(19) United States
(12) Patent Application Publication
(10) Pub. No.: US 2024/0110439 A1
(43) Pub. Date: Apr. 4, 2024

(54) OPERATING SYSTEMS AND RAIL ASSEMBLIES FOR COVERINGS FOR ARCHITECTURAL STRUCTURES AND RELATED COVERINGS

(71) Applicant: Hunter Douglas Inc., Pearl River, NY (US)

(72) Inventors: Wendell B. Colson, Vineyard Haven, MA (US); Robert E. Fisher, II, Thornton, CO (US); Gordon Freirich, Tempe, AZ (US); Timothy W. Fries, Louisville, CO (US); David Byron McNeill, Denver, CO (US); Claude Mathew McNiel, Gilbert, AZ (US)

(21) Appl. No.: 18/478,488

(22) Filed: Sep. 29, 2023

Related U.S. Application Data
(60) Provisional application No. 63/411,780, filed on Sep. 30, 2022.

(51) Int. Cl. E06B 9/307; E06B 9/32

(52) U.S. Cl. CPC E06B 9/307; E06B 9/32; E06B 2009/285

(57) ABSTRACT

Various embodiments of operating systems and rail assemblies configured for use with coverings for architectural structures are described herein. Additionally, the present subject matter is also directed to coverings that incorporate one or more embodiments of the operating systems and/or rail assemblies described herein.

### CROSS-REFERENCE TO RELATED APPLICATIONS

The present application is based upon and claims the right of priority to U.S. Provisional Patent Application No. 63/411,780, filed Sep. 30, 2022, the disclosure of which is hereby incorporated by reference herein in its entirety for all purposes.

### FIELD OF THE INVENTION

The present subject matter relates generally to coverings for architectural structures and, more particularly, to operating systems (e.g., tilt systems and/or lift systems) and rail assemblies (e.g., headrail assemblies, bottom rail assemblies, and/or related sub-assemblies) for coverings and related coverings including the same.

### BACKGROUND OF THE INVENTION

Coverings, such as horizontal/Venetian blinds and other similar slat-based coverings, typically include a headrail, a bottom rail, and a plurality of horizontally oriented slats configured to be supported between the headrail and the bottom rail via two or more ladder tape assemblies. A tilt system is provided to allow the slats to be tilted between an opened position and a closed position. Additionally, one or more lift cords of an associated lift system typically extend between the headrail and the bottom rail for adjusting the position of the bottom rail relative to the headrail.

While various improvements have been made to slat-based coverings in the past to provide for efficient and effective operation thereof, further refinements and advancements are needed, for example, to facilitate more efficient and/or effective operation of a slat-based covering. In addition, further refinements and advancements are needed, for example, to provide enhanced configurations and/or arrangements for one or more components of a slat-based covering. In this regard, an improved operating system and/or rail assembly configured for use within a slat-based covering would be welcomed in the technology.

### BRIEF DESCRIPTION OF THE INVENTION

Aspects and advantages of the present subject matter will be set forth in part in the following description, or may be obvious from the description, or may be learned through practice of the present subject matter.

In one aspect, the present subject matter is directed to a covering for an architectural structure configured in accordance with one or more of the embodiments described herein.

In another aspect, the present subject matter is directed to an operating system (e.g., a tilt system and/or a lift system) for a covering for an architectural structure configured in accordance with one or more of the embodiments described herein.

In a further aspect, the present subject matter is directed to a headrail assembly for a covering for an architectural structure configured in accordance with one or more of the embodiments described herein.

In yet another aspect, the present subject matter is directed to a bottom rail assembly for a covering for an architectural structure configured in accordance with one or more of the embodiments described herein.

In another aspect, the present subject matter is directed to a rail support assembly for a covering for an architectural structure configured in accordance with one or more of the embodiments described herein.

In a further aspect, the present subject matter is directed to a tilt drive assembly for a covering for an architectural structure configured in accordance with one or more of the embodiments described herein.

In yet another aspect, the present subject matter is directed to a tilt wand for a covering for an architectural structure configured in accordance with one or more of the embodiments described herein.

In another aspect, the present subject matter is directed to a brake assembly for a covering for an architectural structure configured in accordance with one or more of the embodiments described herein.

Additionally, in one aspect, the present subject matter is directed to an operating system for tilting a plurality of slats of a covering for an architectural structure. The operating system includes a tilt drive assembly including a drive pulley supported for rotation about a pulley axis and first and second tilt cords coupled to the drive pulley. The operating system also includes a tilt wand supported relative to the tilt drive assembly. The tilt wand includes a first wand portion and a second wand portion. The first and second tilt cords are coupled to the tilt wand such that movement of the second wand portion relative to the first wand portion in a first direction results in the drive pulley being rotated in a first rotational direction about the pulley axis and movement of the second wand portion relative to the first wand portion in an opposed, second direction results in the drive pulley being rotated in an opposed, second rotational direction about the pulley axis.

In one embodiment, the first tilt cord is wound around the drive pulley as the second tilt cord unwinds from the drive pulley while the drive pulley is rotating in the first rotational direction, and the second tilt cord is wound around the drive pulley as the first tilt cord unwinds from the drive pulley while the drive pulley is rotating in the second rotational direction.

In one embodiment, the tilt drive assembly is configured such that rotation of the drive pulley in the first rotational direction results in the plurality of slats being tilted towards one of a closed-up position or a closed-down portion and rotation of the drive pulley in the second rotational direction results in the plurality of slats being tilted towards the other of the one of the closed-up position or the closed-down position.

In one embodiment, the first and second wand portions are provided in a telescoping arrangement. Additionally, in one embodiment, the first and second lift cords extend through the first wand portion and are coupled to portions of the second wand portion.

In one embodiment, an end of the first tilt cord is coupled to the second wand portion at a first location and an end of the second tilt cord is coupled to the second wand portion at a second location spaced apart from the first location.

Additionally, in one embodiment, the first location is adjacent to a bottom end of the second wand portion and the second location is adjacent to a top end of the second wand portion. In one embodiment, the tilt wand further comprises a bottom cap coupled to the bottom end of the second wand portion, the end of the first tilt cord being coupled to the second wand portion via the bottom cap of the tilt wand. In one embodiment, the end of the first tilt cord is directly coupled to the bottom cap of the tilt wand. In one embodiment, the end of the first tilt cord is coupled to the bottom cap of the tilt wand via an elongated connection strap.

Moreover, in one embodiment, the tilt wand further comprises a top cap coupled to the top end of the second wand portion, the end of the second tilt cord being coupled to the second wand portion via the top cap of the tilt wand.

Further, in one embodiment, the second tilt cord is routed through the second wand portion such that an overlapped cord section is formed across which the second tilt cord vertically overlaps itself within the second wand portion. In one embodiment, the second tilt cord is routed downwardly through the second wand portion and wraps around a portion of the tilt wand positioned within the second wand portion before extending upwardly to the second location to form the overlapped cord section. In one embodiment, the second tilt cord wraps around a wand bushing positioned within the second wand portion. In one embodiment, the wand bushing is coupled to a bottom end of the first wand portion.

In one embodiment, a tilt rail coupled is to the tilt drive assembly such that the tilt drive assembly is configured to rotate the tilt rail about a tilt axis, the tilt axis being spaced apart radially from the pulley axis.

In one embodiment, the tilt drive assembly further comprises a tilt drive component coupled between the drive pulley and tilt rail such that rotation of the drive pulley about the pulley axis results in the tilt rail cap and the tilt rail rotating together about the tilt axis.

In one embodiment, the drive pulley comprises a pulley portion about which the first and second tilt cords are wound and unwound and a gear post configured to engage a corresponding gear portion of the tilt drive component.

In one embodiment, the tilt drive assembly further comprises an end plate, and the drive pulley is rotationally coupled to the end plate such that the drive pulley is configured to rotate about the pulley axis relative to the end plate. Additionally, in one embodiment, the drive pulley extends through the end plate such that the pulley portion is positioned on a first side of the end plate and the gear post is positioned on a second side of the end plate and the tilt drive component is supported for rotation about the tilt axis adjacent the second side of the end plate.

In one embodiment, the tilt draft assembly further comprises a stub shaft extending outwardly from the end plate along the tilt axis, with the tilt drive component cap being supported on the stub shaft for rotation about the tilt axis relative to the end plate.

In one embodiment, the tilt drive assembly further comprises a brake spring configured to apply a radially-inwardly directed force against a portion of the tilt drive component that engages the stub shaft to create a frictional interface between tilt drive component and the stub shaft.

In one embodiment, the tilt drive component defines a gear cavity extending radially outwardly from the gear portion of the tilt drive component, the gear cavity being configured to receive the gear post of the drive pulley.

In one embodiment, the gear cavity defines an arc length between opposed first and second ends of the gear cavity, with the arc length defining an angular pivot range about which the tilt drive component is pivotable about the tilt axis.

In one embodiment, the tilt drive component comprises a tilt rail cap configured to be coupled to end of the tilt rail.

In a further aspect, the present subject matter is directed to a covering for an architectural structure, with the covering comprising a headrail assembly, a bottom rail assembly supported relative to the headrail assembly, a plurality of slats are supported between the headrail assembly and the bottom rail assembly, and one or more embodiments of the disclosed operating system.

In one embodiment, the operating system is provided in operative association with the headrail assembly.

In one embodiment, the operating system comprises a tilt rail coupled to the tilt drive assembly such that the tilt drive assembly is configured to rotate the tilt rail about a tilt axis, the tilt axis being spaced apart radially from the pulley axis. Additionally, in one embodiment, the covering further comprises a lift system configured to raise and lower the bottom rail assembly relative to the headrail assembly, with one or more lift system components of the lift system being provided in operative association with the tilt rail such that the one or more lift system components rotate with the tilt rail about the tilt axis.

In one aspect, the present subject matter is directed to an operating system for tilting a plurality of slats of a covering for an architectural structure. The operating system includes a tilt drive assembly and a tilt rail coupled to the tilt drive assembly such that the tilt drive assembly is configured to rotate the tilt rail about a tilt axis. The tilt drive assembly incudes a drive pulley supported for rotation about a pulley axis, with the pulley axis being spaced apart radially from the tilt axis. The tilt drive assembly also includes a tilt drive component coupled between the drive pulley and tilt rail such that rotation of the drive pulley about the pulley axis results in the tilt drive component and the tilt rail rotating together about the tilt axis. First and second tilt cords are coupled to the drive pulley such that: (1) the first tilt cord winds around the drive pulley as the second tilt cord unwinds from the drive pulley with rotation of the drive pulley about the pulley axis in a first rotational direction; and (2) the second tilt cord winds around the drive pulley as the first tilt cord unwinds from the drive pulley with rotation of the drive pulley about the pulley axis in an opposite second rotational direction.

In one embodiment, the tilt drive assembly is configured such that rotation of the drive pulley in the first rotational direction results in the plurality of slats being tilted towards one of a closed-up position or a closed-down portion and rotation of the drive pulley in the second rotational direction results in the plurality of slats being tilted towards the other of the one of the closed-up position or the closed-down position.

In one embodiment, the operating system further comprises a tilt wand supported relative to the tilt drive assembly. In one embodiment, the tilt wand includes a first wand portion and a second wand portion, with the first and second tilt cords being coupled to the tilt wand such that movement of the second wand portion relative to the first wand portion in a first direction results in the drive pulley being rotated in the first rotational direction axis and movement of the second wand portion relative to the first wand portion in an opposed, second direction results in the drive pulley being rotated in the second rotational direction.

In one embodiment, the first and second wand portions are provided in a telescoping arrangement. In one embodiment, the first and second lift cords extend through the first wand portion and are coupled to portions of the second wand portion.

In one embodiment, an end of the first tilt cord is coupled to the second wand portion at a first location and an end of the second tilt cord is coupled to the second wand portion at a second location spaced apart from the first location.

In one embodiment, the drive pulley comprises a pulley portion about which the first and second tilt cords are wound and unwound and a gear post configured to engage a corresponding gear portion of the tilt drive component.

Additionally, in one embodiment, the tilt drive assembly further comprises an end plate, and the drive pulley is rotationally coupled to the end plate such that the drive pulley is configured to rotate about the pulley axis relative to the end plate. In one embodiment, the drive pulley extends through the end plate such that the pulley portion is positioned on a first side of the end plate and the gear post is positioned on a second side of the end plate and the tilt drive component is supported for rotation about the tilt axis adjacent the second side of the end plate.

In one embodiment, the tilt drive assembly further includes a stub shaft extending outwardly from the end plate along the tilt axis, with the tilt drive component cap being supported on the stub shaft for rotation about the tilt axis relative to the end plate.

In one embodiment, the tilt drive assembly further includes a brake spring configured to apply a radially-inwardly directed force against a portion of the tilt drive component that engages the stub shaft to create a frictional interface between tilt drive component and the stub shaft.

In one embodiment, the tilt drive component defines a gear cavity extending radially outwardly from the gear portion of the tilt drive component, the gear cavity being configured to receive the gear post of the drive pulley. In one embodiment, the gear cavity defines an arc length between opposed first and second ends of the gear cavity, with the arc length defining an angular pivot range about which the tilt drive component is pivotable about the tilt axis.

In one embodiment, the tilt drive component comprises a tilt rail cap configured to be coupled to end of the tilt rail.

In a further aspect, the present subject matter is directed to an operating system for use with a covering for an architectural structure. The operating system includes a tilt wand. The tilt wand includes a first wand portion extending lengthwise a top end and a bottom end, and a second wand portion extending lengthwise between a top end and a bottom end. The second wand portion is provided in a telescoping arrangement with the first wand portion such that the second wand portion is movable relative to the first wand portion in a first direction and in an opposite, second direction. The operating system also includes first and second tilt cords provided in operative association with the tilt cords such that portions of the first and second tilt cords are encased within the first and second wand portions. The first and second lift cords are routed through the first wand portion from the top end of the first wand portion to the bottom end of the first wand portion and enter the second wand portion. Additionally, an end of the first tilt cord is coupled to the second wand portion at a first location, and an end of the second tilt cord is coupled to the second wand portion at a second location spaced apart from the first location.

In one embodiment, the first location is adjacent to the bottom end of the second wand portion and the second location is adjacent to the top end of the second wand portion.

In one embodiment, the tilt wand further comprises a bottom cap coupled to the bottom end of the second wand portion, wherein the end of the first tilt cord is coupled to the second wand portion via the bottom cap of the tilt wand. In one embodiment, the end of the first tilt cord is directly coupled to the bottom cap of the tilt wand. In one embodiment, the end of the first tilt cord is coupled to the bottom cap of the tilt wand via an elongated connection strap. In on embodiment, the elongated connection strap is configured to engage the bottom cap of the tilt wand in a manner that prevents movement of the connection strap relative to the bottom cap in a direction of an interior of the tilt wand. In one embodiment, the connection strap defines a ridged surface configured to engage a corresponding pawl of the bottom cap to prevent movement of the connection strap relative to the bottom cap in the direction of the interior of the tilt wand.

In one embodiment, the tilt wand further comprises a top cap coupled to the top end of the second wand portion, the end of the second tilt cord being coupled to the second wand portion via the top cap of the tilt wand.

In one embodiment, the second tilt cord is routed through the second wand portion such that an overlapped cord section is formed across which the second tilt cord vertically overlaps itself within the second wand portion. In one embodiment, the second tilt cord is routed downwardly through the second wand portion from the top end of the second wand portion and wraps around the bottom end of the first wand portion positioned within the second wand portion before extending upwardly to the second location to form the overlapped cord section. In one embodiment, the second tilt cord wraps around a wand bushing coupled to the bottom end of the first wand portion.

In another aspect, the present subject matter is directed to an operating system configured for use with a covering for an architectural structure. The operating system includes a tilt drive assembly and a tilt rail coupled to the tilt drive assembly such that the tilt drive assembly is configured to rotate the tilt rail about a tilt axis. The operating system also includes a ladder tape assembly coupled to the tilt rail, with the ladder tape assembly being configured to support a plurality of slats of a covering. The tilt drive assembly includes an outer end plate, an inner end plate rotatable relative to the outer end plate about the tilt axis, and a drive pulley rotationally coupled to the inner end plate such that the drive pulley is configured to rotate about a pulley axis relative to the inner end plate while rotating together with the inner end plate relative to the outer end plate about the tilt axis, with the pulley axis being spaced apart radially from the tilt axis. A tilt cord is coupled to the drive pulley such that tilt cord winds around and unwinds from the drive pulley with rotation of the drive pulley about the pulley axis.

In one embodiment, the outer end plate includes a fixed gear portion and the drive pulley includes a corresponding gear portion configured to engage with the fixed gear portion of the outer end plate such that rotation of the drive pulley about the pulley axis results in the inner end plate and the drive pulley rotating relative to the fixed gear portion about the tilt axis.

In one embodiment, the operating system further comprises a capstan assembly provided in operative association with the outer end plate. In one embodiment, the capstan assembly comprises a capstan pulley around which a portion of the tilt cord is wrapped as the tilt cord extends along a cord path defined within the tilt drive assembly, with the capstan pulley being rotatable in only one direction such that the capstan pulley rotates when the tilt cord is moved in a first direction along the cord path and allows the tilt cord to slip relative to the capstan pulley when the tilt cord is moved in an opposed second direction along the cord path.

In one embodiment, the operating system further comprises an auxiliary cord pulley supported by the inner end plate, with the tilt cord extending along the cord path from the capstan assembly and at least partially wrapping around the auxiliary cord pulley before extending along the cord path from the auxiliary cord pulley to the drive pulley.

In one embodiment, a portion of the inner end plate defines a cord guide surface across which the tilt cord moves as the tilt cord extends along the cord path defined between the capstan assembly and the auxiliary cord pulley.

In one embodiment, the capstan assembly is positioned along a front side of the tilt axis and the auxiliary cord pulley is positioned along a rear side of the tilt axis when the plurality of slats are disposed at a horizontal, fully opened position.

In one embodiment, the operating system further comprises a drive spring provided in operative association with the drive pulley, with the drive pulley being rotatable about the pulley axis in a first rotational direction to cause the tilt cord to move along the cord path in the first direction. In one embodiment, the drive spring is configured to bias the drive pulley to rotate in an opposed second rotational direction to cause the tilt cord to move along the cord path in the second direction.

In one embodiment, the first rotational direction corresponds to one of a closed-down direction or a closed-up direction for the plurality of slats and the second rotational direction correspond to the other of the closed-down direction or the closed-up direction for the plurality of slats.

In one embodiment, the operating system further comprises a spring cup configured to at least partially house the drive spring. In one embodiment, a first portion of the drive spring is coupled to the drive pulley and a second portion of the drive spring is coupled to the spring cup, wherein rotation of the drive pulley about the pulley axis in the first rotational direction relative to the spring cup results in the drive spring storing energy and wherein the drive spring is configured to release the stored energy to rotationally drive the drive pulley about the pulley axis in the second rotational direction.

In one embodiment, the operating system further comprises a locking mechanism configured to engage a portion of the spring cup to prevent rotation of the spring cup relative to the drive pulley about the pulley axis. In one embodiment, when the locking mechanism is moved to an unlocked position relative to the spring cup, the spring cup is configured to be rotated relative to the drive pulley about the pulley axis to pre-wind the drive spring.

In one embodiment, a frictional force provided by the capstan assembly on the tilt cord is configured to prevent the drive pulley from being rotated in the second rotational direction by the drive spring. In one embodiment, when the frictional force provided by the capstan assembly on the tilt cord is reduced, a return force provided by the drive spring is sufficient to cause the drive pulley to be rotated in the second rotational direction.

In one embodiment, the operating system further includes at least one lift system component supported by the tilt rail such that the at least one lift system components rotates with the tilt rail about the tilt axis.

In one embodiment, a center of mass of the tilt rail is offset from the tilt axis in a radial direction defined relative to the tilt axis.

In a still further aspect, the present subject matter is directed to an operating system configured for use with a covering for an architectural structure. The operating system includes a tilt drive assembly, a tilt rail coupled to the tilt drive assembly such that the tilt drive assembly is configured to rotate the tilt rail about a tilt axis, and a ladder tape assembly coupled to the tilt rail, with the ladder tape assembly being configured to support a plurality of slats of a covering. The tilt drive assembly includes an end plate and a capstan assembly provided in operative association with the end plate. The capstan assembly comprises a one-way capstan pulley around which a portion of a tilt cord is wrapped as the tilt cord extends along a cord path defined within the tilt drive assembly, with the capstan pulley being rotatable in only one direction such that the capstan pulley rotates when the tilt cord is moved in a first direction along the cord path and allows the tilt cord to slip relative to the capstan pulley when the tilt cord is moved in an opposed second direction along the cord path. The tilt drive assembly further includes a drive pulley supported for rotation about the tilt axis relative to the end plate, with the tilt cord being coupled to the drive pulley such that tilt cord winds around and unwinds from the drive pulley with rotation of the drive pulley axis.

In one embodiment, the operating system further comprises a drive spring provided in operative association with the drive pulley, with the drive pulley being rotatable in a first rotational direction to cause the tilt cord to move along the cord path in the first direction and the drive spring being configured to bias the drive pulley to rotate in an opposed second rotational direction to cause the tilt cord to move along the cord path in the second direction.

In one embodiment, the first rotational direction corresponds to one of a closed-down direction or a closed-up direction for the plurality of slats and the second rotational direction correspond to the other of the closed-down direction or the closed-up direction for the plurality of slats.

In one embodiment, the operating system further comprises a spring cup configured to at least partially house the drive spring. In one embodiment, a first portion of the drive spring is coupled to the drive pulley and a second portion of the drive spring is coupled to the spring cup, wherein rotation of the drive pulley in the first rotational direction relative to the spring cup results in the drive spring storing energy and wherein the drive spring being configured to release the stored energy to rotationally drive the drive pulley in the second rotational direction.

In one embodiment, the operating system further comprises a locking mechanism configured to engage a portion of the spring cup to prevent rotation of the spring cup relative to the drive pulley. In one embodiment, when the locking mechanism is moved to an unlocked position relative to the spring cup, the spring cup is configured to be rotated relative to the drive pulley to pre-wind the drive spring.

In one embodiment, a frictional force provided by the capstan assembly on the tilt cord is configured to prevent the drive pulley from being rotated in the second rotational direction by the drive spring. In one embodiment, when the frictional force provided by the capstan assembly on the tilt cord is reduced, a return force provided by the drive spring is sufficient to cause the drive pulley to be rotated in the second rotational direction.

In on embodiment, the operating system further comprises an inner end plate rotatable relative to the outer end plate about the tilt axis, with the drive pulley being rotationally coupled to the inner end plate such that the drive pulley is configured to rotate about a pulley axis relative to the inner end plate while rotating together with the inner end plate relative to the outer end plate about the tilt axis.

In one embodiment, the pulley axis is spaced apart radially from the tilt axis.

In one embodiment, the operating system further includes an auxiliary cord pulley supported by the inner end plate, with the tilt cord extending along the cord path from the capstan assembly and at least partially wrapping around the auxiliary cord pulley before extending along the cord path from the auxiliary cord pulley to the drive pulley.

In one embodiment, a portion of the inner end plate defines a cord guide surface across which the tilt cord moves as the tilt cord extends along the cord path defined between the capstan assembly and the auxiliary cord pulley.

In one embodiment, the capstan assembly is positioned along a front side of the tilt axis and the auxiliary cord pulley is positioned along a rear side of the tilt axis when the plurality of slats are disposed at a horizontal, fully opened position.

In one embodiment, the operating system further includes at least one lift system component supported by the tilt rail such that the at least one lift system components rotates with the tilt rail about the tilt axis.

In one embodiment, a center of mass of the tilt rail is offset from the tilt axis in a radial direction defined relative to the tilt axis.

In a further aspect, the present subject matter is directed to a covering for an architectural structure, with the covering comprising a headrail assembly, a bottom rail assembly supported relative to the headrail assembly, a plurality of slats are supported between the headrail assembly and the bottom rail assembly, and one or more embodiments of the disclosed operating system.

In one embodiment, the operating system is provided in operative association with the headrail assembly.

In one embodiment, the operating system comprises a tilt rail coupled to the tilt drive assembly such that the tilt drive assembly is configured to rotate the tilt rail about a tilt axis, the tilt axis being spaced apart radially from the pulley axis. Additionally, in one embodiment, the covering further comprises a lift system configured to raise and lower the bottom rail assembly relative to the headrail assembly, with one or more lift system components of the lift system being provided in operative association with the tilt rail such that the one or more lift system components rotate with the tilt rail about the tilt axis.

In another aspect, the present subject matter is directed to a headrail assembly configured for use with a covering for an architectural structure. The headrail assembly includes a mounting rail and a tilt system supported relative to the mounting rail. The tilt system includes a tilt drive assembly and a tilt rail. The tilt rail extends lengthwise between a first end and a second end. The tilt drive assembly is configured to rotate the tilt rail about a tilt axis to effectuate tilting of a plurality of slats. The headrail assembly also includes a rail support assembly configured to support the tilt rail relative to the mounting rail for rotation about the tilt axis. The rail support assembly supports the tilt rail at a location between the first and second ends of the tilt rail. The rail support assembly includes a rail support bracket including a first bracket portion coupled to the mounting rail and a second bracket portion extending outwardly from the first bracket portion. The rail support assembly also includes a pivot pin secured to the second bracket portion and extending lengthwise along the tilt axis. The tilt rail is pivotably coupled to the rail support bracket via the pivot pin such that the tilt rail pivots relative to the rail support bracket about the pivot pin.

In one embodiment, the headrail assembly further comprises a lift system configured to raise and lower the covering between raised and lowered positions. In one embodiment, the lift system includes a plurality of components provided in operative association with the tilt rail such that the plurality of components rotate with the tilt rail about the tilt axis, with the tilt rail being pivotably coupled to the pivot pin for rotation relative thereto via a first component of the plurality of components. In one embodiment, the first component comprises a lift station of the lift system, with the lift station including a housing coupled to the tilt rail and the housing being configured to support a lift spool about which a lift cord of the lift system is wound and unwound as the covering is being raised and lowered between the raised and lowered positions.

In one embodiment, the rail support assembly further comprises first and second support components coupled to the tilt rail, with the first support component defining a first bearing surface and the second support component defining a second bearing surface and the pivot pin being captured between the first and second bearing surfaces.

In one embodiment, the first support component defines a first elongated slot and the second support component defines a second elongated slot, with the first and second elongated slots being configured to receive the rail support bracket as the tilt rail is rotated relative to the rail support bracket about the tilt axis.

In one embodiment, the tilt rail defines an elongated slot configured to receive the rail support bracket as the tilt rail is rotated relative to the rail support bracket about the tilt axis. In one embodiment, the first support component comprises a slot cap coupled to the tilt rail such that at least a portion of the slot cap extends within the elongated slot defined by the tilt rail. Additionally, in one embodiment, the headrail assembly further includes a lift system configured to raise and lower the covering between raised and lowered positions, with the lift system comprising a plurality of components provided in operative association with the tilt rail such that the plurality of components rotate with the tilt rail about the tilt axis. In one embodiment, the second support component comprising a first lift system component of the plurality of components of the lift system such that the pivot pin is captured directly between the slot cap and the first lift station component.

In another aspect, the present subject matter is directed to a headrail assembly configured for use with a covering for an architectural structure. The headrail assembly includes a mounting rail and a tilt system supported relative to the mounting rail. The tilt system includes a tilt drive assembly and a tilt rail, with the tilt rail extending lengthwise between a first end and a second end. The tilt drive assembly is configured to rotate the tilt rail about a tilt axis to effectuate tilting of a plurality of slats. The headrail assembly also includes a rail support assembly configured to support the tilt rail relative to the mounting rail for rotation about the tilt axis. The rail support assembly supports the tilt rail at a location between the first and second ends of the tilt rail. The rail support assembly includes a rail support bracket including a first bracket portion coupled to the mounting rail and a second bracket portion extending outwardly from the first bracket portion. The rail support assembly also includes first and second support components coupled between the tilt rail and the second bracket portion, with the first and second support component being configured to rotate with the tilt rail about the tilt axis relative to the rails support bracket.

In one embodiment, the first support component defines a first elongated slot and the second support component defines a second elongated slot, with the first and second elongated slots being configured to receive the rail support bracket as the tilt rail is rotated relative to the rail support bracket about the tilt axis.

In one embodiment, the tilt rail defines an elongated slot configured to receive the rail support bracket as the tilt rail is rotated relative to the rail support bracket about the tilt axis. In one embodiment, the first support component comprises a slot cap coupled to the tilt rail such that at least a portion of the slot cap extends within the elongated slot defined by the tilt rail. Additionally, in one embodiment, the headrail assembly further includes a lift system configured to raise and lower the covering between raised and lowered positions. In one embodiment, the lift system includes a plurality of components provided in operative association with the tilt rail such that the plurality of components rotate with the tilt rail about the tilt axis. In one embodiment, the second support component includes a first lift system component of the plurality of components of the lift system such that the pivot pin is captured directly between the slot cap and the first lift station component.

In one embodiment, the first lift system component comprises a lift station of the lift system, with the lift station including a housing coupled to the tilt rail and the housing configured to support a lift spool about which a lift cord of the lift system is wound and unwound as the covering is being raised and lowered between the raised and lowered positions.

In one embodiment, the rail support assembly further comprises a pivot pin secured to the second bracket portion and extending lengthwise along the tilt axis, with the first and second support components being pivotably coupled to the rail support bracket via the pivot pin such that the first and second support components pivot relative to the pivot pin with pivoting of tilt rail relative about the tilt axis.

In one embodiment, the first support component defines a first bearing surface and the second support component defines a second bearing surface, with the pivot pin being captured between the first and second bearing surfaces.

In one embodiment, the first and second support components comprise first and second rail slides configured to engage with the second bracket portion such that a sliding interface is defined between the second bracket portion and the first and second rail slides.

In one embodiment, the second bracket portion comprises a slide arm defining first and second bearing surfaces configured to engage the first and second rail slides, respectively, across the sliding interface as the tilt rail is rotated about the tilt axis.

In one embodiment, the first and second bearing surfaces correspond to arcuate-shaped surfaces having a radius of curvature centered about the tilt axis.

In yet another aspect, the present subject matter is directed to a headrail assembly configured for use with a covering for an architectural structure. The headrail assembly comprises a tilt system including a tilt drive assembly and a tilt rail, with the tilt drive assembly being configured to rotate the tilt rail about a tilt axis to effectuate tilting of a plurality of slats. The headrail assembly also includes a lift system configured to raise and lower the covering between raised and lowered positions. The lift system includes a lift rod configured to rotate as the covering is being moved between the raised and lowered positions and a brake assembly configured to apply a braking force to the lift rod. The brake assembly includes a housing provided in operative association with the tilt rail such that the brake assembly rotates together with the tilt rail about the tilt axis, and a drum coupled to the lift rod and extending within the housing, the drum including a brake gear. The brake assembly also includes first and second planetary gears supported within the housing relative to the drum such that the first and second planetary gears are configured to mesh with the brake gear. The first and second planetary gears are configured to rotate with the brake gear relative to the housing when the drum is being rotated in a first direction. Additionally, rotation of the drum in an opposed second direction results in at least one of the planetary gears being locked against rotation relative to the housing to prevent further rotation of the drum in the second rotational direction.

In one embodiment, the housing defines first and second gear cavities configured to receive the first and second planetary gears, respectively, and a first stop tooth extends within the first gear cavity and a second stop tooth extends within the second gear cavity.

In one embodiment, the first and second gear cavities are defined within the housing at spaced apart locations such that a force of gravity acting on the first and second planetary gears will tend to cause at least one of the first planetary gear or the second planetary gear to shift towards its respective first stop tooth or second stop tooth when the drum is rotated in the second direction regardless of an orientation of the tilt rail about the tilt axis.

In one embodiment, the first and second planetary gears are supported within the housing at a spaced apart locations relative to the brake gear such that the first planetary gear is configured to be locked against rotation relative to the housing when the tilt rail is at a first orientation about the tilt axis and the second planetary gear is configured to be locked against rotation relative to the housing when the tilt rail is at a second orientation about the tilt axis, the second orientation differing from the first orientation.

In one embodiment, the brake assembly further comprises a hub configured to directly engage the lift rod for rotation therewith and a brake spring coupling the hub to the drum. In one embodiment, the brake spring is captured between an outer radial surface of the hub and an inner radial surface of the drum. In one embodiment, the drum and the brake spring provide a braking force that is applied through the hub to resist rotation of the lift rod when the at least one of the planetary gears is locked against rotation relative to the housing to prevent further rotation of the drum in the second rotational direction.

In a further aspect, the present subject matter is directed to a covering including one or more embodiments of the disclosed headrail assembly, a bottom rail assembly supported relative to the headrail assembly, and a plurality of slats being supported between the headrail assembly and the bottom rail assembly.

In one aspect, the present subject matter is directed to a covering for an architectural structure. The covering includes a headrail assembly and a plurality of slats supported relative to the headrail assembly by at least one ladder tape assembly. The covering also includes a tilt system forming part of the headrail assembly. The tilt system includes a tilt drive assembly and a tilt rail coupled to the at least one ladder tape assembly, with the tilt drive assembly being configured to rotate the tilt rail about a tilt axis to effectuate tilting of the plurality of slats. Additionally, the covering includes a lift system forming part of the headrail assembly and being configured to raise and lower the plurality of slats relative to the headrail assembly. One or more lift system components of the lift system are provided in operative association with the tilt rail such that the one or more lift system components rotate with the tilt rail about the tilt axis.

In one embodiment, the one or more lift system components comprise a lift station and a motor operatively coupled to the lift station.

In one embodiment, the covering further includes a bottom rail assembly positioned relative to the headrail assembly such that the plurality of slats are supported between the headrail assembly and the bottom rail assembly. In one embodiment, the lift system includes at least one lift cord extending between the headrail assembly and the bottom rail assembly. In one embodiment, the at least one lift cord is coupled to at least one lift spool of the lift station.

In one embodiment, the tilt rail defines an open-ended mounting channel within which the one or more lift system components are supported.

In one embodiment, the covering further includes a rail cover configured to be installed relative to the tilt rail such that the rail cover and tilt rail at least partially define an enclosed cavity within which the one or more lift system components are positioned. In one embodiment, front and rear cord gaps are defined at respective interfaces between the rail cover and the tilt rail and wherein front and rear runs of the at least one ladder tape assembly extend through the front and rear cord gaps, respectively. Additionally, in one embodiment, the covering further includes a bottom rail assembly positioned relative to the headrail assembly such that the plurality of slats are supported between the headrail assembly and the bottom rail assembly, with the lift system including front and rear lift cords extending between the headrail assembly and the bottom rail assembly and the front and rear lift cords extending through the front and rear cord gaps, respectively.

In one embodiment, front and rear runs of the at least one ladder tape assembly depend from opposed front and rear sides of the tilt rail, respectively, such that rotation of the tilt rail about the tilt axis in a first direction results in the front run being raised while the rear run is lowered.

In one embodiment, the covering further includes a bottom rail assembly positioned relative to the headrail assembly such that the plurality of slats are supported between the headrail assembly and the bottom rail assembly. In one embodiment, the lift system includes front and rear lift cords extending between the headrail assembly and the bottom rail assembly, with the front and rear lift cords depending from the opposed front and rear side of the tilt rail, respectively, such that rotation of the tilt rail in the first direction results in the front lift cord being raised by the same magnitude as the front run while the rear lift cord is lowered by the same magnitude as the rear run.

In one embodiment, a center of mass of the tilt rail is offset from the tilt axis in a radial direction defined relative to the tilt axis. In one embodiment, the tilt axis is positioned below the center of mass of the tilt rail when the plurality of slats are disposed at a horizontal, fully opened position.

In one aspect, the present subject matter is directed to a bottom rail assembly for a covering for an architectural structure. The bottom rail assembly includes a bottom rail comprising a rail portion and a separate cover portion. The rail portion includes an upper rail wall and forward and rear edge walls extending from upper rail wall along respective front and rear sides of the rail portion. The rail portion defines an open bottom end configured to be at least partially covered by the covering portion. The bottom rail assembly further includes a connector insert received within the rail portion and being configured to couple the cover portion to the rail portion of the bottom rail. The connector insert includes at least one connection member configured to engage at least one corresponding connection member of the cover portion to support the cover portion relative to the open bottom end of the rail portion.

In one embodiment, the rail portion further includes front and rear engagement flanges extending inwardly relative to the forward and rear edge walls of the rail portion, respectively, with the front engagement flange being spaced apart from the rear engagement flange such that the open bottom end of the rail portion is defined between the front and rear engagement flanges.

In one embodiment, an inner surface of the cover portion is configured to contact against the front and rear engagement flanges when the cover portion is coupled to the connector insert.

In one embodiment, at least one cord slot is defined in each of the front and rear engagement flanges for receiving at least one cord of a covering.

In one embodiment, the cover portion is configured to cover at least a portion of the at least one cord slot when the cover portion is supported relative to the open bottom end of the rail portion by the connector insert.

In one embodiment, the at least one connection member of the connector insert comprises a pair of hook-shaped members and wherein at least one connection member of the cover portion compresses a corresponding pair of hook-shaped members configured to engage the pair of hook-shaped members of the connector insert.

In one embodiment, a snap-fit connection is provided between the cover portion and the connector insert.

In a further aspect, the present subject matter is directed to a covering including a headrail assembly, one or more embodiments of the disclosed bottom rail assembly, and a plurality of slats configured to be supported between the headrail assembly and the bottom rail assembly.

These and other features, aspects and advantages of the present subject matter will become better understood with reference to the following Detailed Description and appended claims. The accompanying drawings, which are incorporated in and constitute a part of this specification, illustrate embodiments of the present subject matter and, together with the description, serve to explain the principles of the present subject matter.

This Brief Description is provided to introduce a selection of concepts in a simplified form that are further described below in the Detailed Description. This Brief Description is not intended to identify key features or essential features of the claimed subject matter, nor is it intended as an aid in determining the scope of the claimed subject matter.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 illustrates a perspective view of one embodiment of a covering in accordance with aspects of the present subject matter;

FIG. 2 illustrates a perspective, assembled view of one embodiment of a headrail assembly in accordance with aspects of the present subject matter;

FIG. 3 illustrates a perspective, partially exploded view of the headrail assembly shown in FIG. 2 (with a tilt wand of the assembly removed for purposes of illustration);

FIG. 4 illustrates a perspective view of a portion of the headrail assembly shown in FIG. 2, particularly illustrating one embodiment of a tilt wand of the assembly in accordance with aspects of the present subject matter;

FIG. 5 illustrates another perspective view of the portion of the headrail assembly shown in FIG. 4, particularly illustrating the tilt wand of the assembly extended to pull downwardly on an associated tilt cord of the tilt system;

FIG. 6 illustrates a perspective, assembled view of various components of a tilt system in accordance with aspects of the present subject matter;

FIG. 7 illustrates a perspective, partially exploded view of the various tilt system components shown in FIG. 6 to allow various lift system components of the associated covering to be viewed in accordance with aspects of the present subject matter;

FIG. 8 illustrates another perspective, partially exploded view of the various tilt and lift system component shown in FIG. 7;

FIG. 9 illustrates a cross-sectional view of a tilt rail and rail cover of the tilt system shown in FIG. 6 taken about line IX-IX;

FIGS. 10A-10C illustrate various end views of the tilt rail and rail cover shown in FIG. 9 oriented at different positions corresponding to different tilt positions of the slats of the associated covering in accordance with aspects of the present subject matter;

FIG. 11 illustrates a perspective, assembled view of one embodiment of a tilt drive assembly in accordance with aspects of the present subject matter;

FIG. 12 illustrates an opposed perspective, assembled view of the tilt drive assembly shown in FIG. 11;

FIG. 13 illustrates a perspective, exploded view of the tilt drive assembly shown in FIGS. 11 and 12;

FIG. 14 illustrates an opposed perspective, exploded view of the tilt drive assembly shown in FIG. 13;

FIG. 15 illustrates a cross-sectional view of the tilt drive assembly shown in FIG. 11 taken about line XV-XV;

FIG. 16 illustrates a perspective view of an outer end plate of the tilt drive assembly shown in FIG. 11 in accordance with aspects of the present subject matter;

FIG. 17 illustrates an opposed, perspective view of the outer end plate shown in FIG. 16;

FIG. 18 illustrates a perspective, assembled view of the outer end plate shown in FIG. 16 and an associated capstan assembly and wand pivot member of the tilt drive assembly;

FIG. 19 illustrates a perspective, exploded view of the various tilt system components shown in FIG. 18;

FIG. 20 illustrates a perspective view of an inner end plate of the tilt drive assembly shown in FIG. 11 in accordance with aspects of the present subject matter;

FIG. 21 illustrates an opposed, perspective view of the inner end plate shown in FIG. 20;

FIG. 22 illustrates a perspective view of the inner end plate shown in FIG. 20 with a various other tilt system components exploded away therefrom;

FIG. 23 illustrates a perspective, assembled view of the various components shown in FIG. 22;

FIG. 24 illustrates a perspective view of a drive pulley of the tilt drive assembly shown in FIG. 11 in accordance with aspects of the present subject matter;

FIG. 25 illustrates an opposed, perspective view of the drive pulley shown in FIG. 20;

FIG. 26 illustrates a perspective view of the drive pulley shown in FIG. 24 installed relative to the inner end plate and an associated drive pulley bearing of the tilt drive assembly

FIGS. 27A-27C illustrate differing perspective views of the drive pulley, inner end plate, and outer end plate of the tilt drive assembly as assembled together, particularly illustrating various exemplary positions of the drive pulley and inner end plate relative to the outer end plate that can be achieved with rotation of the drive pulley about its pulley axis in accordance with aspects of the present subject matter;

FIG. 28 illustrates an exploded, perspective view of a spring assembly and the drive pulley of the tilt drive assembly;

FIG. 29 illustrates another exploded, perspective view of the components shown in FIG. 28;

FIG. 30 illustrates a perspective, assembled view of the component shown in FIGS. 28 and 29;

FIG. 31 illustrates a cross-sectional view of the assembled component shown in FIG. 30 taken about line XXXI-XXXI;

FIG. 32 illustrates a perspective view of an end plate cover of the tilt drive assembly shown in FIG. 11 in accordance with aspects of the present subject matter;

FIG. 33 illustrates an opposed, perspective view of the end plate cover shown in FIG. 32;

FIG. 34 illustrates a perspective view of the end plate cover shown in FIG. 32 exploded away from the remainder of the tilt system components shown in FIG. 11 (as assembled);

FIG. 35 illustrates a bottom perspective, assembled view of the component shown in FIG. 34;

FIG. 36 illustrates a perspective, assembled view of one embodiment of a bottom rail assembly in accordance with aspects of the present subject matter;

FIG. 37 illustrates a perspective, exploded view of the bottom rail assembly shown in FIG. 36;

FIG. 38 illustrates a cross-sectional view of a bottom rail of the bottom rail assembly shown in FIG. 36 taken about line XXXVIII-XXXVIII;

FIG. 39 illustrates a bottom perspective, partially exploded view of a portion of the bottom rail assembly shown in FIG. 37;

FIG. 40 illustrates an assembled, bottom view of the portion of the bottom rail assembly shown in FIG. 39;

FIG. 41 illustrates a perspective view of another embodiment of a covering in accordance with aspects of the present subject matter;

FIG. 42 illustrates a perspective, assembled view of another embodiment of a headrail assembly in accordance with aspects of the present subject matter;

FIG. 43 illustrates a perspective, partially exploded view of the headrail assembly shown in FIG. 42 (with a tilt wand of the assembly removed for purposes of illustration);

FIG. 44 illustrates a perspective view of a portion of the headrail assembly shown in FIG. 42, particularly illustrating one embodiment of a tilt wand of the assembly in accordance with aspects of the present subject matter;

FIG. 45 illustrates another perspective view of the portion of the headrail assembly shown in FIG. 4, particularly illustrating the tilt wand of the assembly extended to adjust the tilt of the slats of the covering;

FIG. 46 illustrates a cross-sectional view of the tilt wand shown in FIG. 44 taken about line XLVI-XLVI;

FIG. 47 illustrates a perspective, assembled view of various components of a tilt system in accordance with aspects of the present subject matter;

FIG. 48 illustrates a perspective, partially exploded view of the various tilt system components shown in FIG. 47 to allow various lift system components of the associated covering to be viewed in accordance with aspects of the present subject matter;

FIG. 49 illustrates another perspective, partially exploded view of the various tilt and lift system component shown in FIG. 48;

FIG. 50 illustrates a cross-sectional view of a tilt rail and rail cover of the tilt system shown in FIG. 47 taken about line L-L, with all the various other tilt/lift system components being removed for purposes of illustration;

FIG. 51 illustrates a perspective view of one embodiment of a tilt drive assembly in accordance with aspects of the present subject matter;

FIG. 52 illustrates another perspective view of the tilt drive assembly shown in FIG. 51;

FIG. 53 illustrates an exploded, perspective view of the tilt drive assembly shown in FIG. 51;

FIG. 54 illustrates another exploded, perspective view of the tilt drive assembly shown in FIG. 51;

FIG. 55 illustrates a cross-sectional view of the tilt drive assembly shown in FIG. 51 taken about line LV-LV.

FIGS. 56A-56C illustrate various end views of the tilt drive assembly shown in FIG. 51 with the tilt wand installed relative thereto, specifically illustrating a tilt rail cap of the tilt drive assembly and the tilt wand at differing positions corresponding to different tilt positions of the slats of the associated covering;

FIG. 57 illustrates a perspective, assembled view of one embodiment of an end plate assembly and a wand pivot member in accordance with aspects of the present subject matter;

FIG. 58 illustrates another perspective, assembled view of the end plate assembly and wand pivot member shown in FIG. 57;

FIG. 59 illustrates a perspective, exploded view of the end plate assembly and wand pivot member shown in FIG. 57;

FIG. 60 illustrates another perspective, exploded view of the end plate assembly and wand pivot member shown in FIG. 57;

FIG. 61 illustrates a cross-sectional view of the end plate assembly and wand pivot member shown in FIG. 58 taken about line LXI-LXI;

FIG. 62 illustrates a perspective view of one embodiment of a drive pulley in accordance with aspects of the present subject matter;

FIG. 63 illustrates another perspective view of the drive pulley shown in FIG. 62;

FIG. 64 illustrates a perspective view of the drive pulley shown in FIG. 62 as assembled relative to the end plate assembly and wand pivot member shown in FIG. 57;

FIG. 65 illustrates an end view of the assembled components shown in FIG. 63, particularly illustrated a cord path for the tilt cords extending through such assembled components;

FIG. 66 illustrates a perspective view of one embodiment of a tilt rail cap in accordance with aspects of the present subject matter;

FIG. 67 illustrates another perspective view of the tilt rail cap shown in FIG. 66;

FIG. 68 illustrates a partial, cross-sectional view of another embodiment of a tilt wand in accordance with aspects of the present subject matter, particularly illustrating a portion the tilt wand similar to the portion of the tilt wand contained within box LXVIII shown in FIG. 46;

FIG. 69 illustrates a cross-sectional view of a bottom end of a second wand portion of the tilt wand shown in FIG. 68 taken about line LXIX-LXIX;

FIG. 70 illustrates a perspective view of one embodiment of a rail support assembly in accordance with aspects of the present subject matter, particularly illustrating the rail support assembly as assembled within a central portion of a tilt rail;

FIG. 71 illustrates an exploded, perspective view of the rail support assembly shown in FIG. 70, with the various components of the rail support assembly exploded away from the tilt rail;

FIGS. 72A-72C illustrate end views of the rail support assembly and tilt rail shown in FIG. 70 as installed relative to a mounting rail of a headrail assembly, particularly illustrating the tilt rail and the various components supported therein at different positions relative to the mounting rail and a rail support bracket of the rail support assembly as the tilt rail is tilted about the tilt axis to adjust the tilt position of slats of an associated covering;

FIG. 73 illustrates a perspective view of one embodiment of a slot cap in accordance with aspects of the present subject matter;

FIG. 74 illustrates another perspective view of the slot cap shown in FIG. 73;

FIG. 75 illustrates a perspective view of the slot cap shown in FIG. 73 as exploded away from a portion of a tilt rail;

FIG. 76 illustrates an assembled perspective view of the slot cap and tilt rail shown in FIG. 75;

FIG. 77 illustrates another assembled perspective view of the slot cap and tilt rail shown in FIG. 76 with a rail support bracket and associated pivot pint assembled relative thereto;

FIG. 78 illustrates a perspective view of a lift station in accordance with aspects of the present subject matter;

FIG. 79 illustrates another perspective view of the lift station shown in FIG. 78;

FIG. 80 illustrates a similar perspective view of the lift station as that shown in FIG. 78 with an upper or first housing component of the lift station exploded away from the remainder thereof;

FIG. 81 illustrates a top view of the lift station shown in FIG. 78 with a tilt support bracket shown installed relative thereto;

FIG. 82 illustrates a similar perspective view of the lift station as that shown in FIG. 79 with the tilt support bracket shown in FIG. 81 installed relative thereto;

FIG. 83 illustrates a cross-sectional view of the tilt rail and rail support assembly shown in FIG. 70 taken about line LXXXIII-LXXXIII, with the rail support bracket being shown as transparent (e.g., in dashed lines) and an associated mounting rail being added for purposes of illustration;

FIG. 84 illustrates an assembled, perspective view of another embodiment of a rail support assembly in accordance with aspects of the present subject matter;

FIG. 85 illustrates an exploded, perspective view of the rail support assembly shown in FIG. 84;

FIG. 86 illustrates another exploded, perspective view of the rail support assembly shown in FIG. 84;

FIG. 87 illustrates a cross-sectional view of the rail support assembly shown in FIG. 84 taken about line LXXXVII-LXXXVII;

FIGS. 88A-88C illustrate end views of the rail support assembly shown in FIG. 84 as installed relative to a tilt rail and an associated mounting rail in accordance with aspects of the present subject matter, particularly illustrating the tilt rail at different positions relative to the mounting rail and a rail support bracket of the rail support assembly as the tilt rail is tilted about the tilt axis to adjust the tilt position of slats of an associated covering;

FIG. 89 illustrates a perspective view of one embodiment of a brake assembly in accordance with aspects of the present subject matter;

FIG. 90 illustrates another perspective view of the brake assembly shown in FIG. 89;

FIG. 91 illustrates an exploded, perspective view of the brake assembly shown in FIG. 89;

FIG. 92 illustrates another exploded, perspective view of the brake assembly shown in FIG. 89;

FIG. 93 illustrates a cross-sectional view of the brake assembly shown in FIG. 89 taken about line XCIII-XCIII;

FIG. 94 illustrates an end view of the brake assembly shown in FIG. 89 as installed relative to a tilt rail in accordance with aspects of the present subject matter;

FIGS. 95A-95C illustrate a similar cross-sectional view of the brake assembly as shown in FIG. 93 as installed relative to a tilt rail (but with the view mirrored to show the front and rear sides of the tilt rail in the same orientation as similar views provided herein), particularly illustrating the tilt rail oriented at various different rail positions.

### DETAILED DESCRIPTION OF THE INVENTION

In general, the present subject matter is directed to operating systems, rail assemblies and related assemblies and sub-assemblies for a slat-based covering for an architectural feature or structure (referred to herein simply as an architectural “structure” for the sake of convenience and without intent to limit). As will be described below, the disclosed operating systems, rail assemblies, and other assemblies and/or sub-assemblies generally provide for enhanced operation of a slat-based covering and/or improved configurations/arrangements for a slat-based covering, such as by allowing for improved closure of the slats of the covering, by providing a tilt system that can easily and effectively be manipulated by a user to tilt the slats as desired, by reconfiguring the manner in which rail assembly components are coupled together and/or arranged relative to each other, and/or the like.

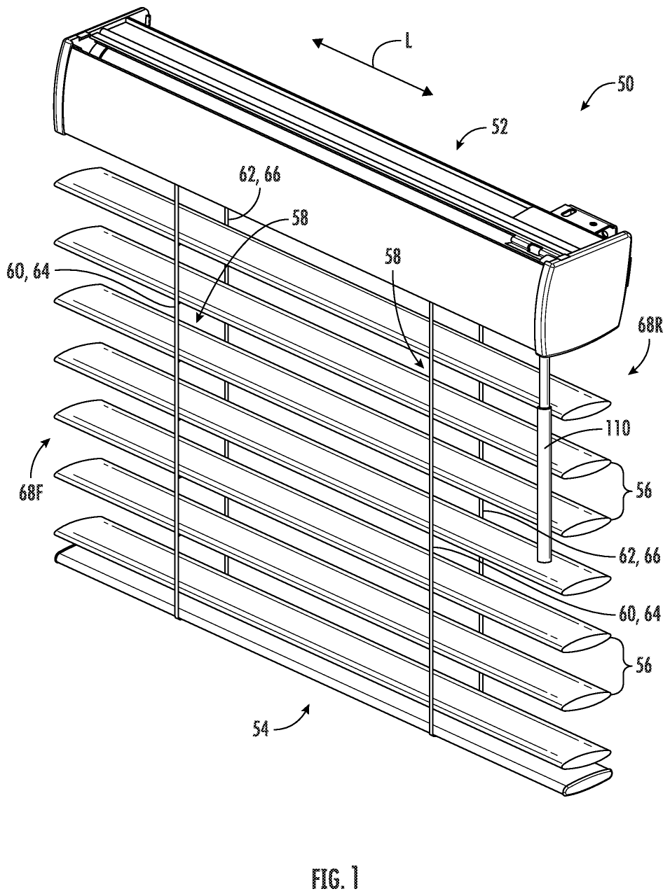

Referring now to the drawings, FIG. 1 illustrates a perspective view of one embodiment of a covering 50 for an architectural structure (not shown) in accordance with aspects of the present subject matter. In general, the covering 50 is configured to be installed relative to a window, door, or any other suitable architectural structure as may be desired. In one embodiment, the covering 50 may be configured to be mounted relative to an architectural structure to allow the covering 50 to be suspended or supported relative to the architectural structure. It should be understood that the covering 50 is not limited in its particular use as a window or door shade, and may be used in any application as a covering, partition, shade, and/or the like, relative to and/or within any type of architectural structure.

In several embodiments, the covering 50 may be configured as a slatted blind, such as a “privacy” Venetian-blind-type extendable/retractable covering. For example, in the embodiment shown in FIG. 1, the covering 50 includes a headrail assembly 52, a bottom rail assembly 54, and a plurality of horizontally disposed, parallel slats 56 configured to be supported between the headrail and bottom rail assemblies 52, 54 via two or more ladder tape assemblies 58 (e.g., a pair of ladder tape assemblies 58). In several embodiments, the slats 56 are rotatable or tiltable about their longitudinal axes by manipulating the ladder tape assemblies 58 to allow the slats 56 to be tilted between a horizontal or open position (e.g., as shown in FIG. 1) for permitting light to pass between the slats 56 and a closed position (not shown—either a closed-down position or a closed-up position depending on whether the front edges of the slats 56 are tilted downwardly or upwardly, respectively), wherein the slats 56 are substantially vertically oriented in an overlapping manner to occlude or block the passage of light through the covering 50.

In several embodiments, the slats 56 may be configured as cellular slats. For example, in one embodiment, each slat 56 may include an outer sock (not shown) forming an outer cellular structure of the slat 56 and an inner core (not shown) positioned within the outer sock that forms an inner cellular structure of the slat 56. For instance, the outer sock of each slat 56 may be formed from a flexible material (e.g., a fabric material) and may have a tube-like or looped configuration that generally forms a closed-perimeter cell that functions to constrain and/or envelop the inner core positioned therein. The inner core of each slat 56 may be formed from a strip of thin-walled material (e.g., a film material) that has been arranged (e.g., folded) to form an inner cellular structure within the interior of the sock that provides stiffness and rigidity to the otherwise flexible sock. An example of suitable cellular slats that may be used within the disclosed covering 50 is disclosed in WO 2022/086834, filed Oct. 18, 2021 and entitled “Cellular Slats for a Covering for an Architectural Structure”, the disclosure of which is hereby incorporated by reference herein in its entirety for all purposes. Alternatively, the slats 56 may be configured as conventional, non-cellular slats.

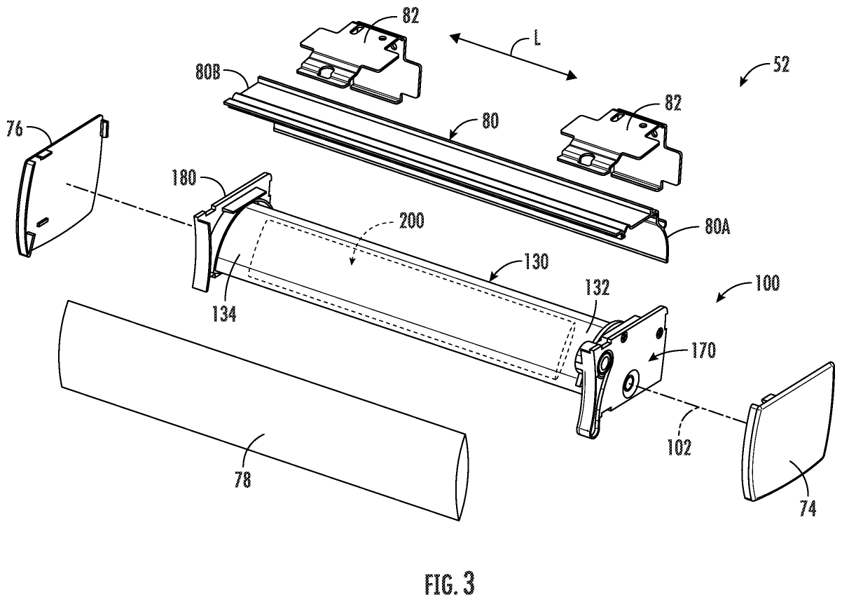

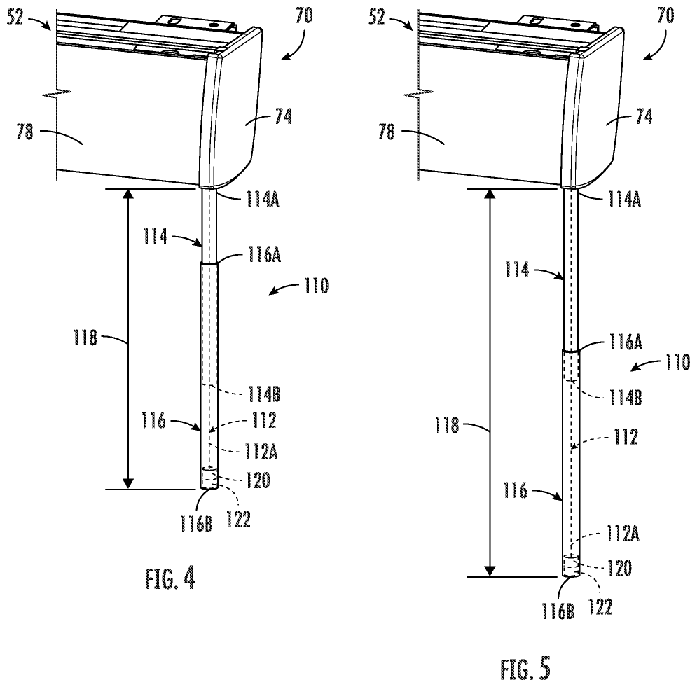

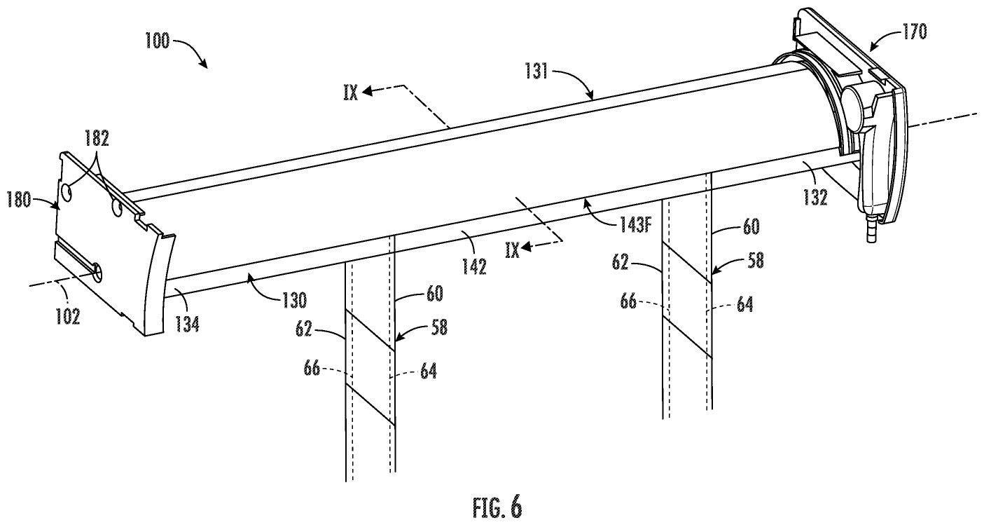

It should be appreciated that the ladder tape assemblies 58 may be manipulated to allow for the slats 56 to be tilted between their open and closed positions using, for example, a suitable tilt wand 110 or any other suitable control device forming part of a tilt system 100 (FIG. 3) provided in operative association with the covering 50. For example, as will be described below with reference to FIG. 3, the covering 50 may include one or more components of the tilt system 100 provided in operative association with the headrail assembly 52, such as a tilt drive assembly 170 and associated tilt rail 130 of the system 100. In such an embodiment, the tilt wand 110 may be manipulated by the user (e.g., by the pulling a portion of the wand 110 down or by raising such portion of the wand 110) to pull down on or remove the tension from an associated tilt cord 112 (FIGS. 4 and 5) extending within the wand 110, which may, in turn, allow the tilt drive assembly 170 to rotationally drive the tilt rail 130. Such rotation of the tilt rail 130 may cause front and rear ladder runs 60, 62 (FIGS. 6-8) of each ladder tape assembly 58 depending from the tilt rail 130 to be raised or lowered relative to each other to adjust the tilt angle of the slats 56.

Moreover, as shown FIG. 1, the covering 50 also includes two or more pairs of lift cords 64, 66 forming part of a lift system 200 (FIG. 3) for moving the covering 50 between a lowered or extended position (e.g., as shown in FIG. 1) and a raised or retracted position (not shown). In the illustrated embodiment, the covering 50 includes two pairs of lift cords 64, 66 extending between the headrail assembly 52 and the bottom rail assembly 54. Each lift cord pair in FIG. 1 includes a front lift cord 64 extending along a front side 68F of the covering 50, and a rear lift cord 66 extending along a rear side 68R of the covering 50. Specifically, each front lift cord 64 is configured to extend between the headrail assembly 52 and the bottom rail assembly 54 along a front edge of each slat 56, while each rear lift cord 66 is configured to extend between the headrail assembly 52 and the bottom rail assembly 54 along an opposed rear edge of each slat 56. As will be described below, each pair of lift cords 64, 66 may be configured to extend to a corresponding lift system component provided in operative association with the headrail assembly 52.

It should be appreciated that the configuration of the covering 50 described above and shown in FIG. 1 is provided only to place the present subject matter in an exemplary field of use. Thus, it should be apparent that the present subject matter may be readily adaptable to any suitable manner of covering configuration.

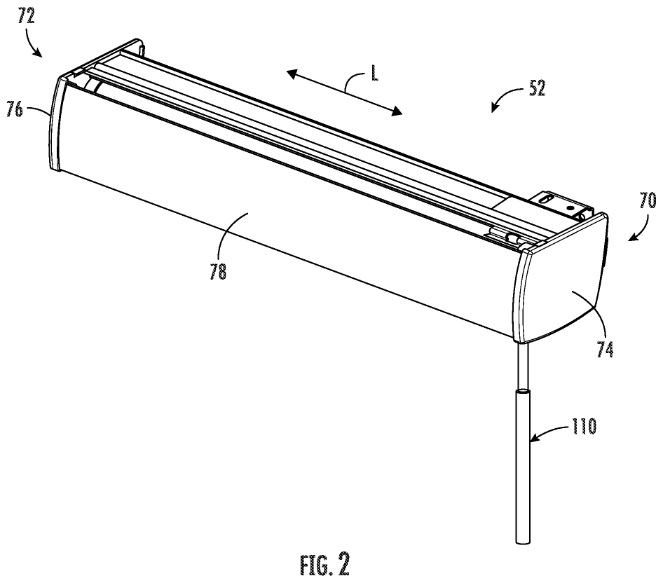

Referring now to FIGS. 2 and 3, perspective views of one embodiment of a headrail assembly (e.g., headrail assembly 52) are illustrated in accordance with aspects of the present subject matter. Specifically, FIG. 2 illustrates a perspective, assembled view of the headrail assembly 52 and FIG. 3 illustrates a perspective, partially exploded view of the headrail assembly 52 shown in FIG. 2 (with the tilt wand 110 removed for purposes of illustration).

In general, the headrail assembly 52 is configured to extend in a lateral direction (indicated by arrow L in FIGS. 2 and 3) between a first assembly end 70 (FIG. 2) and a second assembly end 72 (FIG. 2). As shown in FIGS. 2 and 3, the headrail assembly 52 includes a first endcap 74 positioned at the first assembly end 70, a second endcap 76 positioned at the second assembly end 72, and a valance 78 extending in the lateral direction L between the first and second endcaps 74, 76. In general, the valance 78 may be configured to extend between the endcaps 74, 76 to at least partially cover or conceal one or more of the internal components of the headrail assembly 52 (e.g., one or more components of the tilt system 100 and/or lift system 200) when the associated assembly 52 is viewed from its front side. In one embodiment, the valance 78 may be designed or configured to have the same shape, profile, dimensions, etc. as the slats 56 used in the associated covering 50. For instance, in the illustrated embodiment, the valance 78 corresponds to one of the slats 56 shown in FIG. 1 such that the valance 78 is interchangeable with the each of the slats 56 and vice versa.

As indicated above, in several embodiments, the headrail assembly 52 may be configured to include or be associated with various components of both the tilt system 100 and the lift system 200. For instance, as particularly shown in FIG. 3, various tilt-related components of the tilt system 100 may be positioned or supported between the first and second endcaps 74, 76. Specifically, as shown in FIG. 3, the tilt system 100 includes a tilt rail 130 extending laterally between a first or drive end 132 of the tilt rail 130 positioned adjacent to the first assembly end 70 (FIG. 2) of the headrail assembly 52 and a second or idle end 134 of the tilt rail 130 positioned adjacent to the second assembly end 72 (FIG. 2) of the headrail assembly 52. Additionally, the tilt system 100 includes a tilt drive assembly 170 coupled to the drive end 132 of the tilt rail 130 and an idle end plate 180 coupled to the idle end 134 of the tilt rail 130. For instance, as shown in FIG. 3, the tilt drive assembly 170 is configured to be coupled between the first endcap 74 and the drive end 132 of the tilt rail 130 adjacent to the first assembly end 70 (FIG. 2) of the headrail assembly 52 and the idle end plate 180 is configured to be coupled between the second endcap 76 and the idle end 134 of the tilt rail 130 adjacent to the second assembly end 72 (FIG. 2) of the headrail assembly 52. As will be described in greater detail below with reference to FIGS. 11-14, the tilt drive assembly 170 may be configured to rotationally drive the tilt rail 130 such that the rail rotates about a tilt axis 102 (FIG. 3) across an angular tilt range (e.g., approximately 180 degrees) to allow the slats 56 of the associated covering 50 to be tilted from a first closed position (e.g., a closed-down position) through a fully opened position (e.g., as shown in FIG. 1) to a second closed position (e.g., a closed-up position).

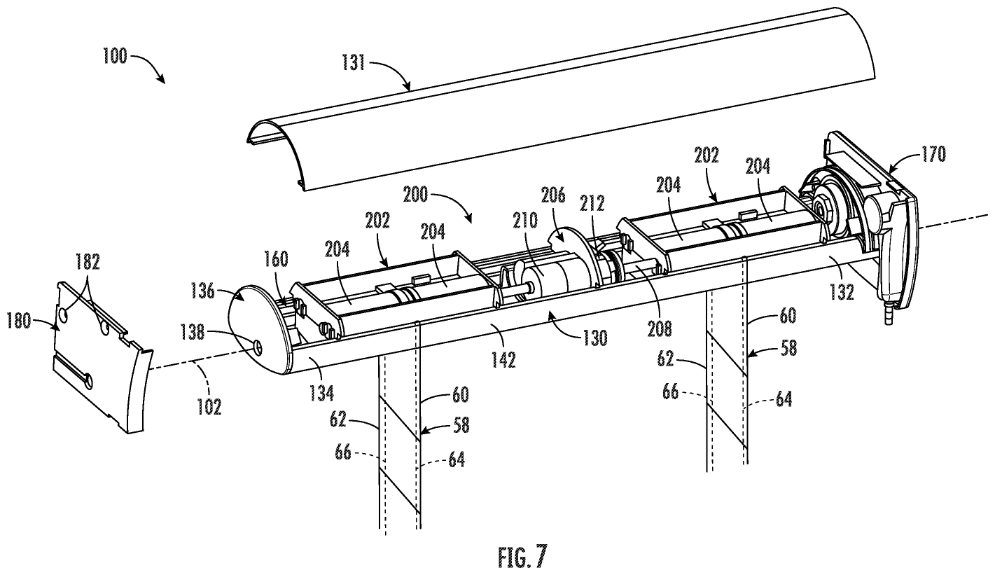

Additionally, in accordance with aspects of the present subject matter, one or more components of the lift system 200 (indicated by dashed lines in FIG. 3) may be supported by the tilt rail 130. As a result, the various lift system components supported by the tilt rail 130 may be configured to rotate with the tilt rail 130 about the tilt axis 102 as the slats 56 are being tilted. As will be described below with reference to FIGS. 7 and 8, such rotation of the lift system components may allow the front and rear lift cords 64, 66 (FIG. 1) to be shifted slightly in opposite directions together with the front and rear runs 60, 62 (FIG. 1) of the ladder tape assemblies 58 as the slats 56 are being tilted, thereby assisting the slats 56 in being moved to one of the closed positions while maintaining the bottom rail assembly 54 at the desired orientation.

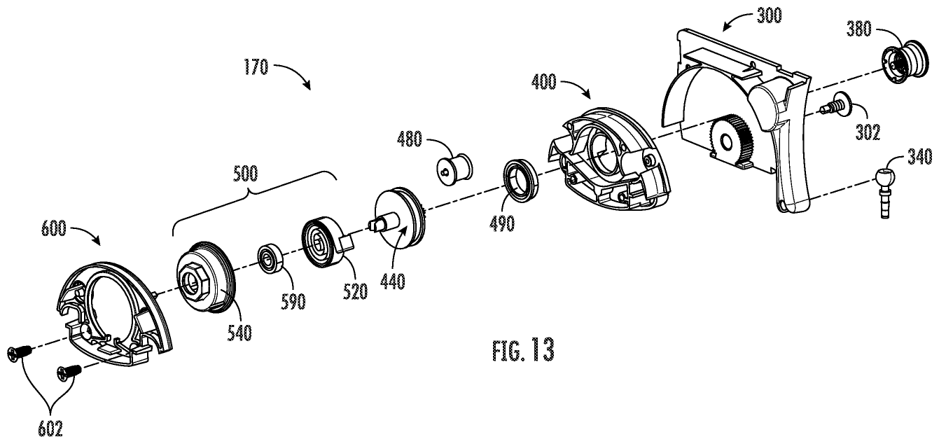

It should be appreciated that the headrail assembly 52 may also include one or more components for mounting the assembly 52 relative to an adjacent architectural structure. For instance, as particularly shown in FIG. 3, the headrail assembly 52 includes a mounting rail 80 and two or more mounting brackets 82, with the mounting brackets 82 configured to be coupled between the mounting rail 80 and the adjacent architectural structure (e.g., using suitable fasteners). The mounting rail 80, in turn, may be configured to be coupled to one or more components of the headrail assembly 52 to support such assembly 52 relative to the brackets 82 and the adjacent architectural structure. For instance, in one embodiment, opposed first and second lateral ends 80A, 80B of the mounting rail 80 may be configured to be coupled to corresponding fixed or stationary components of the tilt system 100, such as by coupling the first lateral end 80A of the mounting rail 80 to a fixed end plate 300 (FIG. 13) of the tilt drive assembly 170 positioned adjacent to the first assembly end 70 of the headrail assembly 52 and by coupling the second lateral end 80B of the mounting rail 80 to the opposed idle end plate 180 positioned adjacent to the second assembly end 72 of the headrail assembly 52. By coupling the mounting rail 80 to the tilt system components in this manner, the mounting rail 80 may be configured to support not only the tilt system components (and the lift system components associated therewith) relative to the adjacent architectural structure, but also the various other assembly components coupled to the tilt system components (e.g., the endcaps 74, 76, valance 78, etc.).

Referring now to FIGS. 4 and 5, perspective views of a portion of the headrail assembly 52 shown in FIG. 2 (e.g., a portion extending adjacent to the first assembly end 70 of the assembly 52) are illustrated in accordance with aspects of the present subject matter, particularly illustrating more detailed views of one embodiment of the tilt wand 110 of the tilt system 100. As particularly shown in FIGS. 4 and 5, in several embodiments, the tilt wand 110 may be configured as a telescoping wand including both an upper or first wand portion 114 and a lower or second wand portion 116, with the first wand portion 114 being configured to be received within the second wand portion 116 (or vice versa) in a telescoping manner to allow an effective length 118 of the tilt wand 110 to be increased or decreased with relative movement between the wand portions 114, 116. For instance, as shown in the illustrated embodiment, the first wand portion 114 extends between a top end 114A and a bottom end 114B, with the bottom end 114B being received within the second wand portion 116. As will be described below, the top end 114A of the first wand portion 114 may be configured to be coupled to a corresponding portion of the tilt drive assembly 170 (FIG. 3) (e.g., a wand pivot member 340 (FIG. 13) of the assembly 170). Additionally, the second wand portion 116 extends between a top end 116A and a bottom end 116B, with the top end 116A being configured to slide over a portion of the first wand portion 114 in a telescoping arrangement as the second wand portion 116 is moved upward and downwardly relative to the first wand portion 114.

Additionally, a portion of the tilt cord 112 (shown in dashed lines in FIGS. 4 and 5) may be configured to extend through the wand portion so that such portion of the tilt cord 112 is encapsulated or encased by the tilt wand 110. For instance, in one embodiment, the tilt cord 112 may extend through the tilt wand 110 from the top end 114A of the first wand portion 114 to the bottom end 116B of the second wand portion 116. Additionally, in several embodiments, an end 112A of the tilt cord 112 may be configured to be coupled to the second wand portion 116, such as by coupling the end 112A of the cord to the second wand portion 116 at or adjacent to the bottom end 116B of the wand portion 116. For instance, in one embodiment, the end 112 of the tilt cord 112 may be tied or secured to the second wand portion 116 within its interior at a location adjacent to the bottom end 116B. Alternatively, as shown in FIGS. 4 and 5, the end 112 of the tilt cord 112 may be secured to a coupling mechanism 120 that is configured to engage with or couple to a corresponding coupling mechanism 122 positioned within the second wand portion 116. For instance, in one embodiment, the coupling mechanisms 120, 122 may correspond to magnets configured to magnetically engaged each other, thereby coupling the tilt cord 112 to the second wand portion 116. In such an embodiment, the magnets may allow the tilt cord to be decoupled from the second wand portion 116, if necessary, in the event of an excessive force being applied thereto.

It should be appreciated that, by coupling the end 112 of the tilt cord 112 to the second wand portion 116, the tilt cord 112 may be pulled downwardly with downward motion of the second wand portion 116 relative to the first wand portion 114. As will be described below, such downward pulling or extension of the tilt cord 112 may generally result in the tilt rail 130 of the tilt system 100 being rotated in a closed-down direction, thereby tilting the slats towards the closed-down position. Additionally, as will be described below, the tilt drive assembly 170 of the tilt system 100 may be configured as a balanced, spring-return drive assembly. As such, with the tilt wand 110 suspended from the tilt drive assembly 170, the downward force on the tilt cord 112 provided via the weight of the wand 110 in combination with the frictional forces applied to the cord 112 via one or more other components of the tilt drive assembly 170 (e.g., the capstan assembly) may generally be equal to the spring-based return force of the tilt drive assembly 170, thereby allowing the slats 56 to be maintained at any suitable tilt position based on the operator-selected position of the second wand portion 116. However, when the weight of the tilt wand 110 is removed from the tilt cord 112 (e.g., by the user lifting the second wand portion 116 relative to the first wand portion 114), the spring-based return force of the tilt drive assembly 170 may result in the tilt rail 130 being rotationally driven in a closed-up direction as the tilt cord 112 is being wound-up or retracted by the tilt drive assembly 170, thereby tilting the slats towards the closed-up position.

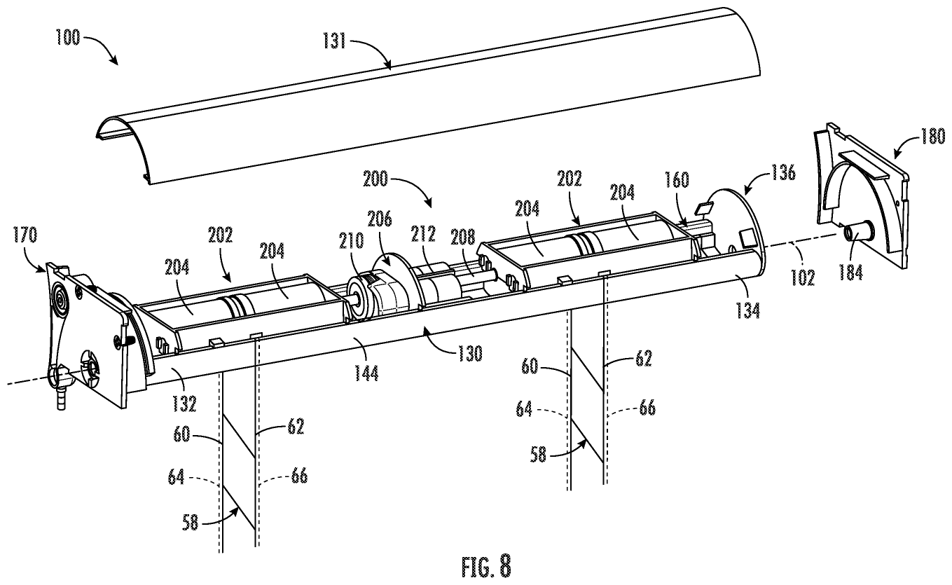

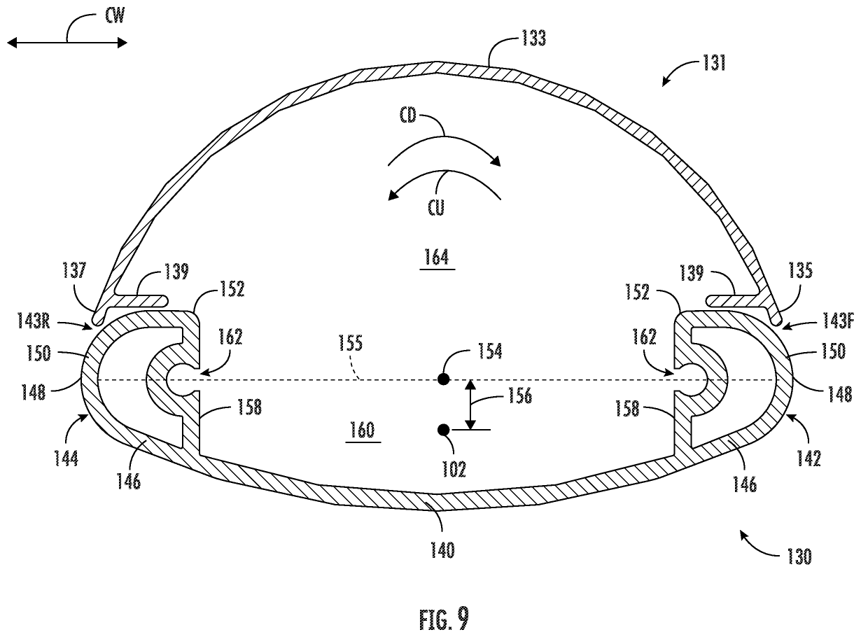

Referring now to FIGS. 6-9, differing views of one embodiment of various components of the tilt and lift systems 100, 220 described above are illustrated in accordance with aspects of the present subject matter. Specifically, FIG. 6 illustrates a perspective, assembled view of various components of the tilt system 100, while FIGS. 7 and 8 illustrate different perspective views of the tilt system components shown in FIG. 6 with the idle end plate 180 and a rail cover 131 for the tilt rail 130 being exploded away to allow the various components of the lift system 200 supported by the rail 130 to be visible. FIG. 9 illustrates a cross-sectional view of the tilt rail 130 and associated rail cover 131 shown in FIG. 6 taken about line IX-IX and with all the various other tilt/lift system components being removed for purposes of illustration. Additionally, FIGS. 6-8 illustrate the various cords/runs that depend or extend from the tilt rail 130, such as the lift cords 64, 66 (shown as dashed lines for purposes of illustration) and the front and rear ladder runs 60, 62 of the ladder tape assemblies 58.

As indicated above, the tilt rail 130 may be configured to extend laterally between a drive end 132 configured to be coupled to the tilt drive assembly 170 and an idle end 134 configured to be coupled to the opposed idle end plate 180 of the tilt system 100, with the tilt drive assembly 170 being configured to cause the tilt rail 130 to be rotated about a tilt axis 102 of the tilt system 100. As shown in FIGS. 7 and 8, the idle end 134 of the tilt rail 130 may be configured to be coupled to the idle end plate 180 via an idle end cover 136 that supports the tilt rail 130 for rotation about the tilt axis 102 relative to the idle end plate 180. Specifically, in several embodiments, the idle end plate 180 may correspond to a fixed or non-rotating component of the tilt system 100. For instance, the idle end plate 180 may, in one embodiment, be configured to be rigidly mounted to the mounting rail 80 (FIG. 3) of the headrail assembly 52 to allow the various tilt system components to be supported by the mounting rail 80 relative to the adjacent architectural structure, such as by coupling the idle end plate 180 to the mounting rail via suitable fasteners (not shown) extending through corresponding fastener openings 182 defined through the idle end plate 180. In such embodiments, to rotationally support the idle end 134 of the tilt rail 130 relative to the fixed plate 180, the idle end plate 180 and associated end cover 136 may include or define complementary rotational connection features. For instance, as shown in FIGS. 7 and 8, the idle end cover 136 defines a shaft opening 138 (FIG. 7) configured to receive a stub shaft 184 (FIG. 8) extending laterally from the idle end plate 180 along the tilt axis 102. In such an embodiment, the stub shaft 184 may be configured to define a bearing surface about which the tilt rail 130 (and cover 136) rotate relative to the idle end plate 180 about the tilt axis 102.

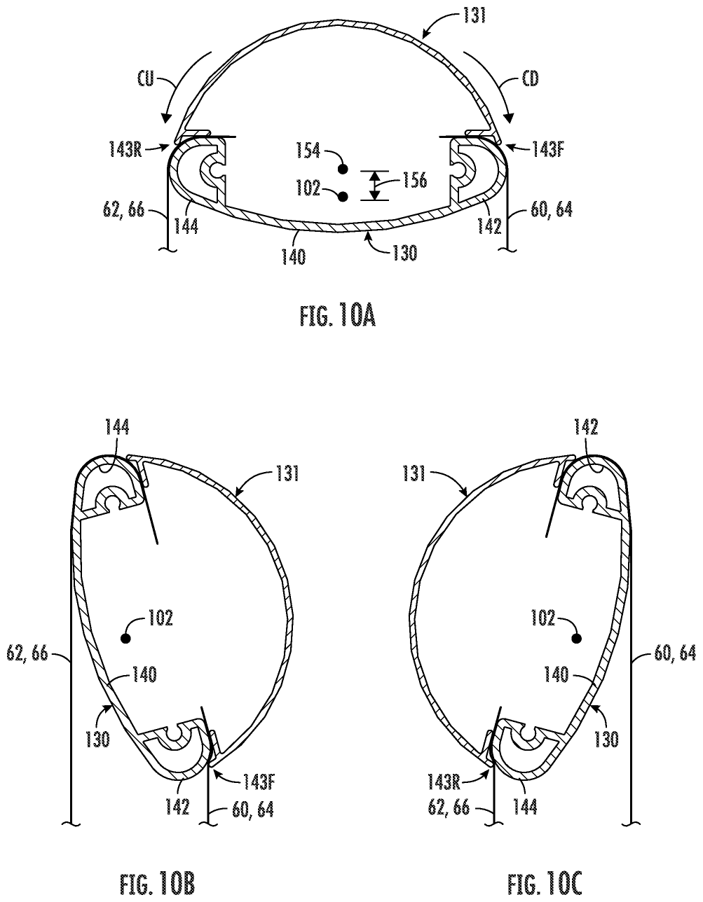

As particularly shown in FIG. 9, the tilt rail 130 may generally include a bottom wall 140 (e.g., a curved or arced bottom wall) extending in a front-to-rear or crosswise direction (indicated by arrow CW in FIG. 9) between a front edge wall 142 and a rear edge wall 144. In several embodiments, each edge wall 142, 144 may be configured as a radiused or curved wall having a first wall portion 146 extending between the bottom wall 140 and an apex point 148 for the radiused edge wall 142, 144 and a second wall portion 150 extending from the apex point 148 to a distal end 152 of the edge wall 142, 144. In one embodiment, a center of mass of the tilt rail (indicated by point 154) may generally be positioned equidistant from the apex points 148 along a reference line (indicated by dashed line 155) extending directly between the apex points 148. As will be described below with reference to FIGS. 9 and 10A, the center of mass 154 of the tilt rail 130 may, in one embodiment, be offset from the tilt axis 102 of the tilt system 100 by a given distance 156.

Additionally, as shown in FIG. 9, the tilt rail 130 further includes opposed internal sidewalls 158 extending between the distal end 152 of each radiused edge wall 142, 144 and the bottom wall 140 of the tilt rail 130. As shown in the illustrated embodiment, the internal sidewalls 158, along with the bottom wall 140, generally define an upward-facing, open-ended mounting channel 160. As will be described below, various components of the lift system 200 may be installed within the open-ended mounting channel 160 to allow such lift system components to be supported by the tilt rail 130 for rotation therewith about the tilt axis 102. Additionally, as particularly shown in FIG. 9, the internal sidewalls 158 of the tilt rail 130 may be configured to define mounting slots 162 along each side of the mounting channel 160. Such mounting slots 162 may allow for the various lift system components to be coupled to the tilt rail 130, such as by configuring such components to include corresponding mounting tabs or similar structure extending outwardly therefrom that is configured to be received within the opposed mounting slots 162. Moreover, the mounting slots 162 may also facilitate coupling the drive and idle ends 132, 134 of the tilt rail 130 to the tilt drive assembly 170 and the idle end plate 180, respectively.

Additionally, as shown in FIGS. 6-9 the tilt system may also include a rail cover 131 configured to be positioned over and cover the upward-facing open-ended mounting channel 160 of the rail 130. In several embodiments, the tilt rail 130 and rail cover 131 (along with the tilt drive assembly 170 and idle end plate 180 at the opposed ends 132, 134 of the rail 130) may generally define a tubular enclosure or chamber 164 (FIG. 9) for housing the components of the lift system 200. For instance, as indicated above and as shown in FIGS. 7 and 8, various lift system components may be installed within the upward-facing, open-ended mounting channel 160 defined by the tilt rail 130. In such an embodiment, when the rail cover 131 is positioned relative to the tilt rail 130 to cover the upward-facing, open end of the mounting channel 160 (and the tilt drive assembly 170 and idle end plate 180 are installed relative to the respective ends 132, 134 of the tilt rail 130), a tubular enclosure 164 (FIG. 9) is formed within which the lift system components are encapsulated or housed.

As particularly shown in FIG. 9, the rail cover 131 generally includes an arcuate or curved cover wall 133 extending circumferentially between a front edge portion 135 and a rear edge portion 137 of the rail cover 131. Additionally, as shown in FIG. 9, the rail cover 131 includes opposed support flanges 139 extending inwardly from the cover wall 133 adjacent to the front and rear edge portions 135, 137 of the rail cover 131. In several embodiments, the rail cover 131 may generally be configured to be installed relative to the tilt rail 130 such that the support flanges 139 generally extend adjacent to the top portions of the edge walls 142, 144 of the tilt rail 130 (e.g., the second wall portions 150 of the edge walls 142, 144) at respective support interfaces defined between the rail/cover, with the front and rear edge portions 135, 137 of the cover wall 133 extending downwardly from such interfaces towards the apex points 148 of the front and rear edge walls 142, 144 of the tilt rail 130, respectively. Moreover, as shown in FIG. 9, the tilt rail 130 and rail cover 131 may be configured such that front and rear cord reveals or “cord gaps” 143F, 143R are defined at the support interfaces between such components when the rail cover 131 is installed relative to the tilt rail 130. As shown in FIG. 6, the cord gaps 143F, 143R (only one of which is shown) may, in one embodiment, extend along the length of the front and rear sides of the tilt rail 130. In general, the cord gaps 143F, 143R may allow the front and rear runs 60, 62 of each ladder tape assembly 58 and lift cords 64, 66 to pass between the tilt rail 130 and rail cover 131 at the support interfaces from the interior of the enclosure or chamber 164 (FIG. 9) defined by such components and subsequently extend downwardly or depend from the front and rear edge walls 142, 144 of the tilt rail 130. For instance, as shown in FIG. 6, the front runs 60 of each ladder tape assembly 58 and the front lift cords 64 may extend through the front cord gap 143F and subsequent hang or depend from the front edge wall 142 of the tilt rail 130. Similarly, the rear runs 62 of each ladder tape assembly 58 and the rear lift cords 66 may extend through the rear cord cap 143R and subsequent hang or depend from the rear edge wall 144 of the tilt rail 130.

Referring still to FIGS. 6-9, the lift system 200 may generally include any suitable components provided in operative association with the tilt rail 130 that allows such components to function to raise and lower the bottom rail assembly 54 relative to the headrail assembly 52 of the associated covering 50. For instance, in several embodiments, the lift system 200 may include two or more lift stations 202 installed within the mounting channel 160 of the tilt rail 130. Specifically, as shown in FIGS. 7 and 8, the lift system 200 includes a respective lift station 202 for each pair of lift cords 64, 66 of the associated covering 50 (e.g., first and second lift stations 202 when the covering 50 includes first and second pairs of lift cords 64, 66), with each lift station 202 including a pair of lift spools 204 for winding and unwinding the respective front and rear lift cords 64, 66 of the corresponding pair of cords. Thus, as the bottom rail assembly 54 is being raised relative to the headrail assembly 52, each lift cord 64, 66 may be wound around its respective lift spool 204. Similarly, as the bottom rail assembly 54 is being lowered relative to the headrail assembly 52, each lift cord 64, 66 is unwound from its respective lift spool 204. Additionally, as shown in FIGS. 7 and 8, the lift system 200 may also include a motor/brake assembly 206 and a lift rod 208 installed relative to the mounting channel 160 of the tilt rail 130. As is generally, understood, the lift rod 208 may be configured to operatively couple the lift stations 202 to the motor/brake assembly 206. As a result, a motor 210 of the motor/brake assembly 206 may be configured to store energy with rotation of the lift spools 204 (and lift rod 208) in a lowering direction as the bottom rail assembly 54 is lowered relative to the headrail rail assembly 52 and release such energy to rotationally drive the lift rod 208 (and lift spools 204) in an opposite, raising direction as the bottom rail assembly 54 is being raised relative to the headrail assembly 52 to assist in moving the covering 50 to its retracted position. Additionally, a brake 212 of the motor/brake assembly 206 may be configured to prevent unintended rotation of the lift rod 208. In one embodiment, the brake 212 may be configured to provide a holding force for the lift system 200 to assist with maintaining the shade at the desired position.

As should be appreciated by those of ordinary skill in the art, the ladder tape assemblies 58 may depend from the tilt rail 130 such that rotation of the tilt rail 130 about the tilt axis 102 results in the front and rear ladder runs 60, 62 of the ladder tape assemblies 58 being raised/lowered in opposite directions to effectuate tilting of the slats 56. Specifically, in several embodiments, an end of each ladder run 60, 62 (e.g., a grommeted or knotted end) may be coupled to an interior portion of the tilt rail 130 or to a component installed within the tilt rail 130 (e.g., a housing of the adjacent tilt station 202) to secure the ladder tape assembly 58 relative to the tilt rail 130. Additionally, as indicated above, each ladder run 60, 62 may extend from such interior connection point through the cord gap 143F, 143R (FIG. 9) defined between the tilt rail 130 and the rail cover 131 and at least partially wrap around the adjacent radiused edge wall 142, 144 of the tilt rail 130 prior to extending downwardly from the tilt rail 130 towards the bottom rail assembly 54 of the associated covering 50. In this regard, as the tilt rail 130 is rotated in a first or closed-down rotational direction about the tilt axis 102 (e.g., as indicated by arrow CD in FIG. 9) to tilt the front edges of the slats 56 downwards towards the closed-down position, the front ladder run 60 will be shifted downward as the front edge wall 142 of the tilt rail 130 pivots downwardly and the rear ladder run 62 will be shifted upward as the rear edge wall 144 of the tilt rail 130 pivots upwardly. Similarly, as the tilt rail 130 is rotated in an opposed second or closed-up rotational direction about the tilt axis 102 (e.g., as indicated by arrow CU in FIG. 9) to tilt the front edges of the slats 56 upwards towards the closed-up position, the front ladder run 60 will be shifted upward as the front edge wall 142 of the tilt rail 130 pivots upwardly and the rear ladder run 62 will be shifted downwardly as the rear edge wall 144 of the tilt rail 130 pivots upwardly.

For example, FIGS. 10A-10C illustrate various end views of the tilt rail 130 and rail cover 131 (as assembled) oriented at different positions corresponding to different tilt positions of the slats 56 of the associated covering 50. FIGS. 10A-10C further show a pair of front and rear ladder runs 60, 62 of a ladder tape assembly 58 and pair of front and rear lift cords 64, 66 depending from the tilt rail 130 (with the front runs/cords being shown as a single line 60, 64 and the rear runs/cords being shown as a single line 62, 66 for ease of illustration), particularly illustrating how such cords/runs 60, 62, 64, 66 wrap around or engage the tilt rail 130 as it is being tilted to adjust the tilt position of the slats 56.

As shown in FIG. 10A, when the slats 56 of the associated covering 50 are at the fully opened position (e.g., the position shown in FIG. 1), the tilt rail 130 is disposed at a substantially horizontal orientation. At such orientation, the ladder runs 60, 62 and lift cords 64, 66 generally depend from the tilt rail 130 at the apex points 148 (FIG. 9) of the front and rear edge walls 142, 144 of the rail 130. To transition the slats 56 from the fully opened position to the closed-down position, the tilt rail 130 is rotated about the tilt axis 102 in the closed-down direction (indicated by arrow CD in FIG. 10A) from the substantially horizontal orientation shown in FIG. 10A to the substantially vertical orientation shown in FIG. 10B, at which point the front edge wall 142 of the tilt rail 130 generally faces downward and the rear edge wall 144 of the tilt rail 130 generally faces upward. Such rotation of the tilt rail 130 results in tilting of the slats 56 to the closed-down position as the front ladder run 60 is lowered simultaneously with the rear ladder run 62 being raised. For instance, as shown in FIG. 10B, in addition to the difference in height between the front and rear edge walls 142, 144 of the tilt rail 130, rotation of the tilt rail 130 to the position shown in FIG. 10B results in the front ladder run 60 depending directly from the cord gap 143F defined between tilt rail 130 and rail cover 131 (as opposed to the apex point of the front edge wall 142 as shown in FIG. 10A) and the rear ladder run 62 partially wrapping around the tilt rail 130 (e.g., around the rear edge wall 144 and potentially a portion of the bottom wall 140 of the tilt rail 130), thereby effectively lowering the front ladder run 60 and raising the rear ladder run 62.

Similarly, to transition the slats 56 from the fully opened position to the closed-down position, the tilt rail 130 is rotated about the tilt axis 102 in the closed-up direction (indicated by arrow CU in FIG. 10A) from the substantially horizontal orientation shown in FIG. 10A to the substantially vertical orientation shown in FIG. 10C, at which point the rear edge wall 144 of the tilt rail 130 generally faces downward and the front edge wall 142 of the tilt rail 130 generally faces upward. Such rotation of the tilt rail 130 results in tilting of the slats 56 to the closed-up position as the rear ladder run 62 is lowered simultaneously with the front ladder run 60 being raised. For instance, as shown in FIG. 10C, in addition to the difference in height between the front and rear edge walls 142, 144 of the tilt rail 130, rotation of the tilt rail 130 to the position shown in FIG. 10C results in the rear ladder run 62 depending directly from the cord gap 143R defined between tilt rail 130 and rail cover 131 (as opposed to the apex point of the rear edge wall 144 as shown in FIG. 10A) and the front ladder run 60 partially wrapping around the tilt rail 130 (e.g., around the front edge wall 142 and potentially a portion of the bottom wall 140 of the tilt rail 130), thereby effectively lowering the rear ladder run 62 and raising the front ladder run 60.

As indicated above, the tilt axis 102 for the tilt system 100 may be offset from the center of mass 154 of the tilt rail 130 by a given distance. Specifically, in several embodiments, the tilt axis 102 may be positioned below the center of mass 154 of the tilt rail 130. For instance, as particularly shown in FIG. 10A, when the tilt rail 130 is disposed at its substantially horizontal position, the tilt axis 102 is located directly below the center of mass 154 of the tilt rail 130 and spaced apart therefrom by a given radial distance 156, such as a distance 156 ranging from about 0.05 inches to about 0.5 inches or from about 0.05 inches to about 0.25 inches or from about 0.10 inches to about 0.20 inches. By placing the tilt axis 102 below the center of mass 154 of the tilt rail 130, the tilt rail 130, itself, provides an additional moment arm about the tilt axis 102 that pulls the rail 130 downwardly in either the closed-down or closed-up direction CD, CU (depending on the tilt direction), thereby facilitating proper closure of the slats 56 in the respective closed-down or closed-up position.

Additionally, it should be appreciated that, by configuring the front and rear lift cords 64, 66 to depend from the tilt rail 130 in the same manner as the front and rear ladder runs 60, 62, the above-described rotation of the tilt rail 130 similarly results in the same effective relative “raising” and “lowering” of the lift cords 64, 66. Specifically, as the tilt rail 130 is being rotated in the closed-down direction CD from the position shown in FIG. 10A to the position shown in FIG. 10B, the front lift cord 64 may be lowered by the same amount or magnitude as the front ladder run 60 while the rear lift cord 66 may be raised by the same amount or magnitude as the rear ladder run 62. Similarly, as the tilt rail 130 is being rotated in the closed-up direction CU from the position shown in FIG. 10A to the position shown in FIG. 10B, the rear lift cord 66 may be lowered by the same amount or magnitude as the rear ladder run 62 while the front lift cord 64 may be raised by the same amount or magnitude as the front ladder run 60. As a result of such simultaneous raising/lowering of the lift cords 64, 66 and ladder runs 60, 63, the vertical positioning of the center of mass of the bottom rail assembly 54 of the covering 50 may remain relatively stationary as the slats 56 are being tilted. In other words, the bottom rail assembly 54 will not generally move vertically up or down with tilting of the slats 56.

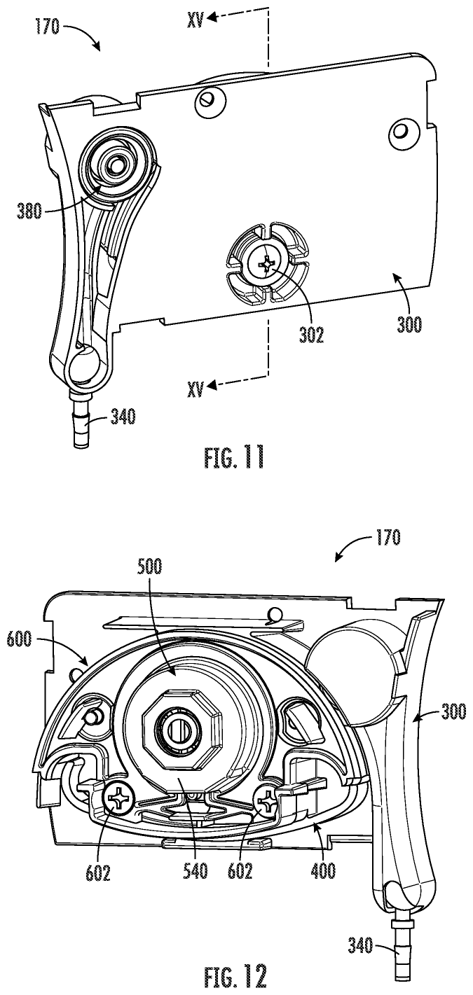

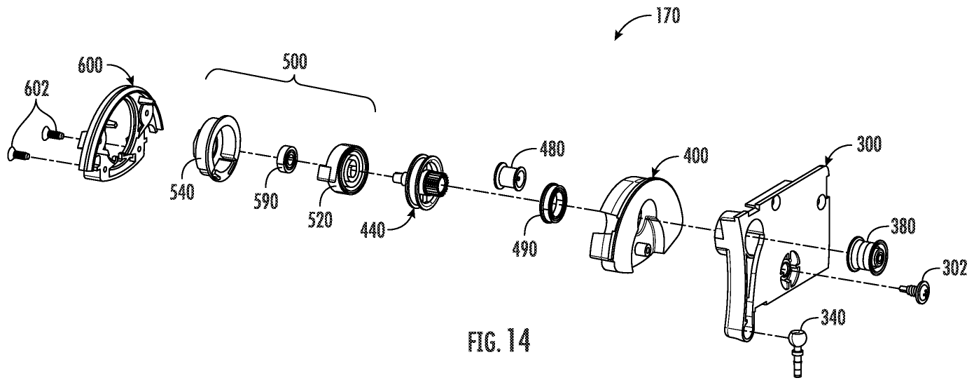

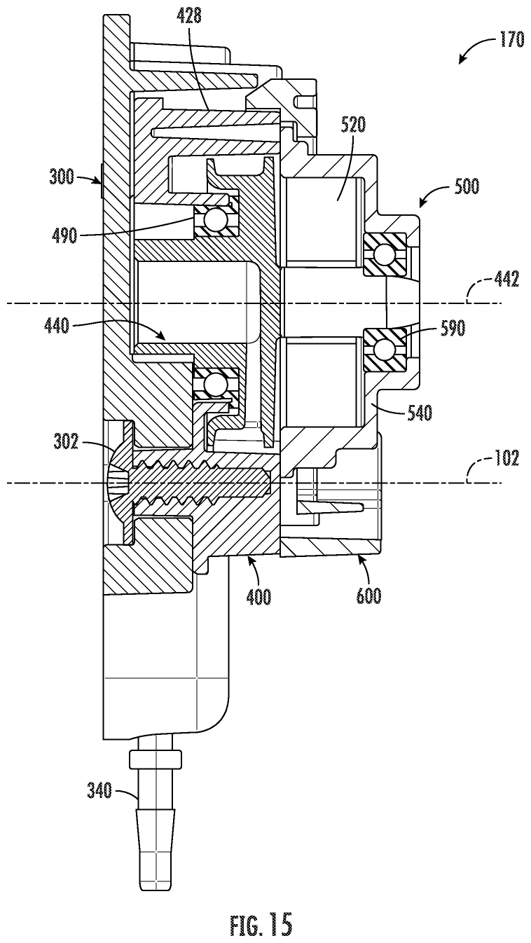

Referring now to FIGS. 11-15, various perspective views of one embodiment of a tilt drive assembly (e.g., tilt drive assembly 170) suitable for use within one or more embodiments of a tilt system (e.g., disclosed tilt system 100) are illustrated in accordance with aspects of the present subject matter. Specifically, FIGS. 11 and 12 illustrate opposed perspective, assembled views of the tilt drive assembly 170 and FIGS. 13 and 14 illustrate opposed perspective, exploded views of the tilt drive assembly 170 shown in FIGS. 11 and 12, respectively. Additionally, FIG. 15 illustrates a cross-sectional view of the tilt drive assembly 170 taken about line XV-XV in FIG. 11.

As particularly shown in FIGS. 13 and 14, the tilt drive assembly 170 includes both an outer end plate 300 and an inner end plate 400. The outer end plate 300 generally corresponds to a fixed component of the tilt drive assembly 170. For instance, as will be described below, the outer end plate 300 may be configured to be fixedly coupled to the mounting rail 80 of the headrail assembly 52 for supporting the remainder of the headrail assembly 52 relative to the mounting rail 80. The outer end plate 300 may also be configured to be coupled to the adjacent endcap of the headrail assembly 52 (e.g., the first endcap 74 (FIG. 2)). In contrast, the inner end plate 400 generally corresponds to a rotatable or pivotable component of the tilt drive assembly 170. Specifically, in several embodiments, the inner end plate 400 may be configured to be coupled to the outer end plate 300 (e.g., via a suitable fastener 302) for rotation about the tilt axis 102 of the tilt system 100. As such, the inner end plate 400 (and any other tilt system components coupled thereto or supported thereby) may be configured to rotate or pivot relative to the fixed outer end plate 300 of the tilt drive assembly 170.

Additionally, the tilt drive assembly 170 includes various cord-related components supported by the end plates 300, 400 that are configured to engage or interact with the tilt cord 112. For instance, as particularly shown in FIGS. 13 and 14, the tilt drive assembly 170 includes a wand pivot member 340 and a capstan assembly 380 configured to be coupled to or supported by the outer end plate 300, and further includes a drive pulley 440 and an auxiliary cord pulley 480 configured to be coupled to or supported by the inner end plate 400 (e.g., via pulley bearing 490). A cord path is defined within the tilt drive assembly 170 to allow the tilt cord 112 to engage or interact with each of such various cord-related components. For instance, as will be described in greater detail below, the tilt cord 112 may enter the tilt drive assembly 170 via the wand pivot member 340 and extend upwardly through a portion of the outer end plate 300 to the capstan assembly 380, at which point the tilt cord 112 may be wrapped around a portion of the capstan assembly 380 a suitable number of times. The tilt cord 112 may then pass through a cord opening 338 (FIG. 16) defined in the outer end plate 300 to allow the cord 112 to extend along a cord guide surface 428 (FIG. 15) of the inner end plate 400. The cord 112 may then at least partially wrap around the auxiliary pulley 480 prior to extending to the drive pulley 440, at which point an end of the tilt cord 112 is coupled to the drive pulley 440 to allow the cord 112 to be wound around and unwound from such pulley with rotation thereof about a separate pulley axis 442 (FIG. 15) spaced apart radially from the tilt axis 102.

Moreover, as shown in FIGS. 13 and 14, the tilt drive assembly 170 includes a drive spring assembly 500 provided in operative association within the drive pulley 440. In general, the drive spring assembly 500 functions to provide a spring-return for the tilt drive assembly 170 to bias the drive pulley 440 to rotate in the closed-up direction CU. As shown in the illustrated embodiment, the drive spring assembly 500 includes a drive spring 520 (e.g., a clock spring), a spring cup 540, and an associated bearing 590. As will be described in greater detail below, the spring 520 may be coupled directly between the drive pulley 440 and the spring cup 540 such that, when the tilt cord 112 is pulled downwardly (e.g., via the tilt wand 110) to cause the slats 56 to be tilted towards the closed-down position, the drive pulley 440 (along with the tilt rail 130 and any other tilting component of the tilt system 100) rotates about the tilt axis 102 in the closed-down direction CD, thereby causing the spring 520 to wind-up within the spring cup 540 and store energy. However, when the tension is relieved from the tilt cord 112 (e.g., by raising the second wand portion 116 of the tilt wand 110 relative to the first wand portion 114 of the tilt wand 110), the spring 520 may be configured to unwind or release its stored energy to rotationally drive the drive pulley 440 in the opposed, closed-up direction CU, thereby causing the slats 56 to be tilted towards the closed-up position.

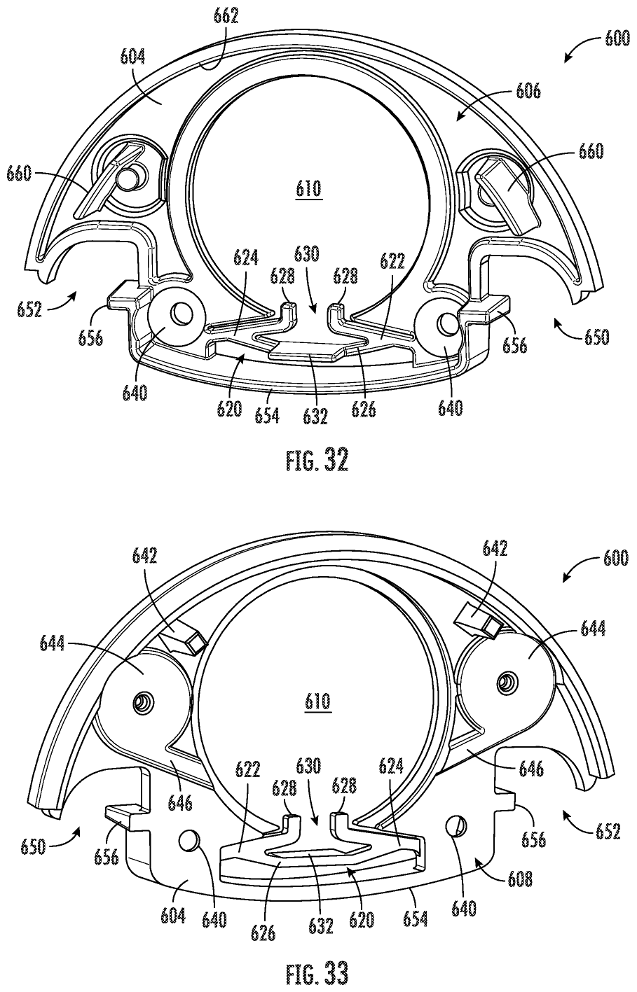

Further, as shown in FIGS. 13 and 14, the tilt drive assembly 170 may also include an end plate cover 600 configured to be coupled to the inner end plate 400 (e.g., via suitable fasteners 602). When coupled together, the end plate cover 600 and the inner end plate 400 may generally be configured to trap the drive spring assembly 500 therebetween, thereby maintaining such assembly components in place in the lateral or axial direction. Additionally, as will be described below, the end plate cover 600 may include a locking mechanism 620 (FIG. 32) to allow the spring cup 540 to be selectively rotationally disengaged or decoupled from the end plate cover 600 to “pre-wind” the drive spring 520 and may also function as a cord guard to maintain the tilt cord 112 laterally in place along the outer cord guide surface 428 (FIG. 15) of the inner end plate 400 as the cord 112 slides relative thereto while tilting the slats 56.

The various components and sub-assemblies of the tilt drive assembly 170 noted above will now be described in more detail with reference to FIGS. 16-35.

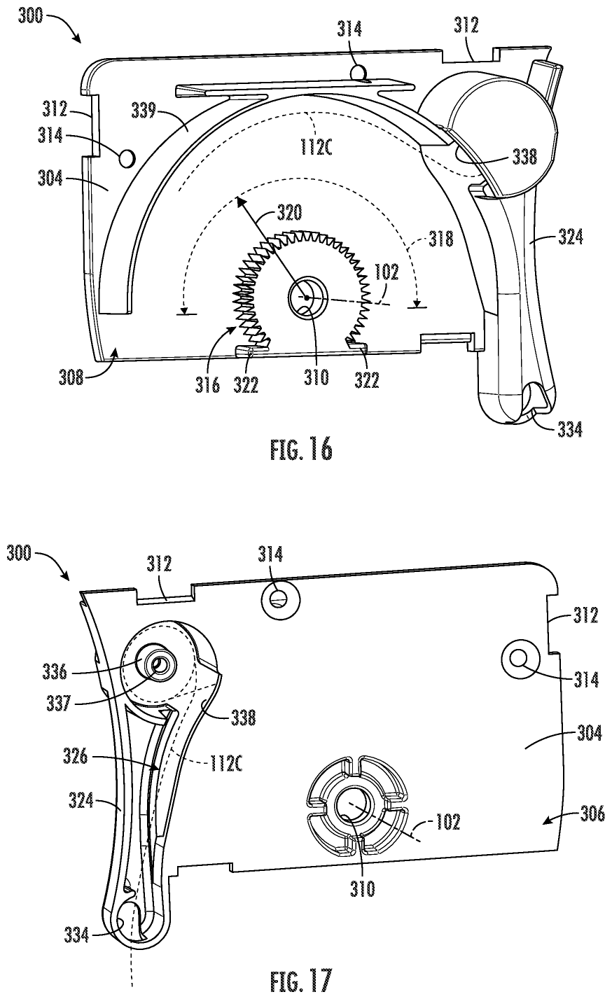

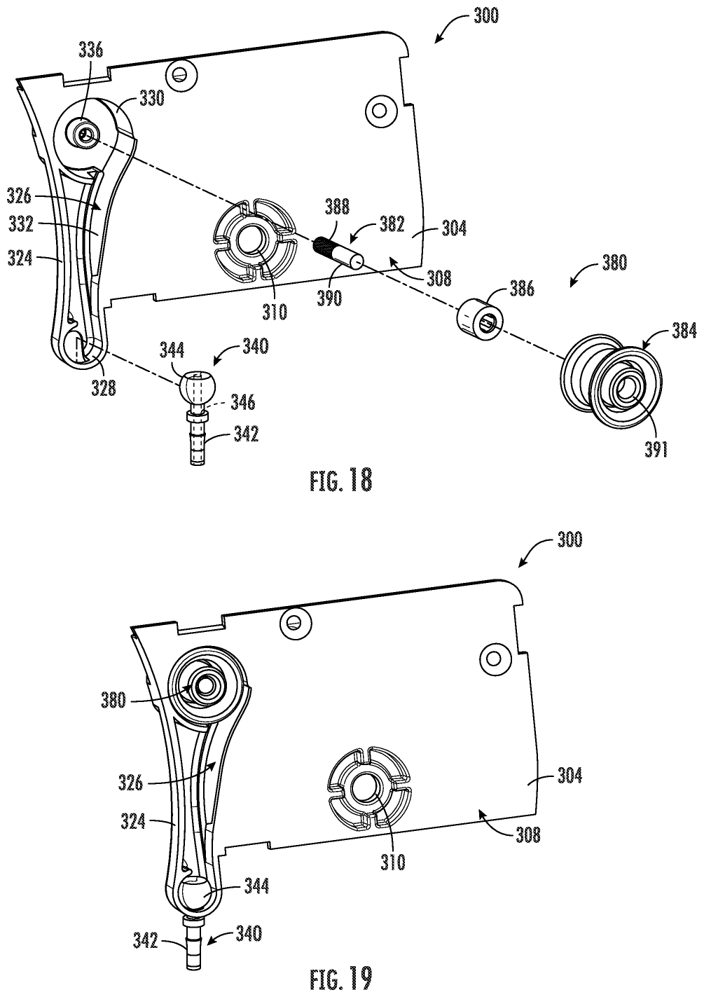

Referring specifically to FIGS. 16-19, various views of the outer end plate 300 and associated components of the tilt drive assembly 170 are illustrated in accordance with aspects of the present subject matter. Specifically, FIGS. 16 and 17 illustrate opposed perspective views of the outer end plate 300. Additionally, FIGS. 18 and 19 illustrate perspective views of the outer end plate 300 with the capstan assembly 380 and the wand pivot member 340 assembled and exploded, respectively, relative thereto.

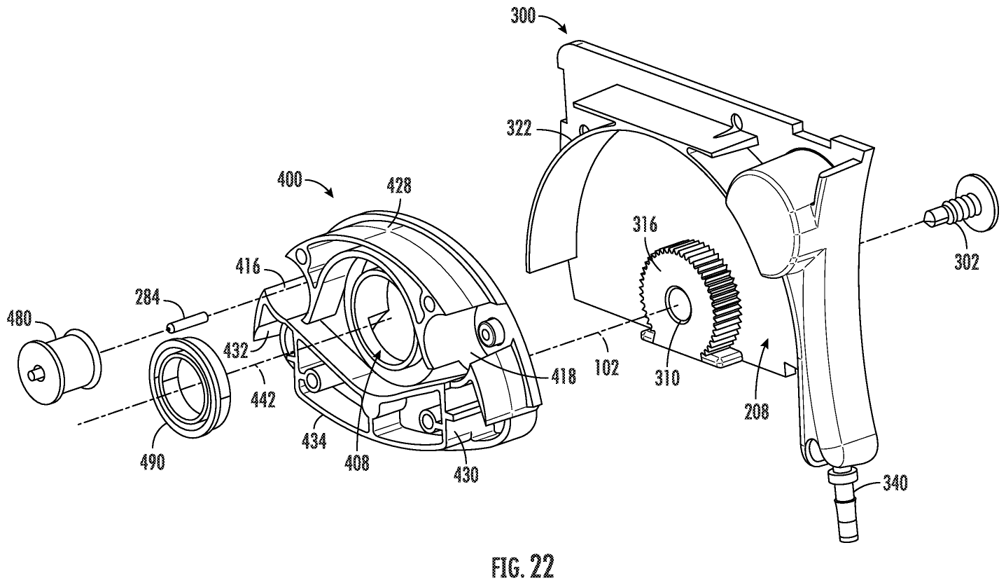

As particularly shown in FIGS. 16 and 17, the outer end plate 300 generally includes a planar wall portion 304 at least partially defining an outer side 306 (FIG. 17) of the end plate 300 that is configured to face towards the adjacent endcap of the headrail assembly 52 (e.g., the first endcap 74 (FIG. 2)) and an inner side 308 (FIG. 16) of the end plate 300 that is configured to face towards the inner end plate 400 (FIGS. 13 and 14). A tilt axis opening 310 is defined through the wall portion 304 and extends coaxially along tilt axis 102 of the tilt system 100 from the outer side 306 of the end plate 300 to the inner side 308 of the end plate 300. As will be described below with reference to FIGS. 21 and 22, a portion of the inner end plate 400 (e.g., a stub shaft or journal 412 of the inner end plate 400) may be configured to extend through the tilt axis opening 310 to allow the inner end plate 400 to be rotationally coupled to the outer end plate 300 (e.g., via fastener 302 shown in FIGS. 11 and 13-15) in a manner that permits the inner end plate 400 to rotate relative to the outer end plate 300 about the tilt axis 102.

The outer end plate 300 may also be configured to include or define suitable mounting features for coupling the adjacent endcap 74 (FIG. 2) to the end plate 300 and for securing the end plate 300 to the mounting rail 80 (FIG. 2) of the headrail assembly 52. For instance, as shown in FIGS. 16 and 17, the wall portion 304 of the end plate 300 defines notches 312 configured to receive corresponding mounting hooks or tabs of the endcap 74 for coupling such endcap 74 to the outer end plate 300. Additionally, as shown in FIG. 17, a plurality of fastener openings 314 (e.g., counter-bored fastener openings) may be defined through the wall portion 304 for receiving suitable fasteners for rigidly coupling the outer end plate 300 to the mounting rail 80.

Additionally, as shown in FIG. 16, the outer end plate 300 includes a fixed gear or “gear portion” 316 positioned along the inner side 308 of the end plate 300 that is centered about the tilt axis 102. In general, the gear portion 316 of the outer end plate 300 may be configured to mesh with a corresponding gear portion 466 (FIG. 25) of the drive pulley 440 of the tilt drive assembly 170 such that rotation of the drive pulley 440 about its separate pulley axis 442 results in the pulley 440 traveling in an arced path around the gear portion 316 of the outer end plate 300. For instance, as shown schematically in FIG. 16, the pulley axis 442 defined by the drive pulley 440 may generally travel around the gear portion 316 along an arced path (indicated by dashed line 318) centered about the tilt axis 102 such that a radius of curvature 320 of the arced path 318 generally corresponds to the radial distance defined between the tilt axis 102 and the pulley axis 442 of the drive pulley 440. As shown in FIG. 16, in one embodiment, the outer end plate 300 may also include stop flanges 322 or similar projections along the bottom end of the gear portion 316 to act as mechanical stops for the drive pulley 440, thereby limiting the maximum arc length of the arced travel path 318 of the drive pulley 440 relative to the gear portion 316. It should be appreciated that, in the illustrated embodiment, the gear portion 316 of the outer end plate 300 is formed integrally with the wall portion 304 of the end plate 300. However, in other embodiments, the gear portion 316 of the outer end plate 300 may be formed by a gear or gear component that is separately coupled to the wall portion 304 of the end plate 300.

As shown in FIGS. 16 and 17, the outer end plate 300 also includes a sidewall portion 324 defining an elongated cavity 326 (FIG. 17) along the outer side 306 of the end plate 300. In general, the cavity 326 may be configured to receive one or more cord-related components of the tilt drive assembly 170, such as the capstan assembly 380 and the wand pivot member 340. For instance, as particularly shown in FIG. 18, the cavity 326 includes a lower cavity portion 328 configured to receive a corresponding portion of the wand pivot member 340 and an upper cavity portion 330 configured to receive one or more components of the capstan assembly 380. In addition, an intermediate cavity portion 332 (FIG. 18) extending between the upper and lower cavity portions 330, 328 generally functions as an open cord cavity for receiving the portion of the tilt cord 112 that extends between the wand pivot member 340 and the capstan assembly 380. It should be appreciated that, when the adjacent endcap 74 (FIG. 2) is installed against the outer side 306 of the outer end plate 300, the endcap 74 may function to enclose or cover the cavity 326 and retain the various cord-related components therein.

As particularly shown in FIGS. 18 and 19, the wand pivot member 340 includes a lower connector portion 342 configured to be coupled to a corresponding portion of the tilt wand 110. For instance, in one embodiment, the lower connector portion 342 may be configured to be pressed into the upper end 114A of the first wand portion 114 (FIGS. 4 and 5) of the tilt wand 110. The wand pivot member 340 also includes an upper ball portion 344 configured to form a pivot or ball joint for pivoting the tilt wand 110 relative to the outer end plate 300. To install the wand pivot member 340 relative to the outer end plate 300, the lower connector portion 342 may be inserted into the lower cavity portion 328 (FIG. 18) of the cavity 326 defined by the end plate 300 and through a cord inlet opening 334 (FIGS. 16 and 17) defined through the sidewall portion 324 of the outer end plate 300 adjacent to the lower cavity portion 328. The upper ball portion 344 (having a diameter that is larger than the cord inlet opening 334) may then be retained within the lower cavity portion 328 to form the pivot or ball joint about which the tilt wand 110 can be pivoted relative to the outer end plate 300. Additionally, as shown in FIG. 18 a lengthwise through-hole (indicated by dashed lines 346) may be defined along the length of the wand pivot member 340 (e.g., through both the lower connector portion 342 and the upper ball portion 344) to allow the tilt cord 112 to pass through the wand pivot member 340. As such, with the wand pivot member 340 installed relative to the outer end plate 300 as shown in FIG. 19, the tilt cord 112 may extend through the wand pivot member 340 and into the cavity 326 defined by the outer end plate 300.

Moreover, as shown in FIG. 18, the capstan assembly 380 generally includes a fixed shaft 382, a capstan pulley 384, and a one-way brake or bearing 386 configured to be installed relative to both the upper cavity portion 330 of the cavity 326 defined by the end plate 300 and an associated mounting journal 336 extending within the upper cavity portion 330. Specifically, to install the capstan assembly 380 relative to the outer end plate 300, the shaft 382 may be pressed into a journal opening 337 (FIG. 17) defined by the mounting journal 336 such that the shaft 382 is rotationally fixed relative to the outer end plate 300. For example, as shown in FIG. 18, the shaft 382 may include both a knurled portion 388 and a cylindrical portion 390, with the knurled portion 388 configured to be inserted into the journal opening 337 to prevent the shaft 382 from rotating within the journal 336. Additionally, the one-way bearing 386 may be configured to be pressed into a central bearing opening 391 (FIG. 18) defined by the capstan pulley 384 such that an outer race of the bearing 386 is coupled to the pulley 384 for rotation therewith. The tilt cord 112 may then be wrapped around the pulley 384 a suitable number of times depending on the desired amount of friction prior to the pulley/bearing assembly being installed within the upper cavity portion 330 of the cavity 326 relative to the shaft 382. For instance, in one embodiment, the bearing 386 may be pressed onto the cylindrical portion 390 of the shaft 382 so that an inner race of the bearing 386 is rotationally fixed to the shaft 382. This assembly generally creates a one-way capstan within the upper cavity portion 330 that functions to provide a holding force (e.g., via the frictional force between the capstan pulley 384 and the tilt cord 112) to counter-balance the return force provided by the drive spring 520 of the tilt drive assembly 170. For instance, in one embodiment, the capstan pulley 384 may be configured to only rotate in the closed-down direction CD as the tilt cord 112 is pulled downwardly to rotate the slats 56 to the closed-down position. In such an embodiment, when the user releases the tilt wand 110, the weight of the tilt wand 110 combined with the multiplying effect of the one-way capstan will hold the slats 56 at a steady position. When it is desired to tilt the slats 56 to the closed-up position, the weight may be removed from the tilt cord 112 (e.g., by lifting up the second wand portion 116 of the tilt wand 110) to reduce the friction between the cord/pulley and allow the tilt cord 112 to slip around the capstan pulley 384 as the drive spring 520 rotationally drives the drive pulley 440 in the closed-up direction to wind-up the cord 112 around the drive pulley 440.

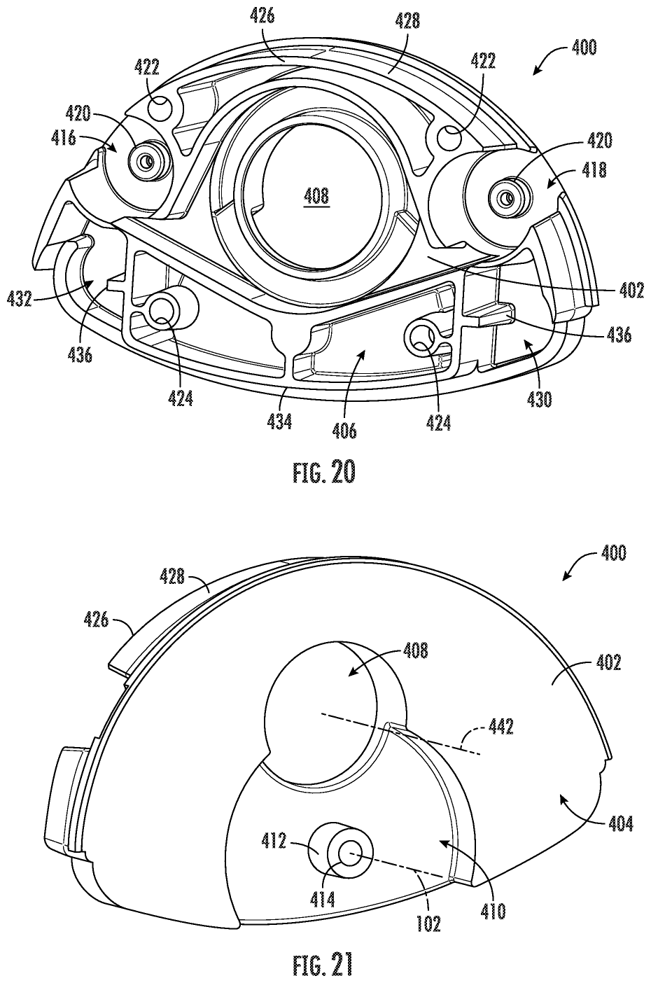

The cord path followed by the tilt cord 112 through the cavity 326 defined by the end plate 300 (e.g., when the capstan assembly 380 and wand pivot member 340 are installed relative to outer end plate 300) is shown schematically by the dashed line 112C in FIGS. 16 and 17. Specifically, as shown in FIG. 17, the tilt cord 112 passes through the wand pivot member 340 (FIG. 19) and extends upwardly through the cavity 326 to the capstan assembly 380 (FIG. 19), at which point the cord 112 wraps around the pulley 384 a given number of times. The tilt cord 112 then exits the cavity 326 through an upper cord outlet opening 338 (FIGS. 16 and 17) and extends across an arced cord path 112C (see FIG. 16) defined along the inner side 308 of the outer end plate 300, with an arcuate cord flange 339 (FIG. 16) of the end plate 300 generally defining a radially outward boundary for the arced cord path 112C. As will be described in greater detail below with reference to FIGS. 20, 21, and 23, an adjacent cord guide surface 428 of the inner end plate 400 may generally define a radially inward boundary for the arced cord path 112C of the tilt cord 112 when the inner end plate 400 is installed relative to the outer end plate 300.

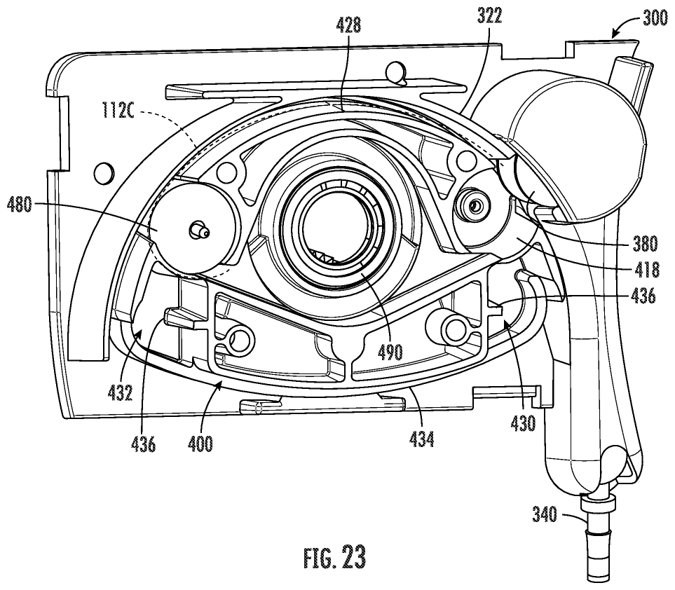

Referring now to FIGS. 20-23, various views of the inner end plate 400 and associated components of the tilt drive assembly 170 are illustrated in accordance with aspects of the present subject matter. Specifically, FIGS. 20 and 21 illustrate opposed perspective views of the inner end plate 400. Additionally, FIG. 22 illustrates a perspective view of the inner end plate 400 with the drive pulley bearing 490, auxiliary pulley 480 (and associated pulley shaft 482), and outer end plate 300 (including the capstan assembly 380 and wand pivot member 340 as installed relative to the plate 300) exploded away therefrom, while FIG. 23 illustrates a perspective view of the various components shown in FIG. 22 in an assembled state.

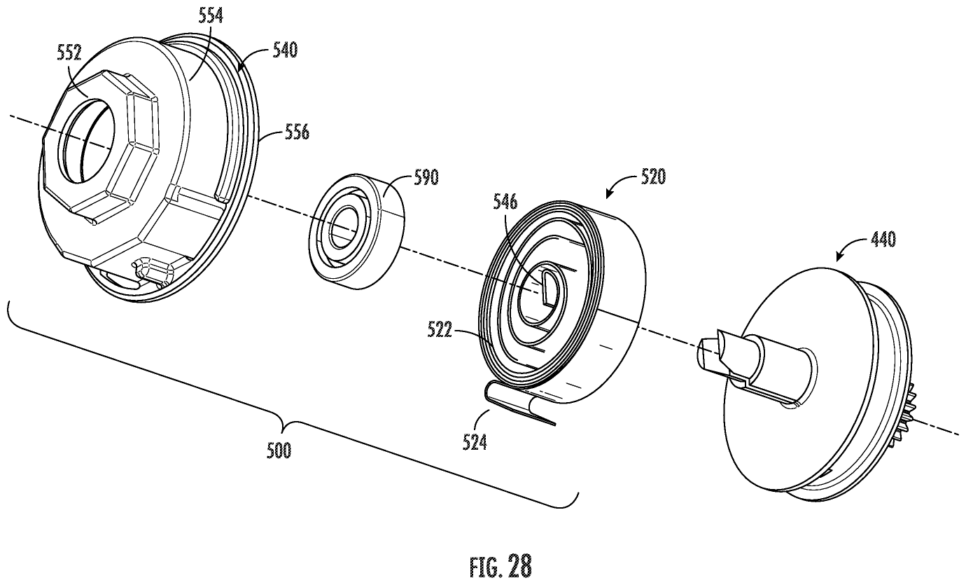

As particularly shown in FIGS. 20 and 21, the inner end plate generally includes a planar wall portion 402 at least partially defining an outer side 404 (FIG. 21) of the end plate 400 that is configured to face towards the outer end plate 300 and an inner side 406 (FIG. 20) of the end plate 400 that is configured to face towards the end plate cover 600 of the tilt drive assembly 170. A drive pulley opening 408 is defined through the wall portion 402 and is configured to extend coaxially along the pulley axis 442 (FIG. 21) of the drive pulley 440 from the outer side 404 of the end plate 400 to the inner side 406 of the end plate 400. As shown in FIGS. 22 and 23, the drive pulley bearing 490 is generally configured to be pressed into drive pulley opening 408. For instance, in one embodiment, the drive pulley bearing 490 may be pressed into the opening 408 such that an outer race of the bearing 490 is rotationally fixed relative to the inner end plate 400. As will be described below with reference to FIGS. 28-31, a portion of the drive pulley 440 (e.g., a bearing post portion of the drive pulley) may be configured to be pressed through the bearing 490 to provide a low friction rotational interface for the drive pulley 440 to rotate relative to the inner end plate 400 about its pulley axis 442.

As particularly shown in FIG. 21, the inner end plate 400 further defines a recessed cavity 410 along the outer side 404 of the plate 400 and further includes a stub shaft or journal 412 extending outwardly from the center of the cavity 410 along the tilt axis 102 of the tilt system 100. As indicated above, the journal 412 may be configured to be received within and extend through the tilt axis opening 310 (FIG. 22) defined by the outer end plate 300 to allow the inner end plate 400 to be rotationally coupled to the outer end plate 300 in a manner that permits the inner end plate 400 to rotate relative to the outer end plate 300 about the tilt axis 102. As shown in FIG. 21, the journal 412 defines a central fastener opening 414 to allow a suitable fastener (e.g., fastener 302 shown in FIG. 22) to be inserted into the opening 414 from the outer side 404 of the outer end plate 400 to maintain the journal 412 positioned within the tilt axis opening 310. For instance, the fastener 302 may not be tightened-up fully against the outer side 306 of the outer end plate 300 to allow relatively uninhibited rotation of the inner end plate 400 relative to the outer end plate 300 about the tilt axis 102.

Additionally, as shown in FIG. 20, the inner end plate 400 includes various structural walls or ribs extending outwardly from the planar wall portion 402 along the inner side 406 of the inner end plate 400 to define or form various cavities, surfaces, or other features of the end plate 400. For instance, in the illustrate embodiment, the various structural wall or ribs are arranged or configured to define a pair of pulley cavities 416, 418 for receiving the auxiliary cord pulley 480 of the tilt drive assembly 170. Specifically, as shown in FIG. 20, a first or rear pulley cavity 416 is defined along a rear side of the drive pulley opening 408 while a second pulley cavity 418 is defined along a front side of the drive pulley opening 408. The dual cavity arrangement provides the inner end plate 400 with a symmetrical configuration, thereby allowing the inner end plate 400 to be used with an outer end plate having a mirrored geometry for installation along the opposed lateral end of the headrail assembly 52, when desired. In general, the pulley cavity is positioned on the opposite side of the tilt drive assembly 170 relative to which the capstan assembly 380 is located. Thus, in the illustrated embodiment shown in FIGS. 22 and 23, the auxiliary cord pulley 480 is configured to be installed within the first pulley cavity 416 such that the auxiliary cord pulley 480 is located on the rear side of the tilt drive assembly 170 relative to the tilt axis 102 while the capstan assembly is located on the front side of the tilt drive assembly 170 relative to the tilt axis 102. As particularly shown in FIG. 20, the inner end plate 400 may also include a stub shaft or mounting journal 420 positioned within the center of each pulley cavity 416, 418. As such, to install the auxiliary cord pulley 480 relative to the inner end plate 400, an associated pulley shaft 482 may be initially pressed into the mounting journal 420 prior to inserting the pulley 480 into the cavity 416 along the shaft 482 to allow the pulley 480 to be supported relative to the inner end plate 400 for rotation about the shaft 482.

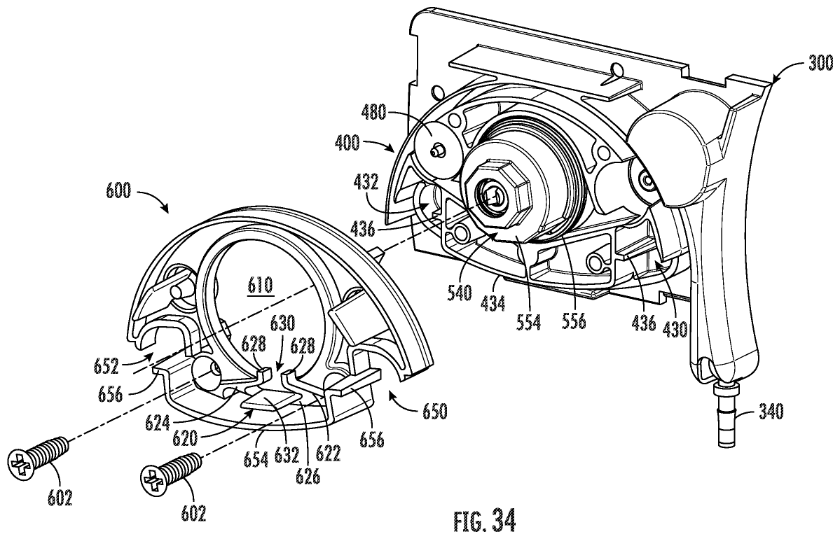

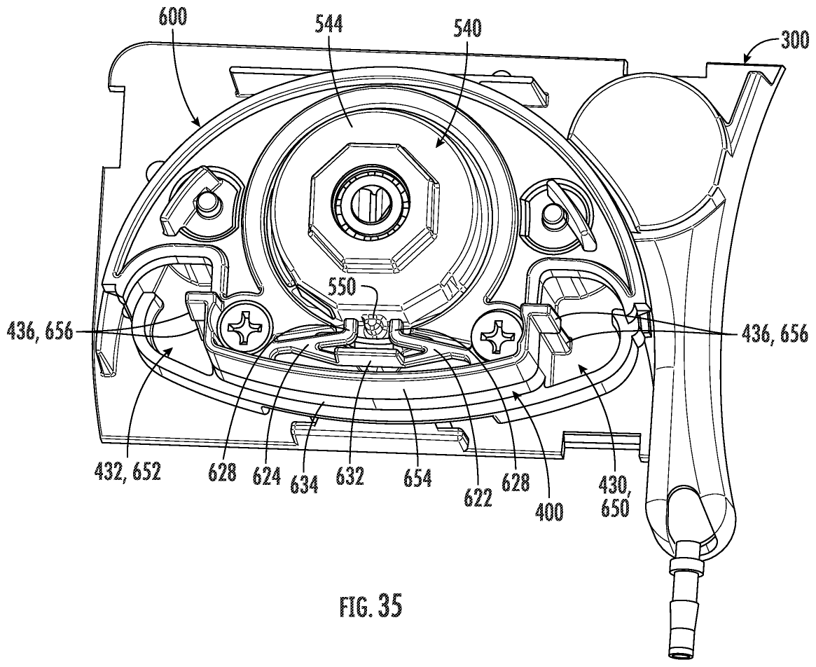

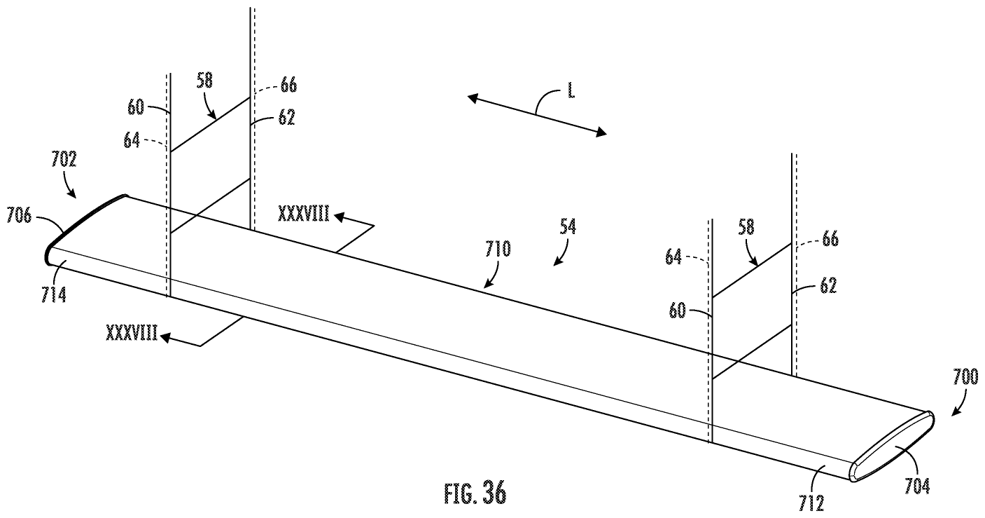

Moreover, the various structural walls or ribs extending outwardly along the inner side 406 of the inner end plate 400 may also be arranged or configured to define or form mounting features for mounting the end plate cover 600 of the tilt drive assembly to inner end plate 400. For instance, as shown in FIG. 20, the inner end plate 400 includes both a pair of upper mounting openings 422 and a pair of lower mounting openings 424. As will be described below with reference to FIGS. 32 and 33, in one embodiment, the upper mounting openings 422 may be configured to receive corresponding features of the end plate cover 600 (e.g., a mounting pins 642 (FIG. 33) of the end plate cover 600) while the lower mounting openings 424 may be configured to be aligned with corresponding fastener openings 640 defined through the end plate cover 600 for receiving suitable fasteners (e.g., fasteners 602 shown in FIG. 34).

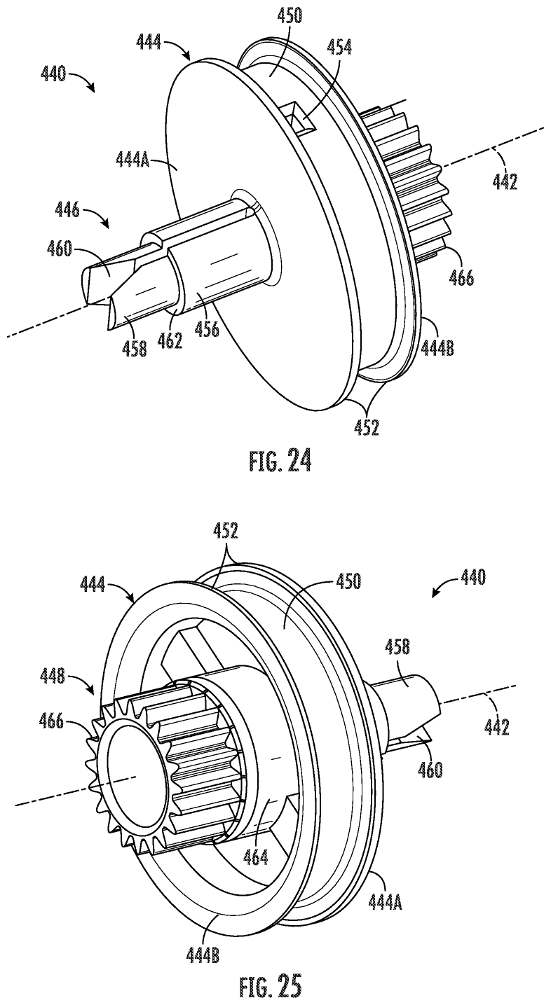

Additionally, the various structural walls or ribs extending outwardly along the inner side 406 of the inner end plate 400 may further be arranged or configured to define or form a cord guide surface for the tilt cord 112. Specifically, as shown in FIG. 20, the inner end plate 400 includes an arcuate wall or rib 426 extending outwardly along the inner side 406 of the inner end plate 400 at the top side thereof that defines an arced cord guide surface 428. In such an embodiment, the portion of the tilt cord 112 positioned between the capstan assembly 380 and the auxiliary cord pulley 480 may extend along the cord guide surface 428. For instance, the arced cord path 112C described above with reference to FIG. 16 is also illustrated in FIG. 23. As shown in FIG. 23, the tilt cord 112 is configured to be positioned radially between the cord guide surface 428 and the arcuate cord flange 322 of the outer end plate 300 as it extends between the capstan assembly 380 and the auxiliary cord pulley 480. Thus, as the tilt cord 112 exits the capstan assembly 380 and passes through the cord outlet opening 338 (FIG. 16) defined by the outer end plate 300, the cord extends along the arcuate cord guide surface 428 until it reaches the auxiliary pulley 480, at which point the cord 112 is partially wrapped around the auxiliary pulley 480. As will be described below with reference to FIG. 24, upon wrapping around the auxiliary pulley 480, the tilt cord 112 may then extend radially inwardly and be coupled to a portion of the drive pulley 440. It should be appreciated that the above-described cord routing may generally provide an advantageous lever arm when the tilt cord 112 is being pulled downwardly to tilt the slats 56 towards the closed-down position

Referring particularly to FIG. 20, the various structural walls or ribs extending outwardly along the inner side 406 of the inner end plate 400 may also be arranged or configured to define or form rail cavities for receiving portions of the drive end 132 of the tilt rail 130 (FIG. 6). Specifically, as shown in FIG. 20, a pair of rail cavities (e.g., a front rail cavity 430 and a rear rail cavity 432) are defined adjacent to the front and rear sides of the inner end plate 400 for receiving the front and rear edge walls 142, 144 (FIG. 9) and adjacent inner sidewalls 158 (FIG. 9) of the tilt rail 130, respectively, with the bottom wall 140 (FIG. 9) of the tilt rail 130 being configured to wrap around or extend adjacent to a correspondingly-shaped lower wall or surface 434 extending between the rail cavities 430, 432. Additionally, as shown in FIG. 20, the inner end plate 400 also includes a mounting tab 436 extending outwardly into each rail cavity 430, 433, with each mounting tab 436 being configured to be received with one of the respective mounting slots 162 (FIG. 9) of the tilt rail 130. As such, with the drive end 132 of the tilt rail 130 installed relative to the inner end plate 400 such that the front and rear edge walls 142, 144 and corresponding inner sidewalls 158 of the rail 130 are received within the respective rail cavities 430, 432 (with the mounting tabs 436 extending within the adjacent mounting slots 162) and the bottom curved wall 140 of the rail 130 wraps around the lower curved wall or surface 434 of the inner end plate 400, the tilt rail 130 may be configured to rotate with the inner end plate 400 about the tilt axis 102 of the tilt system 100.

Referring now to FIGS. 24 and 25, opposed perspective view of one embodiment of the drive pulley 440 described above are illustrated in accordance with aspects of the present subject matter. As shown, the drive pulley 440 generally includes a central pulley portion 444 about which the tilt cord 112 is configured to wind and unwind, an inner spring post 446 (FIG. 24) extending outwardly from an inner side 444A of the pulley portion 444 along the pulley axis 442 of the drive pulley 440 and an outer gear post 448 (FIG. 25) extending outwardly from an outer side 444A of the pulley portion 444 along the pulley axis 442 of the drive pulley 440. In general, the pulley portion 444 may be configured similar to a conventional pulley and may include, for example, a recessed pulley surface 450 extending between opposed pulley flanges 452. As such, the tilt cord 112 may be configured to wind around and unwind from the recessed pulley surface 450, with the tilt cord 112 being retained on such surface 450 between the opposed flanges 452. Additionally, as shown in FIG. 24, a cord opening 454 is defined through a portion of the recessed pulley surface 450 to allow the tilt cord 112 to be secured to the drive pulley 440. For instance, in one embodiment, an end of the tilt cord 112 may be inserted through the cord opening 454 and subsequently knotted so that the knotted end cannot be pulled back through the cord opening 454, thereby securing the tilt cord 112 to the drive pulley 440.

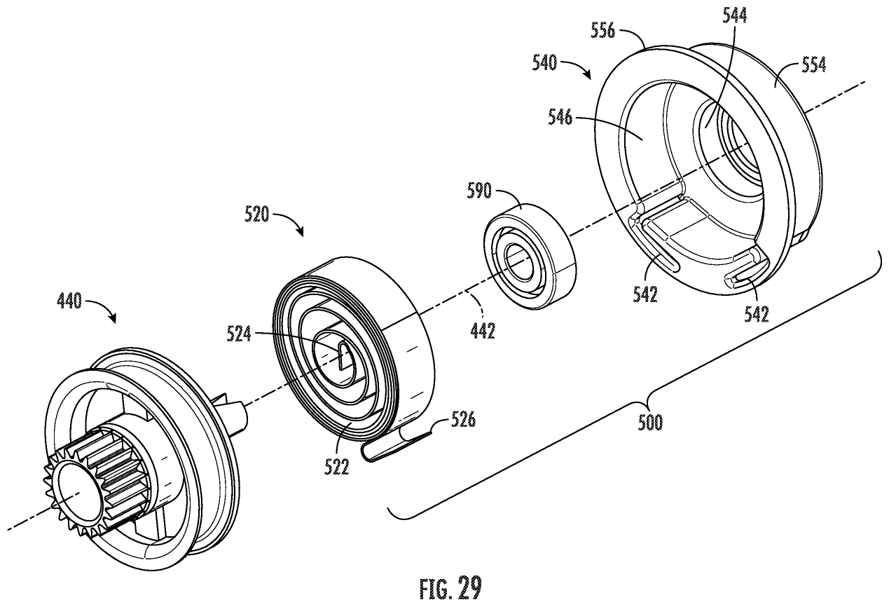

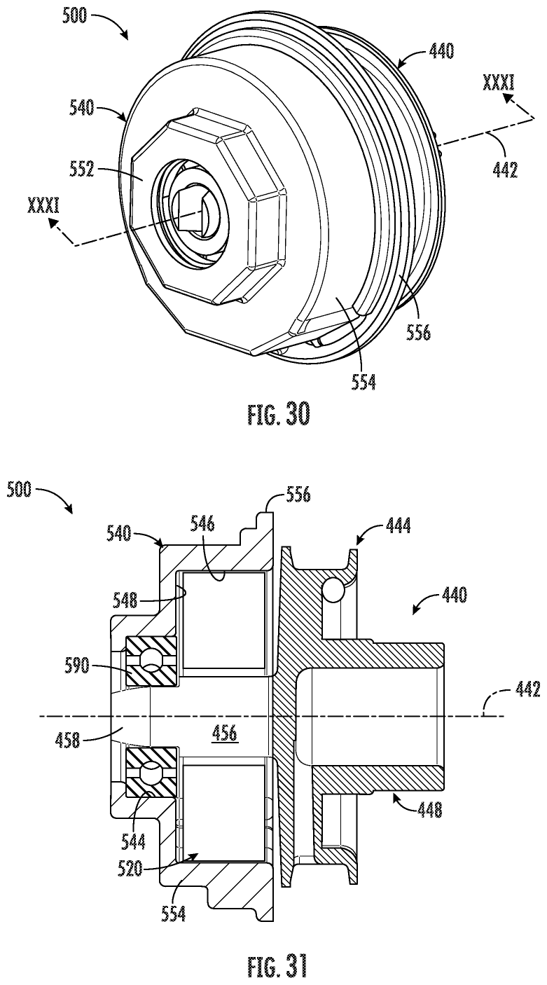

Moreover, as shown in FIG. 24, the inner spring post 446 of the drive pulley 440 is generally configured as a slotted post including both a first or spring post portion 456 and a second or bearing post portion 458 extending axially along the pulley axis 442, with a centralized slot 460 being defined through the inner spring post 446 to divide the post portions 456, 4568 into opposed halves. As will be described in greater detail below with reference to FIGS. 28 and 29, the drive spring 520 of the spring assembly 500 may be configured to be installed onto the spring post portion 456 of the inner spring post 446. In such an embodiment, an inner tang 524 (FIG. 28) of the drive spring 520 may be configured to be received within the centralized slot 560 to rotationally couple such portion of the drive spring 520 to the drive pulley 440. Additionally, as will be described below with reference to FIGS. 28 and 29, the roller bearing 590 of the spring assembly 500 may be configured to be installed onto the bearing post portion 458 of the inner spring post 446. As particularly shown in FIG. 24, a shoulder 462 may be defined at the interface between the spring and bearing post portions 456, 458 that acts as a mechanical stop for the roller bearing 590 when installing such component relative to the inner spring post 446.

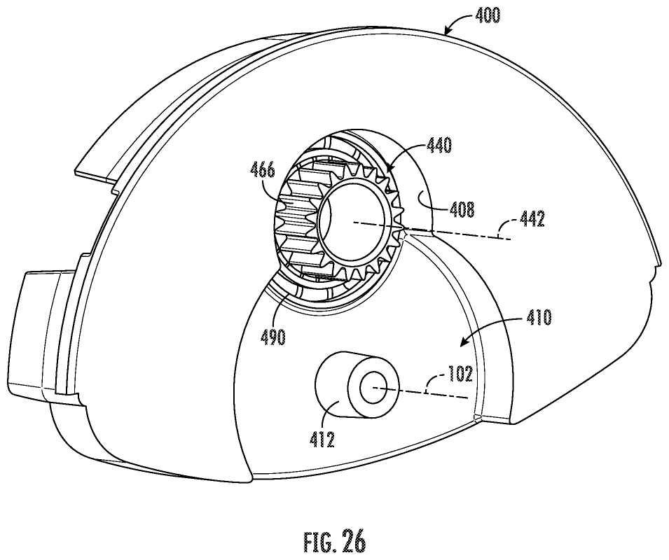

Referring specifically to FIG. 25, the outer gear post 448 of the drive pulley 440 generally includes both a bearing post portion 464 and a gear portion 466 extending axially along the pulley axis 442. As indicated above with reference to FIG. 24, the bearing post portion 464 of the drive pulley 440 may be configured to be pressed into the drive pulley bearing 490 to provide a low friction rotational interface for rotation of the drive pulley 440 relative to the inner end plate 400 about the pulley axis 442. Additionally, the gear portion 466 of the drive pulley 440 may generally be configured to mesh with the corresponding gear portion 316 of the outer end plate 300. Specifically, with the drive pulley 440 installed relative to the inner end plate 400 and associated drive pulley bearing 490 such that the drive pulley bearing 490 is pressed onto the bearing post portion 464 of the drive pulley 440, the gear portion 466 of the drive pulley 440 may be exposed along the outer side 404 of the inner end plate 400, thereby allowing the gear portion 466 to engage the corresponding gear portion 316 of the outer end plate 300. For instance, FIG. 26 illustrates a perspective view of the drive pulley 440 installed relative to the inner end plate 400 and drive pulley bearing 490, with the gear portion 466 of the drive pulley 440 extending through the drive pulley opening 408 defined by the inner end plate 400 to allow the gear portion 466 to mesh with the gear portion 316 of the outer end plate 300 received within the gear cavity 410 of the inner end plate 400. As a result of such gear meshing, rotation of the drive pulley 440 about its pulley axis 442 will result in rotation or pivoting of the inner end plate 400 (and the various components coupled to the end plate 400 for rotation therewith) relative to the outer end plate 300 about the tilt axis 102 as the drive pulley 440 follows the arced travel path 318 described above with reference to FIG. 18.

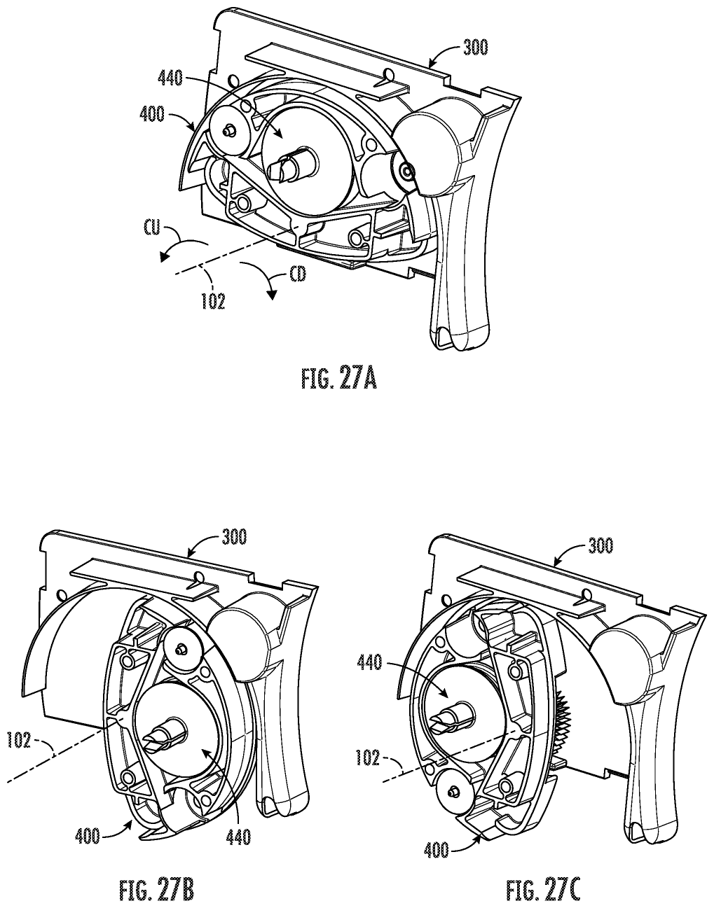

For instance, FIGS. 27A-27C illustrate differing perspective views of the drive pulley 440, inner end plate 400, and outer end plate 300 as assembled together, particularly illustrating various exemplary positions of the drive pulley 440 and inner end plate 400 relative to the outer end plate 300 that can be achieved with rotation of the drive pulley 440 about its pulley axis 442. Specifically, FIG. 27A illustrates the relative positioning of the drive pulley 440, inner end plate 400, and outer end plate 300 when the slats 56 of the associated covering 50 are in the fully opened position (e.g., the position shown in FIG. 1). At such orientation, the tilt rail 130, as installed relative to the inner end plate 40, will have the orientation shown in FIG. 10A. To transition the slats 56 from the fully opened position to the closed-down position, the drive pulley 440 is rotated in the closed-down direction CD (FIG. 27A) by pulling downwardly on the tilt cord 112 via the tilt wand 110, which results in the various tilting components of the headrail assembly 52 (including the tilt rail 130) pivoting relative to the outer end plate 300 about the tilt axis 102 in the closed-down direction CD. For instance, FIG. 27B illustrates the relative positioning of the drive pulley 440, inner end plate 400, and outer end plate 300 when the slats 56 of the associated covering 50 are moved to the closed-down position. At such orientation, the tilt rail 130 will have the orientation shown in FIG. 10B. Similarly, to transition the slats 56 from the fully opened position to the closed-up position, the weight on the tilt cord 112 may be temporarily removed to allow the spring assembly 500 to rotationally drive the drive pulley 440 in the closed-up direction CU (FIG. 27A), which results in the various tilting components of the headrail assembly 52 (including the tilt rail 130) pivoting relative to the outer end plate 300 about the tilt axis 102 in the closed-up direction CU. FIG. 27C illustrates the relative positioning of the drive pulley 440, inner end plate 400, and outer end plate 300 when the slats 56 of the associated covering 50 are moved to the closed-down position. At such orientation, the tilt rail 130 will have the orientation shown in FIG. 10C.

Referring now to FIGS. 28-31, several views of one embodiment of the spring assembly 500 described above are illustrated in accordance with aspects of the present subject matter. Specifically, FIGS. 28 and 29 illustrate exploded, perspective views of both the spring assembly 500 and drive pulley 440. Additionally, FIG. 30 illustrates an assembled view of the various components shown in FIGS. 28 and 29, while FIG. 31 illustrates a cross-sectional view of the assembled components shown in FIG. 30 taken about line XXXI-XXXI.

As shown in the illustrated embodiment, the drive spring 520 of the spring assembly 500 is generally configured as a clock spring including a flat spring ribbon 522 that is spiral-wound between an inner tang 524 and an outer tang 526 of the drive spring 520. As indicated above, the inner tang 524 of the drive spring 520 may be configured to be received within the central slot 460 (FIG. 24) defined through the inner spring post 446 of the drive pulley 440 to couple such portion of the spring 520 to the drive pulley 440. For instance, when installing the drive spring 520 relative to the drive pulley 440, the inner tang 524 of the drive spring 520 may be aligned with the slot 460 of the inner spring post 446 such that the inner tang 524 is received within the slot 460 as the spring 520 is positioned into the spring portion 456 of the inner spring post 446. In contrast, the outer tang 526 of the drive spring 520 may be configured to be coupled to a portion of the spring cup 540. For instance, as will be described below, the spring cup 540 may define a tang slot 542 (FIG. 29) for receiving the outer tang 526 of the drive spring 520, thereby coupling such portion of the spring 520 to the spring cup 540. It should be appreciated that, as an alternative to a clock spring, various other types of springs may be used as the drive spring 520, such as coil springs, B-springs, etc. Additionally, the spring assembly 500 may, in general, have any other suitable arrangement that allows the assembly to function as described herein.

With the arrangement shown in the illustrated embodiment, since the drive pulley 440 is configured to rotate relative to the spring cup 540 about the pulley axis 442 (even though such components tilt together about the tilt axis 102 with rotation of the drive pulley 440), the inner tang 524 may rotate relative to the outer tang 526 with rotation of the drive pulley 440, thereby allowing the drive spring 520 to store energy when the drive pulley 440 is rotated to tilt the slats 56 of the associated covering 50 in one direction and release such energy to rotationally drive the drive pulley 440 when it is desired to tilt the slats 56 in the opposed direction. For instance, as described above, the drive spring 520 may be configured to wind-up (and, thus, store energy) when the tilt cord 112 is pulled downwardly to rotate the drive pulley 440 in the closed-down direction CD to tilt the slats 56 towards the closed-down position. However, when the weight or tension is removed from the tilt cord 112 (e.g., by lifting the tilt wand 110), the drive spring 520 may be configured to release the stored energy and rotationally drive the drive pulley 440 in the closed-up direction CU, thereby allowing the slats 56 to be tilted towards the closed-up position.

The roller bearing 590 of the spring assembly 500 may generally be configured to provide a low friction rotational interface to facilitate rotation of the drive pulley 440 relative to the spring cup 540. In this regard, the bearing 590 may generally be configured to be coupled between the drive pulley 440 and the spring cup 540. For instance, as indicated above, the roller bearing 590 may be configured to be coupled to the bearing post portion 458 of the inner spring post 446 of the drive pulley 440 for rotation therewith, such as by pressing the inner race of the roller bearing 590 onto the bearing post portion 458. Additionally, the outer race of the roller bearing 590 may be configured to be secured to a portion of the spring cup 540, such as by pressing the roller bearing 590 into a bearing cavity 544 (FIGS. 29 and 31) defined by the spring cup 540. As such, the rotational interface provided by the roller bearing 590 may allow the drive pulley 440 to rotate freely relative to the spring cup 540 about the pulley axis 442.

Referring still to FIGS. 28-31, the spring cup 540 of the spring assembly 500 may generally function as a housing or retention element for the drive spring 520, thereby allowing the cup 540 to radially constrain the outward expansion of the spring 520 while it is storing energy (e.g., as the drive pulley 440 is rotating relative to the cup 540 in the closed-down direction CD). In this regard, the spring cup 540 may be configured to define a spring cavity or chamber 546 (FIGS. 29 and 31) within which the drive spring 520 is received upon assembly of such components. For instance, as particularly shown in the cross-sectional view of FIG. 31, the spring cavity or chamber 546 may be dimensioned such that the spring 520 is radially encased or entrapped by the spring cup 540. Additionally, as shown in FIG. 31, the spring 520 may also be axially constrained between the pulley portion 444 of the drive pulley 440 and a retention wall or shoulder 548 extending radially between the spring cavity 546 and the smaller diameter bearing cavity 544 defined by the spring cup 540. Moreover, the spring cup 540 may also function to rotationally fix the outer tang 526 of the drive spring 520, thereby allowing the inner tang 524 to rotate relative thereto with rotation of the drive pulley 440. Specifically, as indicated above, the spring cup 540 may define a tang slot 542 configured to receive the outer tang 526 of the drive spring 520. As particularly shown in FIG. 29, the spring cup 540 may be configured to define a pair of tang slots 542, with the outer tang 526 being inserted into one of such slots 542 depending on the orientation in which the spring 520 is installed within the spring cup 540. For instance, the mirrored geometry of the tang slots 542 may allow the spring cup 540 to be installed within a tilt drive assembly 170 configured to be located at either lateral end of the headrail assembly 52.

Moreover, in several embodiments, the spring cup 540 may also incorporate features that allow the cup 540 to be selectively coupled and decoupled from the end plate cover 600 of the tilt drive assembly 170, which may facilitate “pre-winding” of the drive spring 520. For instance, as particularly shown in FIG. 28, the spring cup includes a locking rib 550 positioned along its outer perimeter. As will be described below with reference to FIGS. 32-35, such rib 550 may be configured to engage a corresponding locking mechanism 620 (FIG. 32) of the end plate cover 600 to rotationally fix the spring cup 540 to the end plate cover 600. However, when it is desired to pre-wind or otherwise adjust the spring load on the drive spring 520, the locking mechanism 620 can be disengaged to allow the spring cup 540 to be rotated relative to the end plate cover 600. In this regard, as particularly show in FIGS. 28 and 30, the spring cup 540 may also be configured to define or include a given profile (e.g., a hex-head profile 552) to allow the cup 540 to be rotated quickly and easily via a corresponding tool.

Referring now to FIGS. 32-35, several views of one embodiment of the end plate cover 600 described above are illustrated in accordance with aspects of the present subject matter. Specifically, FIGS. 32 and 33 illustrate opposed perspective views of the end plate cover 600. Additionally, FIG. 34 illustrates a perspective view of the end plate cover exploded away from the remainder of the components of the tilt drive assembly 170 (as assembled), while FIG. 35 illustrates a bottom perspective view of the end plate cover 600 as assembled relative to the remainder of the tilt drive assembly 170.

As particularly shown in FIGS. 32 and 33, the end plate cover generally includes a planar wall portion 604 at least partially defining an outer side 606 (FIG. 32) of the cover 600 that is configured to face towards the opposed lateral end of the headrail assembly 52 and an inner side 608 (FIG. 33) of the cover 600 that is configured to face towards the inner and outer end plates 300, 400 of the tilt drive assembly 170. A central cup opening 610 is defined through the wall portion 604 and is configured to extend coaxially along the pulley axis 442 of the drive pulley 440 from the outer side 606 of the cover 600 to the inner side 608 of the cover 600. In general, the central cup opening 610 is dimensioned to allow a portion of the spring cup 540 to be received therein when the cover 600 is assembled relative to the remainder of the tilt drive assembly 170. In one embodiment, a diameter of the cup opening 610 may be larger than the diameter of an outer housing portion 554 (see FIG. 34 and FIGS. 28-31) of the spring cup 540 (i.e., the portion of the cup 540 defining the bearing and spring cavities 544, 546), but smaller than the diameter of an outer peripheral flange 556 (See FIG. 34 and FIGS. 28-31) of the spring cup 540 extending radially outwardly from the outer housing portion 554, thereby allowing the flange 556 to engage the inner side 508 of the cover 600 upon assembly of the components. For instance, as particularly shown in FIG. 35, upon assembly of the various tilt drive components, the outer housing portion 554 of the spring cup 540 extends through the cup opening 610 to allow the cup 540 to be accessible along the outer side 606 of the cover 600.

Additionally, as particularly shown in FIGS. 32 and 33, the end plate cover 600 also includes a locking mechanism 620 positioned relative to the central cup opening 610 (e.g., at the bottom of the opening 610) to allow the cover 600 to be selectively coupled and decoupled to/from the spring cup 540. Specifically, in the illustrated embodiment, the locking mechanism 620 includes first and second spring arms 622, 624 and a connector arm 626 extending between the spring arms 622, 624, with each spring arm 622, 624 extending from a proximal end formed integrally with or coupled to the wall portion 604 of the cover 600 to a distal end forming a locking flange 628 of the locking mechanism 620. In such an embodiment, the opposed locking flanges 628 formed at the distal ends of the spring arms 622, 624 may be configured to define a locking channel 630 therebetween within which the locking rib 550 of the spring cup 540 is configured to be received. For instance, as particularly shown in the assembled view of FIG. 35, with the outer housing portion 554 of the spring cup 540 extending through the cup opening 610 defined by the end plate cover 600, the spring arms 622, 624 may be configured to bias the locking flanges 628 up against the outer surface of the spring cup 540 along either side of the locking rib 550, thereby retaining the locking rib 550 within the channel 630 defined between the flanges 628 and preventing rotation of the spring cup 540 relative to the end plate cover 600.

To unlock the spring cup 540 and allow the drive spring 520 to be pre-wound, the spring arms 622, 624 may be configured to be pulled downwardly relative to the spring cup 540 to an unlocked position at which the locking rib 550 of the cup 540 is able to clear the locking flanges 628 of the locking mechanism 620. For instance, as shown in the illustrated embodiment, the connector arm 626 of the locking mechanism 620 may include a press tab 632 that allows a user of the tilt drive assembly 170 to press thereon to move the spring arms 622, 624 downwardly relative to the spring cup 540 to the unlocked position. The spring cup 540 may then be rotated relative to the end plate cover 600 and, more importantly, relative to the drive pulley 440 (e.g., using a suitable tool configured to engage the hex profile 552 of the cup 540) to pre-wind the drive spring 520. For example, as described above, the outer tang 526 of the drive spring 520 may be coupled to the spring cup 540 while the inner tang 524 of the drive spring 520 may be coupled to the drive pulley 440. Thus, by rotating the spring cup 540 relative to the drive pulley 440, the spring 520 may be pre-wound or pre-tensioned as desired, such as by pre-winding the spring 520 a given amount to get into the usable band of the spring's power curve. Once the spring cup 540 has been rotated relative to the drive pulley 440 a desired number of revolutions to pre-wind the spring 520, the connector arm 626 of the locking mechanism 620 may be released, at which point the spring force within the spring arms 622, 624 may bias the locking flanges 628 back into engagement with the spring cup 540 to rotationally capture the locking rib 550 between the flanges 628 and prevent further relative rotation of the spring cup 540.

Referring still to FIGS. 32 and 33, the end plate cover 600 may also include suitable features for mounting the end plate cover 600 to the inner end plate 400. For instance, as shown in FIGS. 32-34, fastener openings 640 may be defined through the wall portion 604 of the cover 600 that are configured to be aligned with the lower pair of mounting openings 424 defined by the inner end plate 400, thereby allowing suitable fasteners 602 (FIGS. 34 and 35) to be used to couple such components together. Additionally, as particularly shown in FIG. 33, the end plate cover 600 may include mounting posts 642 extending outwardly from the wall portion 604 along the inner side of the cover. As described above, such mounting posts 642 may be configured to be received within the upper pair of mounting openings 422 defined by the inner end plate 400 for coupling the end plate cover 600 and inner end plate 400 to each other.

Moreover, the end plate cover 600 may also include component retention features for axially or laterally retaining one or more components of the tilt system 100 between the cover 600 and the inner end plate 400. For instance, as particularly shown in FIG. 33, a pair of pulley retention walls or surfaces 644 are defined along the inner side 608 of the cover 600 that are configured to be aligned with the pulley cavities 416, 418 defined by the inner end plate 400 when the end cover 600 is installed relative to such plate 400, thereby allowing the auxiliary cord pulley 480 to be retained within the specific pulley cavity 416, 418 within which it is installed. Additionally, as shown in FIG. 33, the end plate cover 600 further includes cord guide walls or surfaces 646 extending from the pulley retention walls or surfaces 646 to provide a means of axially or laterally retaining the tilt cord 112 between the cover 600 and the inner end plate 400 as the cord 112 extends radially inwardly along its travel path between the auxiliary pulley 480 and the drive pulley 440.

Referring still to FIGS. 32-35, the end plate cover 600 also includes or defines rail mounting features for coupling the tilt rail 130 (and associated rail cover 131) to the tilt drive assembly 170. Specifically, in several embodiments, the end plate cover 600 may include or define features for receiving or engaging the drive end 132 of the tilt rail 130. For instance, as shown in the illustrated embodiment, similar to the inner end plate 400, the end plate cover 600 defines a pair of rail cavities (e.g., a front rail cavity 650 and a rear rail cavity 652) adjacent to the front and rear sides of the cover 600 for receiving the front and rear edge walls 142, 144 (FIG. 9) and adjacent sidewalls 158 (FIG. 9) of the tilt rail 130, respectively, with the bottom wall 140 (FIG. 9) of the tilt rail 130 being configured to wrap around or extend adjacent to a correspondingly-shaped lower wall or surface 654 of the cover 600 extending between the rail cavities 650, 652. Additionally, the end plate cover 600 includes a mounting tab 656 extending outwardly into each rail cavity 650, 652, with each mounting tab 656 being configured to be received with one of the respective mounting slots 162 (FIG. 9) of the tilt rail 130. As particularly shown in FIG. 35, with the end plate cover 600 installed relative to the inner end plate 400, the rail cavities 650, 652 and mounting tabs 656 of the end plate cover 600 may generally align with the corresponding rail cavities 430, 432 and mounting tabs 436 of the inner end plate 400, thereby allowing the drive end 132 of the tilt rail 130 to be installed relative to the plate/cover such that the front and rear edge walls 142, 144 and corresponding sidewalls 158 of the rail 130 are received within the respective aligned rail cavities 430, 432, 650, 652 (with the aligned mounting tabs 435, 656 extending within the adjacent mounting slots 162 of the rail 130) and the bottom wall 140 of the rail 130 wraps around the corresponding lower walls or surfaces 434, 654 of the aligned cover/plate. Moreover, as shown in FIG. 32, the end plate cover 600 may also include additional mounting flanges 660 extending outwardly from the outer side 606 of the cover 600 for engaging a portion of the rail cover 131. For instance, in one embodiment, the cover 600 may include a pair of inner mounting flanges 660 configured to be engaged against and contact an inner surface of the upper curved wall 133 (FIG. 9) of the rail cover 131 when the rail/cover are installed relative to the end plate cover 600. Additionally, as shown in FIG. 32, the cover 600 may include an outer peripheral flange 662 that generally matches the curvature of the upper curved wall 133 of the rail cover 131 to allow such wall 133 to be retained between the outer peripheral flange 662 and the inner mounting flanges 660 when the rail/cover are installed relative to the end plate cover 600.

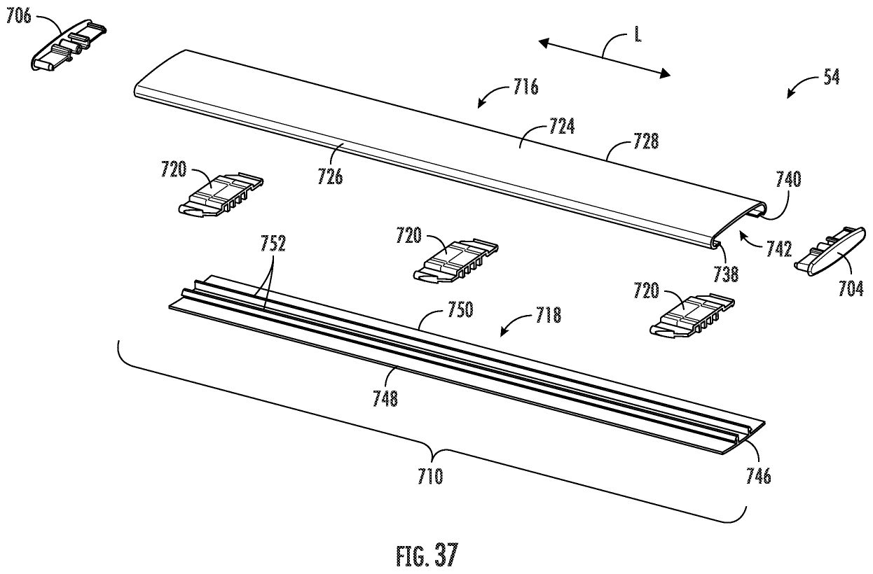

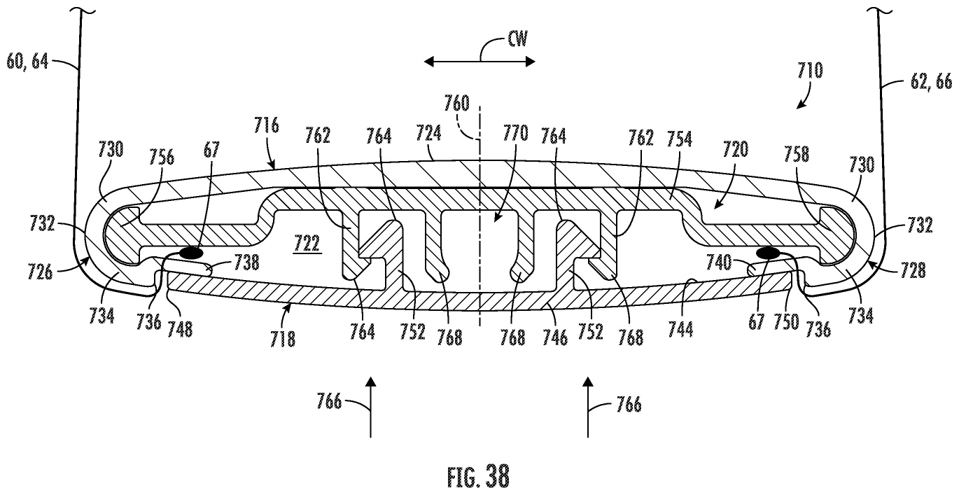

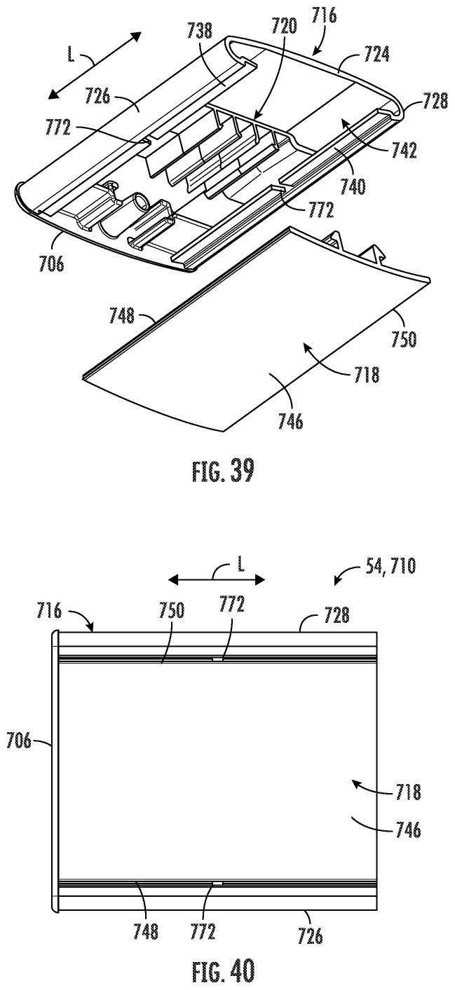

Referring now to FIGS. 36-40, various views of one embodiment of a bottom rail assembly (e.g., bottom rail assembly 54) suitable for use within one or more embodiments of the disclosed covering are illustrated in accordance with aspects of the present subject matter. Specifically, FIGS. 36 and 37 illustrate respective assembled and exploded perspective views of the bottom rail assembly 54, while FIG. 38 illustrates a cross-sectional view of the bottom rail assembly shown in FIG. 36 taken about line XXXVIII-XXXVIII with an endcap of the assembly removed for purposes of illustration. FIG. 39 illustrates a bottom perspective, partially exploded view of a portion of the bottom rail assembly shown in FIG. 37 (e.g., the portion extending to the left of the section line XXXVIII-XXXVIII of FIG. 37) while FIG. 40 illustrates an assembled, bottom view of the portion of the bottom rail assembly shown in FIG. 39.

In general, the bottom rail assembly 54 is configured to extend in a lateral direction (indicated by arrow L in FIGS. 36 and 37) between a first assembly end 700 (FIG. 36) and a second assembly end 702 (FIG. 36). As shown in FIGS. 36 and 37, the bottom rail assembly 54 includes a first endcap 704 positioned at the first assembly end 700 and a second endcap 706 positioned at the second assembly end 702. Additionally, the bottom rail assembly 54 includes a bottom rail 710 extending in the lateral direction L between the first and second endcaps 704, 706. For instance, as particularly shown in FIG. #, the bottom rail 710 includes a first lateral end 712 configured to be coupled to the first endcap 704 and a second lateral end 714 configured to be coupled to the second endcap 706.

In several embodiments, the bottom rail 710 may be configured as a two-piece assembly. For example, as particularly shown in FIG. 37, the bottom rail 710 includes an upper rail portion 716 and a lower cover portion 718 configured to be coupled to the rail portion 716, with both the rail portion 716 and the cover portion 718 being configured to extend in the lateral direction L between the first and lateral ends 712, 174 of the bottom rail 710. As will be described below, in one embodiment, the rail and cover portions 716, 178 may be configured to be coupled to one another via one or more internal rail connectors or connector inserts 720 of the bottom rail assembly 54. For instance, as shown in FIG. 37, the bottom rail assembly 54 may include a plurality of connector inserts 720 for coupling the cover portion 718 to the rail portion 718, with each insert 720 configured to be received within an internal chamber or cavity 722 (FIG. 38) defined by the bottom rail 710 when the rail and cover portions 716, 718 (and the associated endcaps 704, 706) are assembled together. Such connector inserts 720 may be particularly advantageous for use within the disclosed bottom rail assembly 54 when the rail and cover portions 716, 718 of the bottom rail 710 are formed from material extrusions (e.g., metal-based extrusions, such as aluminum extrusions) that require relatively significant tolerance allowances, thereby making it difficult to form an interface therebetween without excessive clearance. In such instance, the connector inserts 720 may be used to provide an efficient connection means between the rail and cover portions 716, 718 of the bottom rail 710. For instance, the connector inserts 720 may be formed from a non-metal material (e.g., plastic) that allows the inserts 720 to be manufactured with relatively tight tolerances to provide a secure and tight connection between the rail and cover portions 716, 718. In an alternative embodiment, the rail and cover portions 716, 718 may be configured to be coupled together without the use of connector inserts, such as by snapping the cover portion 718 to the rail portion 718.

As particularly shown in the cross-sectional view of FIG. 38, the rail portion 716 of the bottom rail 710 generally includes an upper wall 724 (e.g., a slightly curved or arced upper wall) extending in a front-to-rear or crosswise direction (indicated by arrow CW in FIG. 38) between a front edge wall 726 and a rear edge wall 728. In several embodiments, each edge wall 726, 728 may be configured as a radiused or curved wall having a first wall portion 730 extending between the upper wall 724 and an apex point 732 for the radiused edge wall 726, 728 and a second wall portion 734 extending from the apex point 732 to a distal end 736 of the edge wall 726, 728. Additionally, as shown in FIG. 38, the rail portion 716 includes recessed engagement flanges (e.g., front and rear engagement flanges 738, 740) extending inwardly from the distal ends 736 of the radiused walls 726, 728, with the engagement flanges 738, 740 being spaced apart from one another in the crosswise direction CW to form an open, downward-facing bottom end 742 (FIG. 39) of the rail portion 716. For instance, as shown in the partial view of FIG. 39, the flanges 738, 740 may be configured to extend in the lateral direction L in a spaced apart relationship along the front and rear sides of the rail portion 716 such that the open end 742 of the rail portion 716 generally extends along the entire lateral length of the rail portion 716 defined between the opposed lateral ends 712, 714 of the bottom rail 710. In such an embodiment, the cover portion 718 may be configured to be installed relative to the rail portion 716 to cover the open, bottom end 742 thereof. For example, as shown in FIG. 38, the cover portion 718 may be configured to be installed relative to the rail portion 716 such that the cover portion 718 extends in the cross-wise direction CW between the distal ends 736 of the front and rear edge walls 726, 728, with an inner surface 744 of the cover portion 718 contacting or engaging against the opposed engagement flanges 738, 740 of the rail portion 716.

Moreover, as shown in FIGS. 37 and 38, the cover portion 718 of the bottom rail 710 generally includes a lower cover wall 746 (e.g., a slightly curved or arced wall) extending in a front-to-rear or crosswise direction (indicated by arrow CW in FIG. 38) between a front edge 748 and a rear edge 750. As particularly shown in FIG. 38, in one embodiment, when the cover portion 718 is installed relative to the rail portion 716, the front edge 748 of the cover portion 716 may generally be configured to be positioned adjacent to the distal end 736 of the front edge wall 726 of the rail portion 716 while the rear edge 750 of the cover portion 716 may generally be configured to be positioned adjacent to the distal end 736 of the rear edge wall 728 of the rail portion 716. Moreover, as shown in FIG. 38, the engagement flanges 738, 740 of the rail portion 716 may generally be configured to be recessed relative to the distal ends 736 of the front and rear edge walls 726, 728 such that, when the inner surface 744 of the cover portion 718 is engaged against the engagement flanges 738, 740, the bottom rail 710 may generally define a substantially continuous profile. For instance, the curved profile of the wall 746 of the cover portion 718 may generally match the curved profile of the edge walls 726, 728 extending towards the distal ends 736 thereof such that a substantially continuous profile is defined at the interface between the cover portion 718 and the rail portion 716.

Additionally, in several embodiments, the cover portion 718 of the bottom rail 710 may also be configured to include mounting or coupling features for coupling the cover portion 718 to the rail portion 716 via the connector inserts 720. For instance, as shown in FIGS. 37 and 38, the cover portion 718 includes a pair of connection members 752 (e.g., hook-shaped members) extending outwardly from the inner surface 744 of the cover portion 718, with the connection members 752 generally extending along the lateral length of the cover portion 718. As will be described below, the connection members 752 of the cover portion 718 may be configured to engage with or otherwise be coupled to corresponding connection members of the connector inserts 720 to provide a secure connection between the cover portion 718 and each insert 720 (and, thus, a secure connection between the cover portion 718 and the rail portion 716).

Referring still to FIGS. 36-40, each internal connector or connector insert 720 of the bottom rail assembly 54 may generally be configured to be received within the rail portion 716 of the bottom rail 710. For example, as particularly shown in FIG. 38, each connector insert 720 includes a base connector wall 754 extending in the crosswise direction CW between opposed front and rear end portions 756, 758 of the insert 720. In such an embodiment, each insert 720 may be configured to be received within the rail portion 716 such that the base connector wall 754 extends across the interior of the rail portion 716 between the front and rear edge walls 726, 728 of the rail portion 716, with the front end portion 756 of the insert 720 configured to be positioned adjacent to and/or contacting the inner surface of the front edge wall 726 and the rear edge portion 758 of the insert 720 configured to be positioned adjacent to and/or contacting the inner surface of the rear edge wall 728. As shown in FIG. 38, the end portions 756, 758 of each insert 720 may, in one embodiment, have radiused or curved profiles that generally match the inner radiused or curved profiles of the edge walls 726, 728 of the rail portion 716. Additionally, in one embodiment, the end portions 756, 758 of each insert 720 may be slightly tapered in the crosswise direction CW to define cam surfaces or profiles for allowing the insert 720 to be fixed in place within the rail portion 716. For instance, upon installing a given connector insert 720 within the rail portion 716, the insert 720 may be slightly rotated about its central axis 760 (FIG. 38) to lock the end portions 756, 756 of the insert 720 against the opposed inner surfaces of the edge walls 726, 728 of the rail portion 716.

Moreover, each connector insert 720 may include mounting or coupling features that are configured to mate with or otherwise complementary to the corresponding mounting or coupling features of the rail portion 716 of the bottom rail 710. For instance, as shown in FIG. 38, each insert 720 may include a pair of connection members 762 (e.g., hook-shaped members) extending outwardly from the base connector wall 754 of the insert 720. As shown in the illustrated embodiment, the connection members 762 of each insert 720 may be configured to engage the connection members 752 of the cover portion 718 to lock or secure the cover portion 718 in place relative to the rail portion 716. In one embodiment, each connection member 752, 762 includes a tapered or hooked end 764 that allows for a snap-fit connection between the cover portion 716 and the corresponding connector insert 720. For instance, as shown in FIG. 38, the cover portion 718 may be installed relative to the rail portion 716 and associated connector insert(s) 720 by pushing the cover portion 718 towards the bottom end of the rail portion 718 (e.g., in the installation direction indicated by arrows 766 shown in FIG. 38) until the hooked ends 764 of the connection members 752 of the cover portion 718 have been pushed in the installation direction 766 past the corresponding hooked ends 764 of the connection members 762 of each connector insert 720, thereby allowing the adjacent pairs of hooked ends 764 to snap into interlocking engagement with each other to secure the cover portion 718 to the rail portion 718. Alternatively, as opposed to snapping the cover portion 718 onto the connector inserts 720, the cover portion 718 may be slid laterally into place relative to the rail portion 716 and associated inserts 720.

Further, in several embodiments, each connector insert 720 may, in one embodiment, include one or more retention features for retaining one or more weighted components (rods) to increase the overall weight of the bottom rail assembly 54, if necessary. For instance, as shown in FIG. 38, each insert 720 includes a pair of retention arms 768 extending outwardly from the base connector wall 754 at a location between the connection members 762 of the insert 720. In such an embodiment, the retention arms 768 may be configured to define a retention channel 770 therebetween for optionally receiving a weighted components. For example, an elongated rod may be snapped into the retention channel 770 to increase the weight of the bottom rail assembly 54.

In several embodiments, the front and rear runs/cords 60, 62, 64, 66 of the associated covering 50 may be configured to extend from the headrail assembly 52 and wrap around the respective front and rear edge walls 726, 728 of the rail portion 716 of the bottom rail 710 to allow such cords/runs 60, 62, 64, 66 to be coupled to the bottom rail 710 along its bottom side. For instance, FIG. 36 illustrates the front and rear lift cords 64, 66 (indicated by dashed lines for purposes of illustration) and the front and rear runs 60, 62 of each ladder tape assembly 58 installed relative to the bottom rail assembly 54. Additionally, FIG. 38 illustrates a simplified view of the various cords/runs 60, 62, 64, 66 extending relative to the bottom rail 710, with each front cord/run 60, 64 pair and each rear cord/run 62, 66 being shown as a single line to illustrate such front and rear cords/runs wrapping around the respective front and rear sides of the bottom rail 710. As particularly shown in FIG. 38, in one embodiment, the cords/runs 60, 62, 64, 66 may be configured to wrap around the adjacent edge walls 726, 728 of the rail portion 716 and extend into the internal cavity 722 defined by bottom rail 710 at the interface defined between the rail and cover portions 716, 718.

To accommodate such cord/run routing, the bottom rail 710 may incorporate suitable cord-related features for receiving the various cords/runs 60, 62, 64, 66. For instance, as particularly shown in FIG. 39, the engagement flanges 738, 740 of the rail portion 716 may define cord/run slots 772 for receiving the ends of the front and rear cords/runs 60, 62, 64, 66 (e.g., knotted or grommeted ends 67). In such an embodiment, when the cover portion 718 of the bottom rail 710 is installed relative to the bottom end of the rail portion 716, the cover portion 718 may cover or extend across a substantial portion of the cord/run slots 772 to retain the cords/runs 60, 62, 64, 66 relative thereto. For instance, as shown in the bottom, partial view of FIG. 40, with the cover portion 718 installed relative to the rail portion 718, only a small section of each cord/run slot 772 may remain uncovered by the cover portion 716 along the bottom end of the rail portion 718 (e.g., a sufficient slot section to simply allow the cords/runs to pass therethrough). As a result, the knotted or grommeted ends 67 of the cords/runs 60, 62, 64, 66 may be trapped within the interior of the bottom rail 710 and retained relative thereto.

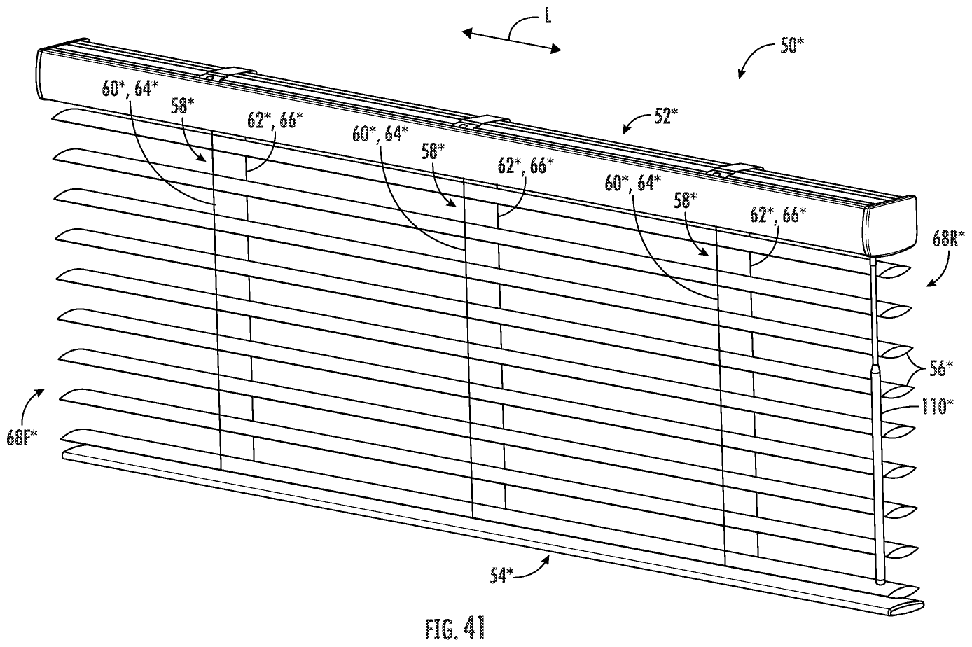

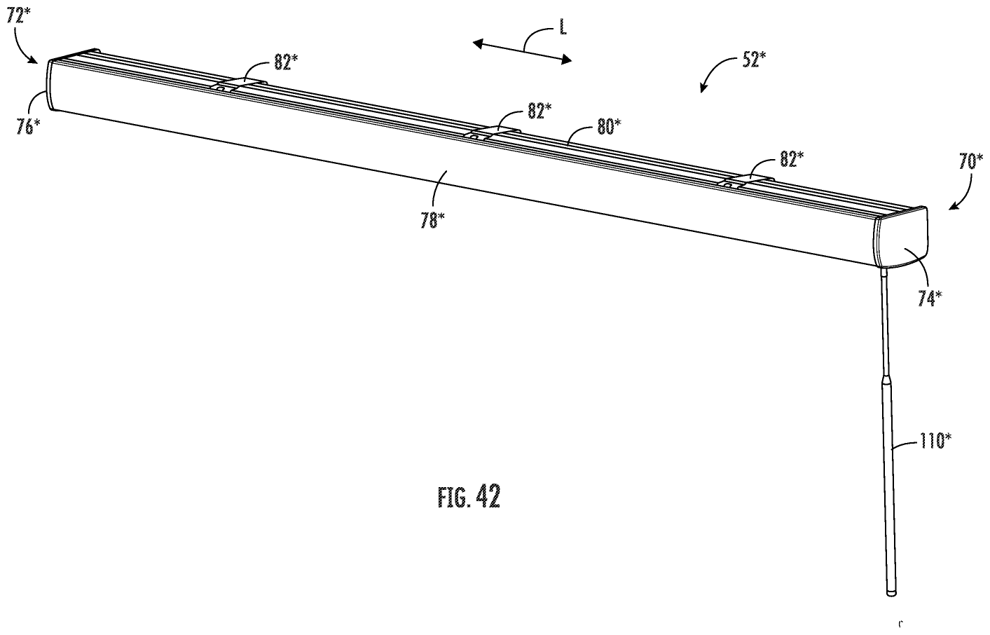

Referring now to FIG. 41, a perspective view of another embodiment of a covering 50* for an architectural structure (not shown) is illustrated in accordance with aspects of the present subject matter. The covering 50* shown in FIG. 41 is generally configured similar to the covering 50 described above with reference to FIG. 1. As such, components, features, and/or structures of the covering 50* that are the same or similar to corresponding components, features, and/or structures of the covering 50 described above will be designated by the same reference character with an asterisk (*) added. Additionally, when a given component, feature, and/or structure of the covering 50* is configured to generally perform the same function as the corresponding component, feature, and/or structure of the covering 50 described above, a less detailed description of such component/feature/structure will be provided below for the sake of brevity.

As shown in FIG. 41, the covering 50* is configured as a slatted blind (e.g., a “privacy” Venetian-blind-type extendable/retractable covering) and generally includes a headrail assembly 52*, a bottom rail assembly 54*, and a plurality of horizontally disposed, parallel slats 56* configured to be supported between the headrail and bottom rail assemblies 52, 54* via two or more ladder tape assemblies 58* (e.g., three ladder tape assemblies 58*). The slats 56* are rotatable or tiltable about their longitudinal axes by manipulating the ladder tape assemblies 58* to allow the slats 56* to be tilted between a horizontal or open position (e.g., as shown in FIG. 41) for permitting light to pass between the slats 56* and a closed position (not shown—either a closed-down position or a closed-up position depending on whether the front edges of the slats 56* are tilted downwardly or upwardly, respectively), wherein the slats 56* are substantially vertically oriented in an overlapping manner to occlude or block the passage of light through the covering 50*. Similar to the embodiment of the covering 50 described above, the slats 56* may, in one embodiment, be configured as cellular slats. Alternatively, the slats 56* may be configured as conventional, non-cellular slats.

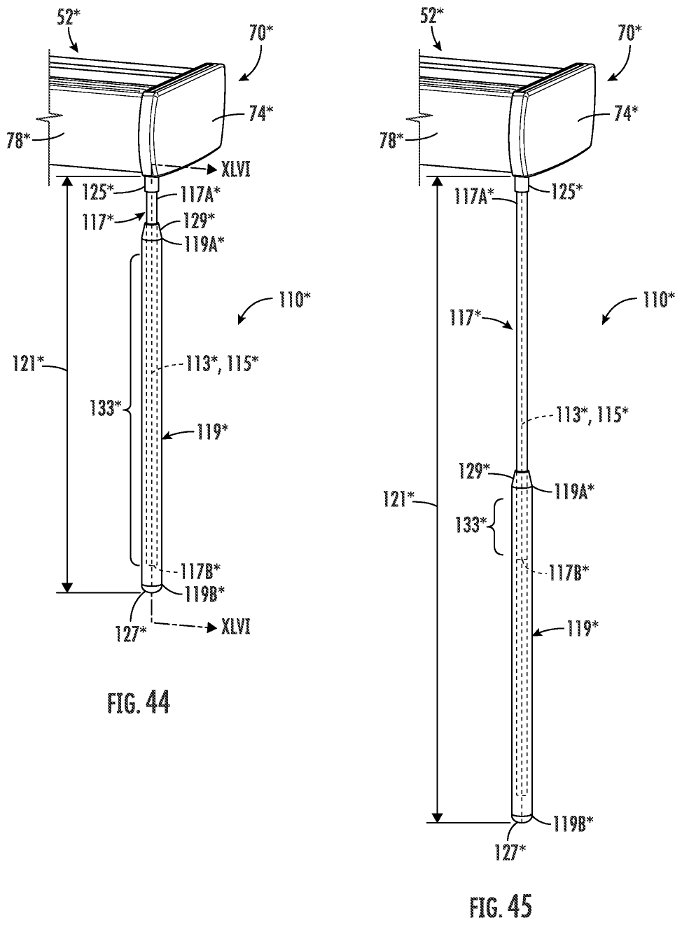

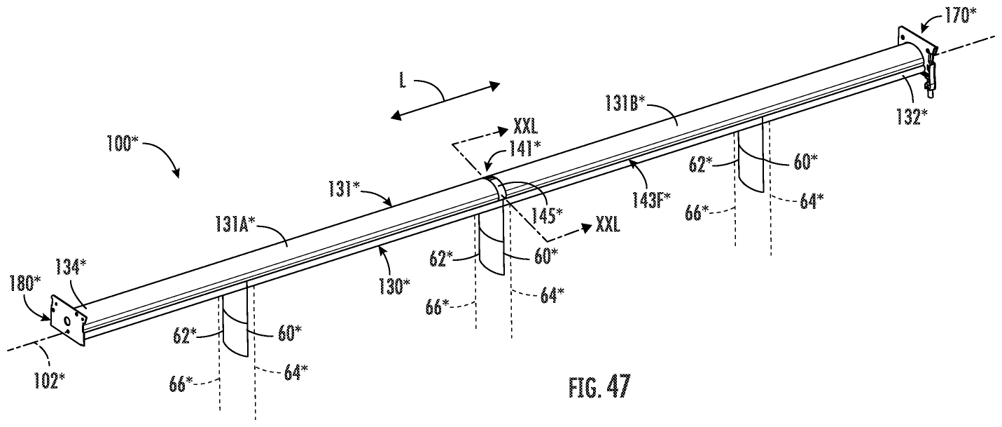

Additionally, similar to the embodiment described above, the ladder tape assemblies 58* may be manipulated to allow for the slats 56* to be tilted between their open and closed positions using, for example, a suitable tilt wand 110* or any other suitable control device forming part of a tilt system 100* (FIG. 43) provided in operative association with the covering 50*. For example, as will be described below with reference to FIG. 43, the covering 50* may include one or more components of the tilt system 100* provided in operative association with the headrail assembly 52*, such as a tilt drive assembly 170* and associated tilt rail 130* of the system 100*. In such an embodiment, the tilt wand 110* may be manipulated by the user (e.g., by the pulling a portion of the wand 110* down or by raising such portion of the wand 110*) to actuate the associated tilt cords (e.g., first and second tilt cords 113*, 115* (see FIGS. 44-46) extending within the wand 110*, which may, in turn, allow the tilt drive assembly 170* to rotationally drive the tilt rail 130*. Such rotation of the tilt rail 130* may cause front and rear ladder runs 60*, 62* (FIGS. 47-49) of each ladder tape assembly 58* depending from the tilt rail 130* to be raised or lowered relative to each other to adjust the tilt angle of the slats 56*.

Moreover, the covering 50* is also configured to include two or more pairs of lift cords 64*, 66* forming part of a lift system 200* (FIG. 43) for moving the covering 50* between a lowered or extended position (e.g., as shown in FIG. 41) and a raised or retracted position (not shown). In the illustrated embodiment, the covering 50* includes three pairs of lift cords 64*, 66* extending between the headrail assembly 52* and the bottom rail assembly 54*. Each lift cord pair in FIG. 41 includes a front lift cord 64* extending along a front side 68F* of the covering 50*, and a rear lift cord 66* extending along a rear side 68R* of the covering 50*. Specifically, each front lift cord 64* is configured to extend between the headrail assembly 52* and the bottom rail assembly 54* along a front edge of each slat 56*, while each rear lift cord 66* is configured to extend between the headrail assembly 52* and the bottom rail assembly 54* along an opposed rear edge of each slat 56*. As will be described below, each pair of lift cords 64*, 66* may be configured to extend to a corresponding lift system component provided in operative association with the headrail assembly 52*.

It should be appreciated that the configuration of the covering 50* described above and shown in FIG. 41 is provided only to place the present subject matter in an exemplary field of use. Thus, it should be apparent that the present subject matter may be readily adaptable to any suitable manner of covering configuration. For example, the covering 50* shown in FIG. 41 is configured as a wider covering than the covering 50 shown in FIG. 1 and, thus, includes three ladder tape assemblies 58* and three pairs of lift cords 64*, 66*. However, in an alternative embodiment, the covering 50* may be configured as a narrower covering and, thus, may include a similar configuration to that shown in FIG. 1 (e.g., by only including two ladder tape assemblies 58* and two pairs of lift cords 64*, 66*). As another example, the covering 50* may be configured as an even wider covering than that shown in FIG. 41, in which case the covering 50* may include four (or more) ladder tape assemblies 58* and four (or more) pairs of lift cords 64*, 66*.

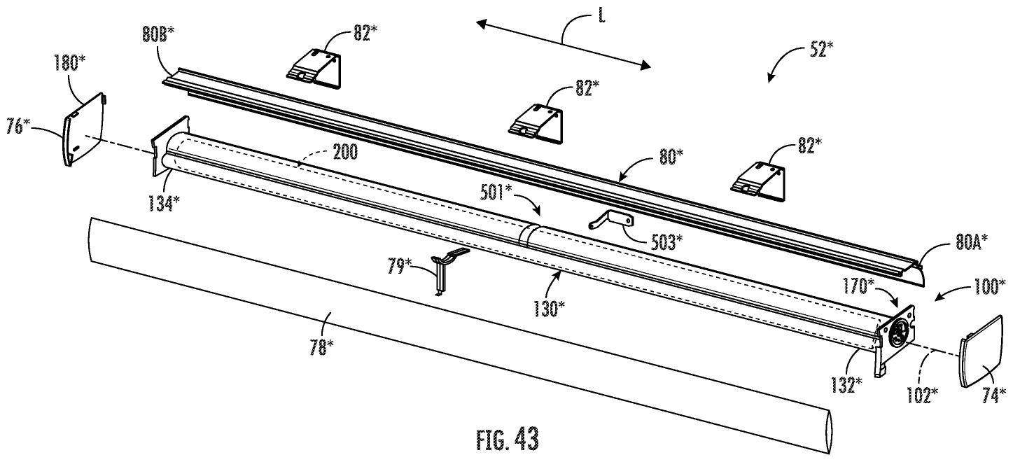

Referring now to FIGS. 42 and 43, perspective views of one embodiment of a headrail assembly (e.g., headrail assembly 52*) are illustrated in accordance with aspects of the present subject matter. Specifically, FIG. 42 illustrates a perspective, assembled view of the headrail assembly 52* and FIG. 43 illustrates a perspective, partially exploded view of the headrail assembly 52* shown in FIG. 42 (with the tilt wand 110* removed for purposes of illustration). The headrail assembly 52* shown in FIGS. 42 and 43 is generally configured similar to the headrail assembly 52 described above with reference to FIGS. 2 and 3. As such, components, features, and/or structures of the assembly 52* that are the same or similar to corresponding components, features, and/or structures of the assembly 52 described above will be designated by the same reference character with an asterisk (*) added. Additionally, when a given component, feature, and/or structure of the assembly 52* is configured to generally perform the same function as the corresponding component, feature, and/or structure of the assembly 52 described above, a less detailed description of such component/feature/structure will be provided below for the sake of brevity.

In general, the headrail assembly 52* is configured to extend in a lateral direction (indicated by arrow L in FIGS. 42 and 43) between a first assembly end 70* (FIG. 42) and a second assembly end 72* (FIG. 42). As shown in FIGS. 42 and 43, the headrail assembly 52* includes a first endcap 74* positioned at the first assembly end 70*, a second endcap 76* positioned at the second assembly end 72*, and a valance 78* extending in the lateral direction L between the first and second endcaps 74*, 76*. In general, the valance 78* may be configured similar to the valance 78 described above. For instance, in one embodiment, the valance 78* may be designed or configured to have the same shape, profile, dimensions, etc. as the slats 56* used in the associated covering 50*. Additionally, as shown in FIG. 43, the headrail assembly 52* may also include one or more valance clips 79* configured to support the valance at a location between its opposed ends relative to the remainder of the assembly 52*.

As indicated above, in several embodiments, the headrail assembly 52* may be configured to include or be associated with various components of both the tilt system 100* and the lift system 200*. For instance, as particularly shown in FIG. 43, various tilt-related components of the tilt system 100* may be positioned or supported between the first and second endcaps 74*, 76*. Specifically, as shown in FIG. 43, the tilt system 100* includes a tilt rail 130* extending laterally between a first or drive end 132* of the tilt rail 130* positioned adjacent to the first assembly end 70* (FIG. 42) of the headrail assembly 52* and a second or idle end 134* of the tilt rail 130* positioned adjacent to the second assembly end 72* (FIG. 42) of the headrail assembly 52*. Additionally, the tilt system 100* includes a tilt drive assembly 170* coupled to the drive end 132* of the tilt rail 130* and an idle end plate 180* coupled to the idle end 134* of the tilt rail 130*. For instance, as shown in FIG. 43, the tilt drive assembly 170* is configured to be coupled between the first endcap 74* and the drive end 132* of the tilt rail 130* adjacent to the first assembly end 70* (FIG. 42) of the headrail assembly 52* and the idle end plate 180* is configured to be coupled between the second endcap 76* and the idle end 134* of the tilt rail 130* adjacent to the second assembly end 72* (FIG. 42) of the headrail assembly 52*. Similar to the embodiment described above, the tilt drive assembly 170* may be configured to rotationally drive the tilt rail 130* such that the rail 130* rotates about a tilt axis 102* (FIG. 3) across an angular tilt range (e.g., approximately 180 degrees) to allow the slats 56* of the associated covering 50* to be tilted from a first closed position (e.g., a closed-down position) through a fully opened position (e.g., as shown in FIG. 41) to a second closed position (e.g., a closed-up position).

Additionally, in accordance with aspects of the present subject matter, one or more components of the lift system 200* (indicated by dashed lines in FIG. 43) may be supported by the tilt rail 130*. As a result, the various lift system components supported by the tilt rail 130* may be configured to rotate with the tilt rail 130* about the tilt axis 102* as the slats 56* are being tilted. As will be described below with reference to FIGS. 47-49, such rotation of the lift system components may allow the front and rear lift cords 64*, 66* (FIG. 41) to be shifted slightly in opposite directions together with the front and rear runs 60*, 62* (FIG. 41) of the ladder tape assemblies 58* as the slats 56* are being tilted, thereby assisting the slats 56* in being moved to one of the closed positions while maintaining the bottom rail assembly 54* at the desired orientation.

Similar to the embodiment described above, the headrail assembly 52* may also include one or more components for mounting the assembly 52* relative to an adjacent architectural structure. For instance, as particularly shown in FIG. 43, the headrail assembly 52* includes a mounting rail 80* and two or more mounting brackets (e.g., three mounting 82*), with the mounting brackets 82* configured to be coupled between the mounting rail 80* and the adjacent architectural structure (e.g., using suitable fasteners). The mounting rail 80*, in turn, may be configured to be coupled to one or more components of the headrail assembly 52* to support such assembly 52* relative to the brackets 82* and the adjacent architectural structure. For instance, in one embodiment, opposed first and second lateral ends 80A*, 80B* (FIG. 43) of the mounting rail 80* may be configured to be coupled to corresponding fixed or stationary components of the tilt system 100*, such as by coupling the first lateral end 80A* of the mounting rail 80* to a fixed end plate assembly of the tilt drive assembly 170* positioned adjacent to the first assembly end 70* of the headrail assembly 52* and by coupling the second lateral end 80B* of the mounting rail 80* to the opposed idle end plate 180* positioned adjacent to the second assembly end 72* of the headrail assembly 52*.

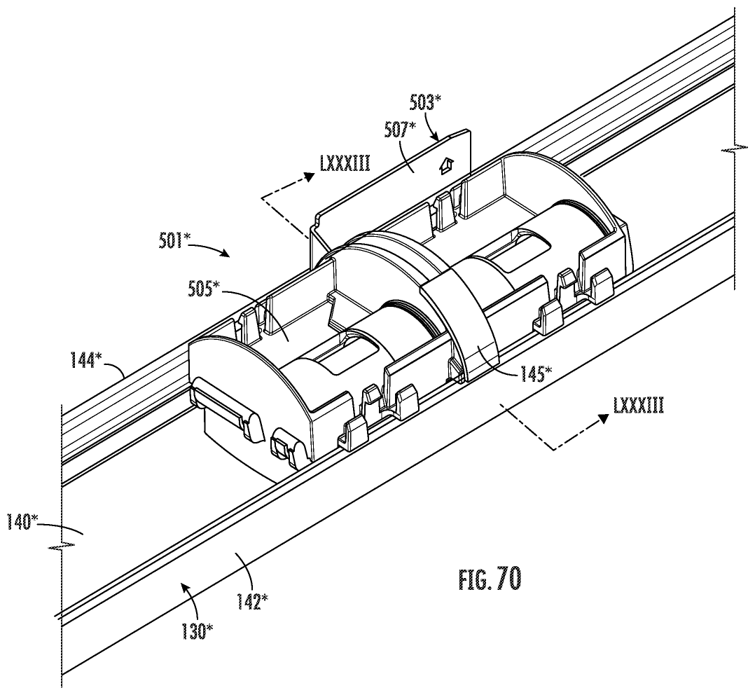

Additionally, in accordance with aspects of the present subject matter, the headrail assembly 52* may also include one or more components for pivotably supporting the tilt rail 130* (and the lift system components associated therewith) for rotation or pivoting about the tilt axis 102* relative to the mounting rail 80* (and the adjacent architectural structure). For instance, as will be described in more detail below with reference to FIGS. 70-83, the headrail assembly 52* may, in several embodiments, include a rail support assembly 501* (FIG. 43) coupled between the mounting rail 80* and the tilt rail 130* at a location between the opposed assembly ends 52A*, 52B* of the headrail assembly 52* to provide vertical support for such rail 130* (and the lift system components associated therewith). Specifically, as shown in FIG. 43, a rail support member 503* of the rail support assembly 501* is configured to be coupled between the mounting rail 80* and the tilt rail 130* at more centralized location along the rail 130* in the lateral direction L to provide vertical support for the tilt rail 130* and, thus, prevent sagging of the rail 130* between the opposed assembly ends 52A*, 52B* of the headrail assembly 52*.

The rail support assembly 501* may, in certain embodiments, be advantageous for use with wider coverings that have wider headrail assemblies 52* (and, thus, longer tilt rails 130*) spanning between the opposed assembly ends 52A*, 52B* of the headrail assembly 52*. For instance, in the embodiment of the headrail assembly 52* shown in FIG. 43, a single rail support assembly 501* may be used to support the tilt rail 130* between the opposed assembly ends 52A*, 52B* of the headrail assembly 52*. For an ever wider headrail assembly 52*, two or more rail support assemblies 501* may be used to support the tilt rail 130* (and the lift system components associated therewith) relative to the mounting rail 80* (and the adjacent architectural structure). However, it should be appreciated that, in general, one or more rail support members 501* may be provided in association with a headrail assembly having any suitable width, including the narrow headrail assembly 52 (and associated covering 50) described above with reference to FIGS. 1-3.

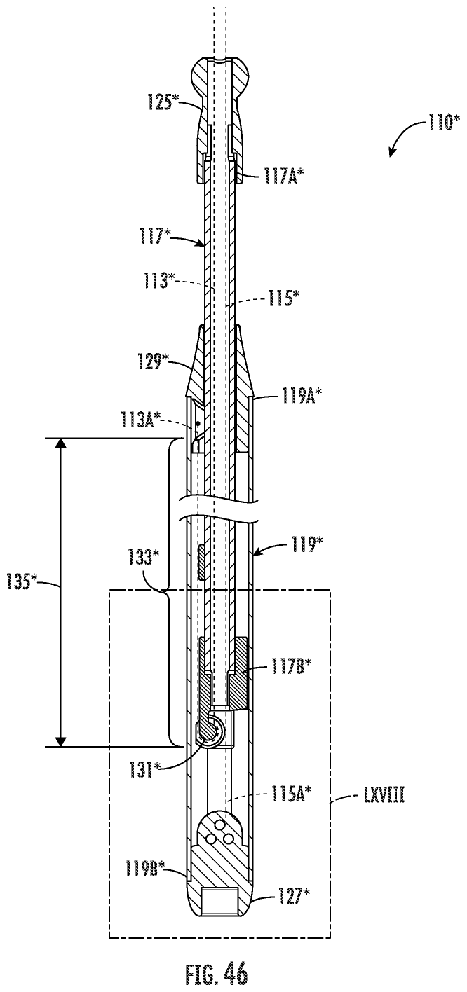

Referring now to FIGS. 44-46, various views of one embodiment of the tilt wand 110* of the tilt system 100* are illustrated in accordance with aspects of the present subject matter. Specifically, FIGS. 44 and 45 illustrate perspective views of a portion of the headrail assembly 52* shown in FIG. 42 (e.g., a portion extending adjacent to the first assembly end 70* of the assembly 52*), particularly illustrating more detailed views of the tilt wand 110*. Additionally, FIG. 46 illustrates a cross-sectional view of the tilt wand 110* shown in FIG. 44 taken about line XLVI-XLVI.

As particularly shown in FIGS. 44-46, in several embodiments, the tilt wand 110* may be configured as a telescoping wand including both an upper or first wand portion 117* and a lower or second wand portion 119*, with the first wand portion 117* being configured to be received within the second wand portion 119* (or vice versa) in a telescoping manner to allow an effective length 121* (FIGS. 44 and 45) of the tilt wand 110* to be increased or decreased with relative movement between the wand portions 117*, 119*. For instance, as shown in the illustrated embodiment, the first wand portion 117* extends between a top end 117A* and a bottom end 117B*, with the bottom end 117B* being received within the second wand portion 119*. The top end 117A* of the first wand portion 117* may be configured to be coupled to a wand pivot member 125*. As will be described below, the wand pivot member 125* may, in turn, be configured to be pivotably coupled to a corresponding portion of the tilt drive assembly 170* (FIG. 3) to allow the tilt wand 110* to be pivoted relative to the tilt drive assembly 170*. Additionally, the second wand portion 119* extends between a top end 119A* and a bottom end 119B*, with the top end 119A* being configured to slide over a portion of the first wand portion 117* in a telescoping arrangement as the second wand portion 119* is moved upward and downwardly relative to the first wand portion 117*.

Additionally, a portion of each tilt cord 113*, 115* (shown schematically as a single dashed line in FIGS. 44 and 45 and shown in more detail as separate dashed lines in the cross-sectional view of FIG. 46) may be configured to extend through the wand portions 117*, 119* so that such portions of the tilt cords 113*, 115* are encapsulated or encased by the tilt wand 110*. For instance, in one embodiment, each tilt cord 113*, 115* may extend through the tilt wand 110* from the wand pivot member 125* positioned at the top end 117A* of the first wand portion 117* to a location within the second wand portion 118*. Specifically, as shown in FIG. 46, the first tilt cord 113* may extend through the tilt wand 110* from the wand pivot member 125* to the bottom end 119B* of the second wand portion 119*, with an end 113A* of the tilt cord 113* being coupled to the second wand portion 119* at or adjacent to its bottom end 119B*. For instance, in the illustrated embodiment, the end 113A* of the tilt cord 113* is configured to be coupled to a bottom cap 127* mounted or secured to the bottom end 119B* of the second wand portion 119*, such as by tying the end 113A* of the tilt cord 113* to the bottom cap 127*. Moreover, as shown in FIG. 46*, the second tilt cord 115* may extend downwardly through the tilt wand 110* from the wand pivot member 125*, wrap around the bottom end 117B* of the first wand portion 117*, and extend upwardly therefrom to the top end 119A* of the second wand portion 119*, with an end 115A* of the tilt cord 115* being coupled to the second wand portion 119* at or adjacent to its top end 119A*. For instance, in the illustrated embodiment, the end 115A* of the second tilt cord 115* is configured to be coupled to a top cap 129* mounted or secured to the top end 119B* of the second wand portion 119*, such as by tying the end 115A* of the tilt cord 115* to the top cap 129*. Additionally, as shown in the illustrated embodiment, a wand bushing 131* is coupled to the bottom end 117B* of the first wand portion 117* to provide a bearing surface for the second tilt cord 115* as it wraps around the bottom end 117B* of the first wand portion 117* and extends upwardly therefrom towards the top end 119A* of the second wand portion 119*. Such routing of the second tilt cord 115* creates an overlapped cord section (e.g., as indicated by bracket 133) within the tilt wand 110* across which the second tilt cord 115* vertically overlaps itself. A vertical height 135* (FIG. 46) of this overlapped cord section 133* may generally vary as the second wand portion 119* is moved relative to the first wand portion 117*.

As will be described below with reference to FIGS. 63-65, an opposed end of each tilt cord 113*, 115* may be configured to be coupled to a tilt drum of the tilt drive assembly 170*. In this regard, by coupling the ends 113A*, 115A* of the tilt cords 113*, 115* to the second wand portion 119* in the manner described above, the cords 113*, 115* may function to rotationally drive the tilt drum as the second wand portion 119* is moved relative to the first wand portion 117*. For example, downward motion of the second wand portion 119* relative to the first wand portion 117* may result in the first tilt cord 113* paying off of or unwinding from the tilt drum while the second tilt cord 115* winds around the tilt drum to rotationally drive the drum in a first rotational direction, which, in turn, results in the slats 56* being tilted towards their closed-down position. In doing so, the vertical height 135* of the overlapped cord section 133* of the second tilt cord 115* may be reduced by an amount proportional to the amount of the second tilt cord 115* that winds around the tilt drum as the second wand portion 119* is moved downward relative to the first wand portion 117*. Similarly, upward motion of the second wand portion 119* relative to the first wand portion 117* may result in the second tilt cord 115* paying off of or unwinding from the tilt drum while the first tilt cord 113* winds around the tilt drum to rotationally drive the drum in an opposite, second rotational direction, which, in turn, results in the slats 56* being tilted towards their closed-up position. In doing so, the vertical height 135* of the overlapped cord section 133* of the second tilt cord 115* may be increased by an amount proportional to the amount of the second tilt cord 115* that is unwound from the tilt drum as the second wand portion 119* is moved downward relative to the first wand portion 117*. Accordingly, by moving second wand portion 119* relative to the first wand portion 117*, a user of the tilt wand 110* may tilt the slats 56* in either direction between their closed-up and closed-down positions.

It should be appreciated that, in several embodiments, the tilt cords 113*, 115* may be configured to be in “tension” in their installed states. Specifically, during installation of the tilt cords 113*, 115* relative to the tilt wand 110* and the tilt drive assembly 170*, a given amount of tension may be applied through the cords 113*, 115* (e.g., a nominal tension, such as one pound of tension) as the ends of the cords 113*, 115* are being tied off or otherwise coupled to the respective components of the tilt wand 110* and/or tilt drive assembly 170*. This “pre-tensioned state” of the tilt cords 113*, 115* may allow the cords 113*, 115* to provide a compressive force against the tilt wand 110*. Specifically, the “pre-tensioned” first tilt cord 113* applies an upward force at the bottom end 119B* of the second wand portion 119* while the “pre-tensioned” second tilt cord 115* applies a downward force at the top end 119A* of the second wand portion 119*.

Moreover, the “pre-tensioned” tilt cords 113*, 115* collectively apply an upwardly directed force against the first wand portion 117* of the tilt wand 110* (and the wand pivot member 125*). As will be described below, this upwardly directed force results in the tilt wand 110* being maintained in position relative to the tilt drive assembly 170* without the need of any mechanical retention structure.

In general, it should be appreciated that the tilt cords 113*, 115* may correspond to any suitable cords formed from any suitable material. However, in several embodiments, it may be desirable to form the tilt cords 113*, 115* from a chemical fiber capable of maintaining the set amount of pre-tension within the cords 113*, 115* during operation of the tilt system 100*, such as ultra high molecular weight polyethylene (UHMWPE) fibers (also referred to as high modulus polyethylene (HMPE) fibers). UHMWPE or HMPE fibers are types of polyolefin fibers formed from very long, highly oriented chains of polyethylene. This microstructure generally provides numerous mechanical advantages, including high strength and high modulus along the longitudinal direction of the chains. As such, the fibers will stretch under tension, but will slowly retract back to their nominal or default state once the tensile load is removed. Accordingly, in the present application, such fibers can be used within the tilt cords 113*, 115* to provide a “no-slack” tilt system 100* without the use of the springs. For example, unlike many conventional cords that will stretch or lengthen over time and create slack within the tilt system, cords formed from UHMWPE or HMPE fibers will return back to their initial or nominal state, thereby maintaining the “pre-tensioned” state of the cord and, thus, preventing cord slack within the tilt system. Such fibers are commercially available, for example, under the trade names DYNEEMA and SPECTRA.

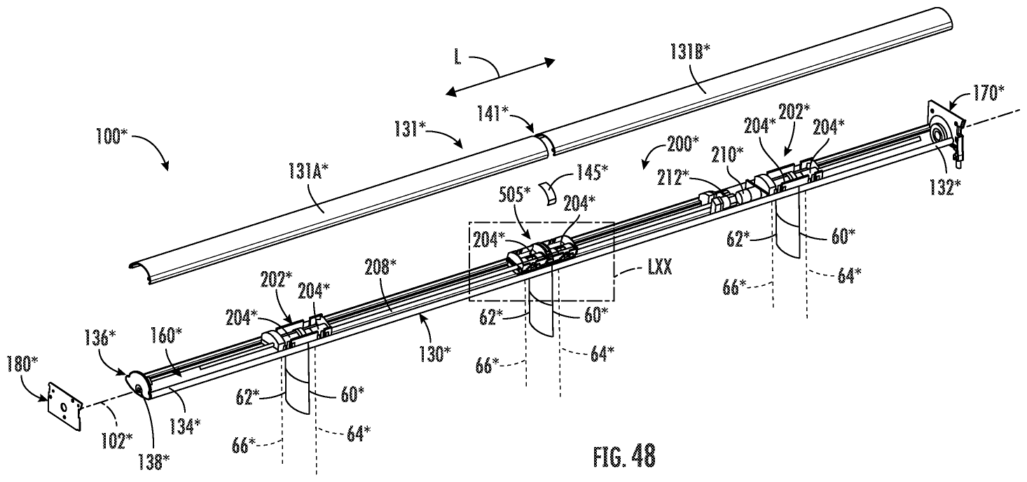

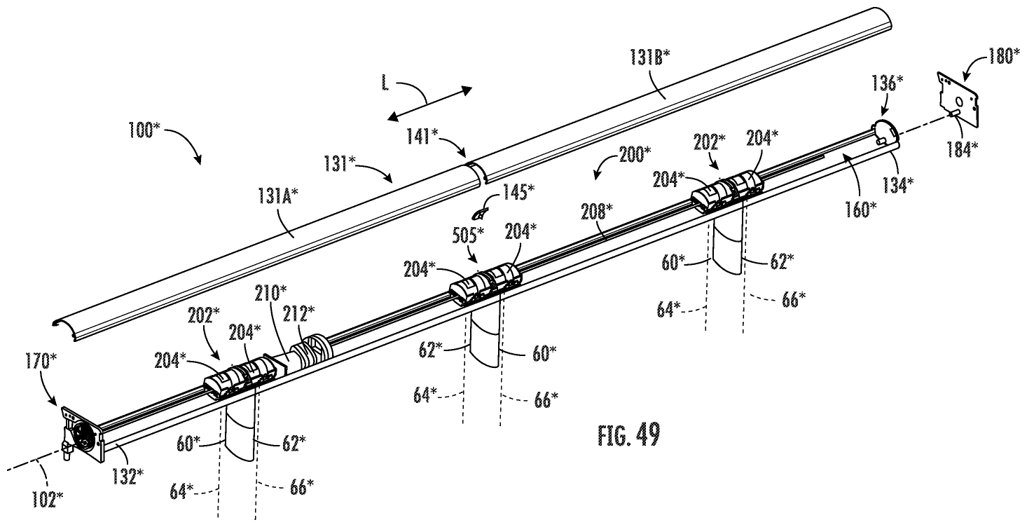

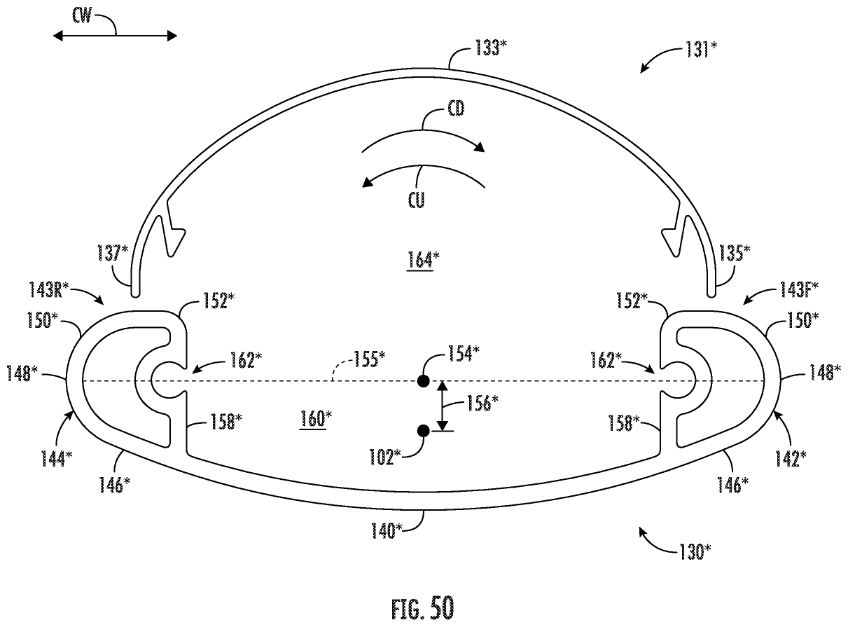

Referring now to FIGS. 47-50, differing views of one embodiment of various components of the tilt and lift systems 100*, 200* described above are illustrated in accordance with aspects of the present subject matter. Specifically, FIG. 47 illustrates a perspective, assembled view of various components of the tilt system 100*, while FIGS. 48 and 49 illustrate different perspective views of the tilt system components shown in FIG. 47 with the idle end plate 180* and a rail cover 131* for the tilt rail 130* being exploded away to allow the various components of the lift system 200* supported by the rail 130* to be visible. FIG. 50 illustrates a cross-sectional view of the tilt rail 130* and associated rail cover 131* shown in FIG. 47 taken about line XXL-XXL and with all the various other tilt/lift system components being removed for purposes of illustration. Additionally, FIGS. 47-49 illustrate the various cords/runs that depend or extend from the tilt rail 130*, such as the lift cords 64*, 66* (shown as dashed lines for purposes of illustration) and the front and rear ladder runs 60*, 62* of the ladder tape assemblies 58*.

As indicated above, the tilt rail 130* may be configured to extend laterally between a drive end 132* configured to be coupled to the tilt drive assembly 170* and an idle end 134* configured to be coupled to the opposed idle end plate 180* of the tilt system 100*, with the tilt drive assembly 170* being configured to cause the tilt rail 130* to be rotated about a tilt axis 102* of the tilt system 100*. As shown in FIGS. 48 and 49, the idle end 134* of the tilt rail 130* may be configured to be coupled to the idle end plate 180* via an idle end cover 136* that supports the tilt rail 130* for rotation about the tilt axis 102* relative to the idle end plate 180*. Specifically, in several embodiments, the idle end plate 180* may correspond to a fixed or non-rotating component of the tilt system 100*. In such embodiments, to rotationally support the idle end 134* of the tilt rail 130* relative to the fixed plate 180*, the idle end plate 180* and associated end cover 136* may include or define complementary rotational connection features. For instance, as shown in FIGS. 48 and 49, the idle end cover 136* defines a shaft opening 138* (FIG. 48) configured to receive a stub shaft 184* (FIG. 49) extending laterally from the idle end plate 180* along the tilt axis 102*. In such an embodiment, the stub shaft 184* may be configured to define a bearing surface about which the tilt rail 130* (and cover 136*) rotate relative to the idle end plate 180* about the tilt axis 102*.

As particularly shown in FIG. 50, the tilt rail 130* may generally include a bottom wall 140* (e.g., a curved or arced bottom wall) extending in a front-to-rear or crosswise direction (indicated by arrow CW in FIG. 50) between a front edge wall 142* and a rear edge wall 144*. In several embodiments, each edge wall 142*, 144* may be configured as a radiused or curved wall having a first wall portion 146* extending between the bottom wall 140* and an apex point 148* for the radiused edge wall 142*, 144* and a second wall portion 150* extending from the apex point 148* to a distal end 152* of the edge wall 142*, 144*. In one embodiment, a center of mass of the tilt rail 130* (indicated by point 154*) may generally be positioned equidistant from the apex points 148* along a reference line (indicated by dashed line 155*) extending directly between the apex points 148*. Similar to the embodiment described above, the center of mass 154* of the tilt rail 130* may, in one embodiment, be offset from the tilt axis 102* of the tilt system 100* by a given distance 156*.

Additionally, as shown in FIG. 50, the tilt rail 130* further includes opposed internal sidewalls 158* extending between the distal end 152* of each radiused edge wall 142*, 144* and the bottom wall 140* of the tilt rail 130*. As shown in the illustrated embodiment, the internal sidewalls 158*, along with the bottom wall 140*, generally define an upward-facing, open-ended mounting channel 160*. As will be described below, various components of the lift system 200* may be installed within the open-ended mounting channel 160* to allow such lift system components to be supported by the tilt rail 130* for rotation therewith about the tilt axis 102*. Additionally, as particularly shown in FIG. 50, the internal sidewalls 158* of the tilt rail 130* may be configured to define mounting slots 162* along each side of the mounting channel 160*. Such mounting slots 162* may allow for the various lift system components to be coupled to the tilt rail 130*, such as by configuring such components to include corresponding mounting tabs or similar structure extending outwardly therefrom that is configured to be received within the opposed mounting slots 162*. Moreover, the mounting slots 162* may also facilitate coupling the drive and idle ends 132*, 134* of the tilt rail 130* to the tilt drive assembly 170* and the idle end plate 180*, respectively.

Additionally, as shown in FIGS. 47-50, the tilt system 100* may also include a rail cover 131* configured to be positioned over and cover the upward-facing open-ended mounting channel 160* of the rail 130*. In several embodiments, the tilt rail 130* and rail cover 131* (along with the tilt drive assembly 170* and idle end plate 180* at the opposed ends 132*, 134* of the rail 130*) may generally define a tubular enclosure or chamber 164* (FIG. 50) for housing the components of the lift system 200*. For instance, as indicated above and as shown in FIGS. 48 and 49, various lift system components may be installed within the upward-facing, open-ended mounting channel 160* defined by the tilt rail 130*. In such an embodiment, when the rail cover 131* is positioned relative to the tilt rail 130* to cover the upward-facing, open end of the mounting channel 160* (and the tilt drive assembly 170* and idle end plate 180* are installed relative to the respective ends 132*, 134* of the tilt rail 130*), the tubular enclosure 164* (FIG. 50) is formed within which the lift system components are encapsulated or housed.

The rail cover 131* may, in several embodiments, be formed as a multi-piece assembly, such as a two-piece assembly. For instance, as shown in FIGS. 47-49, the rail cover 131* is formed by first and second cover portions 131A*, 131B* configured to extend across and cover separate axial lengths of the tilt rail 130*. Since both cover portions 131A, 131B have the same configuration, such cover portions 131A, 131B will generically be referred to herein as the rail cover 131 when describing their configuration (e.g., with reference to FIG. 50). Additionally, as particularly shown in FIGS. 47-49, a small gap or slot 141* may be defined between the adjacent ends of the cover portions 131A, 131B when such components are installed relative to the tilt rail 130* that wraps around from the top of the rail cover 131* toward the rear or aft end thereof. This slot 141* may generally be configured to accommodate the rail support bracket 503* of the rail support assembly 501* when the tilt rail 130* and rail cover 131* are being pivoted relative thereto about the tilt axis 102*, as will be described below with reference to FIGS. 70-83. Additionally, as shown in FIGS. 47-49, a small rail cover extension 145* may be configured to be positioned within the slot 141* along the front side thereof to provide an aesthetically pleasing look along the room-side of the associated covering 50*.

As particularly shown in FIG. 50, the rail cover 131* (e.g., each cover portion 131A, 131B) generally includes an arcuate or curved cover wall 133* extending circumferentially between a front edge portion 135* and a rear edge portion 137* of the rail cover 131. Moreover, as shown in FIG. 50, the tilt rail 130* and rail cover 131* may be configured such that front and rear cord reveals or “cord gaps” 143F*, 143R* are defined at the support interfaces between such components when the rail cover 131* is installed relative to the tilt rail 130*. As shown in FIG. 47, the cord gaps 143F*, 143R* (only one of which is shown) may, in one embodiment, extend along the length of the front and rear sides of the tilt rail 130*. Similar to the embodiment described above, the cord gaps 143F*, 143R* may allow the front and rear runs 60*, 62* of each ladder tape assembly 58* and lift cords 64*, 66* to pass between the tilt rail 130* and rail cover 131* at the support interfaces from the interior of the enclosure or chamber 164* (FIG. 50) defined by such components and subsequently extend downwardly or depend from the front and rear edge walls 142*, 144* of the tilt rail 130*.

Referring still to FIGS. 47-50, the lift system 200* may generally include any suitable components provided in operative association with the tilt rail 130* that allows such components to function to raise and lower the bottom rail assembly 54* relative to the headrail assembly 52* of the associated covering 50*. For instance, in several embodiments, the lift system 200* may include two or more lift stations (e.g., three lift stations 202*, 505*) installed within the mounting channel 160* of the tilt rail 130*. Specifically, as shown in FIGS. 48 and 49, the lift system 200* includes a respective lift station 202*, 505* for each pair of lift cords 64*, 66* of the associated covering 50* (e.g., first, second, and third lift stations 202*, 505* when the covering 50* includes first, second, and third pairs of lift cords 64*, 66*), with each lift station 202*, 505* including a pair of lift spools 204* for winding and unwinding the respective front and rear lift cords 64*, 66* of the corresponding pair of cords. As will be described in greater detail below with reference to FIGS. 70-83, one of the lift stations (e.g., the centrally located lift station 505*) may also be configured to form part of the rail support assembly 501* of the headrail assembly 52*. For instance, the lift station 505* may be configured to be operatively engaged with the rail support bracket 503* of the rail support assembly 501* to facilitate vertically supporting the tilt rail 130* relative to the mounting rail 80* of the headrail assembly 52* for rotation relative thereto about the tilt axis 102*. As such, the lift station 505* may serve a dual function, i.e., as a component of the lift system 200* to assist in raising and lowering the bottom rail assembly 54* relative to the headrail assembly 52* and as a component of the rail support assembly 501* for vertically supporting the tilt rail 130*.

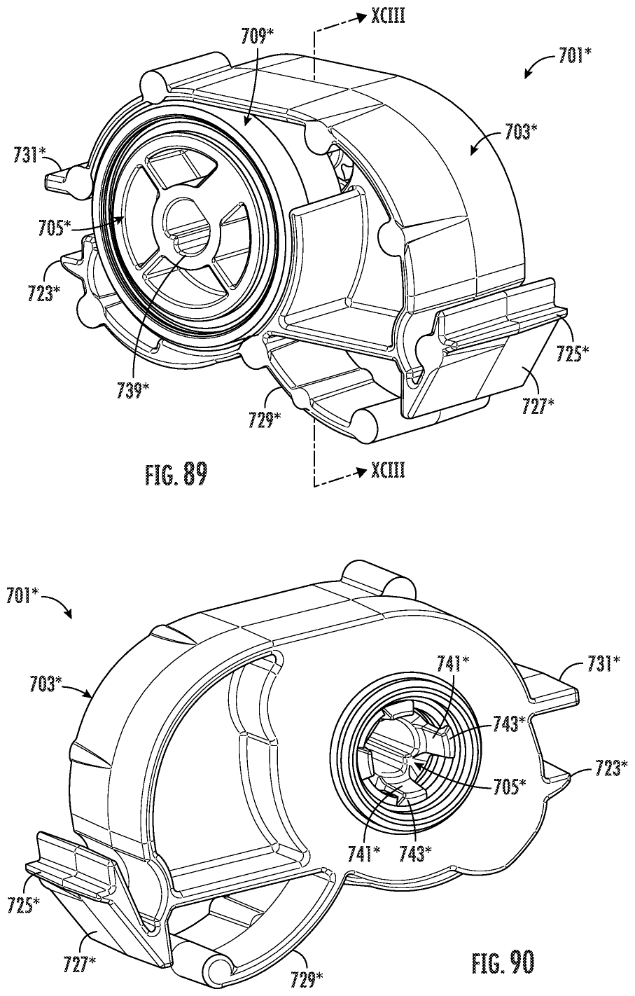

Additionally, as shown in FIGS. 48 and 49, the lift system 200* may also include a lift rod 208*, a motor 210*, and a brake 212* installed relative to the mounting channel 160* of the tilt rail 130*. As is generally, understood, the lift rod 208* may be configured to operatively couple the lift stations 202*, 505* to the motor 210* and the brake 212*. As a result, the motor 210* may be configured to store energy with rotation of the lift spools 204* (and lift rod 208*) in a lowering direction as the bottom rail assembly 54* is lowered relative to the headrail rail assembly 52* and release such energy to rotationally drive the lift rod 208* (and lift spools 204*) in an opposite, raising direction as the bottom rail assembly 54* is being raised relative to the headrail assembly 52* to assist in moving the covering 50* to its retracted position. Additionally, the brake 212* may be configured to prevent unintended rotation of the lift rod 208*. For example, as will be described below with reference to FIGS. 89-95C, the brake 212 may be configured as a one-way brake that provides a holding force for the lift system 200* to assist with maintaining the bottom rail assembly 54* at the desired position.

Similar to the embodiment described above, the ladder tape assemblies 58* may depend from the tilt rail 130* such that rotation of the tilt rail 130* about the tilt axis 102* results in the front and rear ladder runs 60*, 62* of the ladder tape assemblies 58* being raised/lowered in opposite directions to effectuate tilting of the slats 56*. Specifically, in several embodiments, an end of each ladder run 60*, 62* (e.g., a grommeted or knotted end) may be coupled to an interior portion of the tilt rail 130* or to a component installed within the tilt rail 130* (e.g., a housing of the adjacent tilt station 202*, 505*) to secure the ladder tape assembly 58* relative to the tilt rail 130*. Additionally, each ladder run 60*, 62* may extend from such interior connection point through the cord gap 143F*, 143R* (FIG. 50) defined between the tilt rail 130* and the rail cover 131* and at least partially wrap around the adjacent radiused edge wall 142*, 144* of the tilt rail 130* prior to extending downwardly from the tilt rail 130* towards the bottom rail assembly 54* of the associated covering 50*. In this regard, as the tilt rail 130* is rotated in a first or closed-down rotational direction about the tilt axis 102* (e.g., as indicated by arrow CD in FIG. 50) to tilt the front edges of the slats 56* downwards towards the closed-down position, the front ladder run 60* will be shifted downward as the front edge wall 142* of the tilt rail 130* pivots downwardly and the rear ladder run 62* will be shifted upward as the rear edge wall 144* of the tilt rail 130* pivots upwardly. Similarly, as the tilt rail 130* is rotated in an opposed second or closed-up rotational direction about the tilt axis 102* (e.g., as indicated by arrow CU in FIG. 50) to tilt the front edges of the slats 56* upwards towards the closed-up position, the front ladder run 60* will be shifted upward as the front edge wall 142* of the tilt rail 130* pivots upwardly and the rear ladder run 62* will be shifted downwardly as the rear edge wall 144* of the tilt rail 130* pivots upwardly.

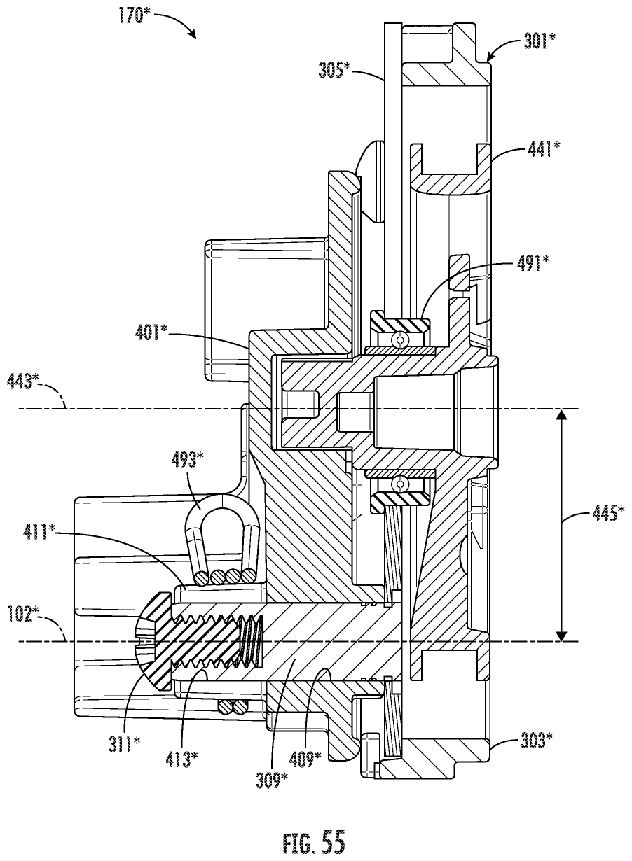

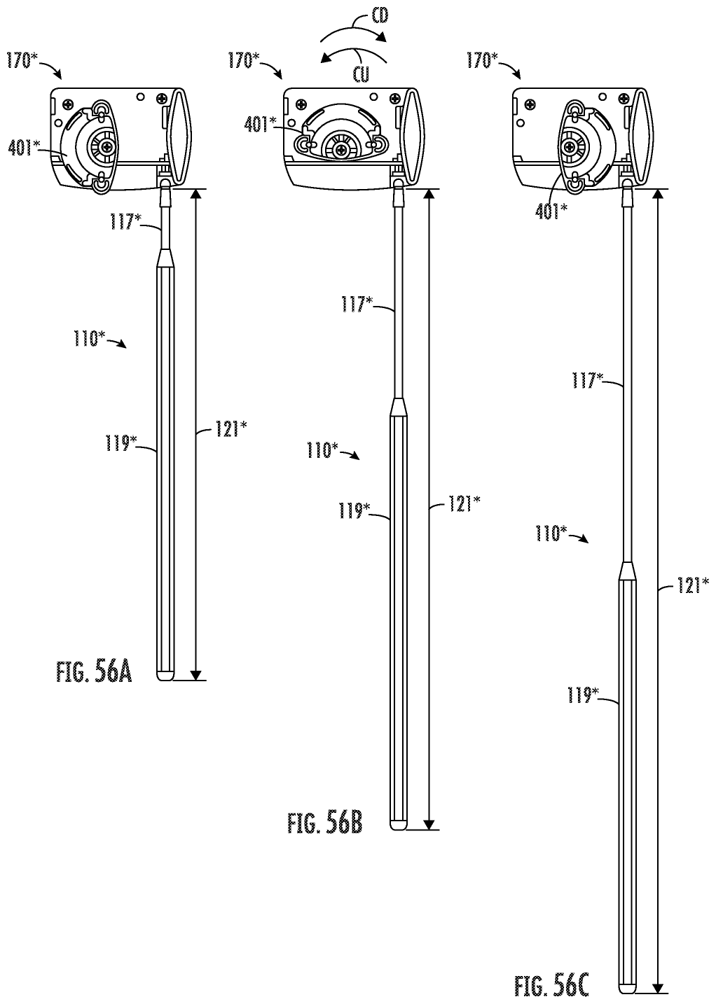

In this regard, the discussion of the tilt rail 130 (and associated cords 60, 62, 64, 66) provided above with reference to FIGS. 10A-10C generally applicable to the tilt rail 130* (and associated cords 60*, 62*, 64*, 66*) shown in FIGS. 47-50. Thus, the tilting of the tilt rail 130* to its various different rail positions (e.g., the rail positions shown in FIGS. 56A-56C) to effectuate tilting of the slats 56* to their associated tilt positions (e.g., a fully opened position when the tilt rail 130* is oriented similar to that shown in FIG. 56B, a closed-down position when the tilt rail 130* is oriented as shown in FIG. 56C, and a closed-up position when the tilt rail 130* is oriented as shown in FIG. 56A), as well as the significance of the offset tilt axis 102* relative to the center of mass 154* of the tilt rail 130* and the ability to maintain the bottom rail assembly 54* relatively stationary during slat tilting, will not be repeated to avoid further duplicative language.

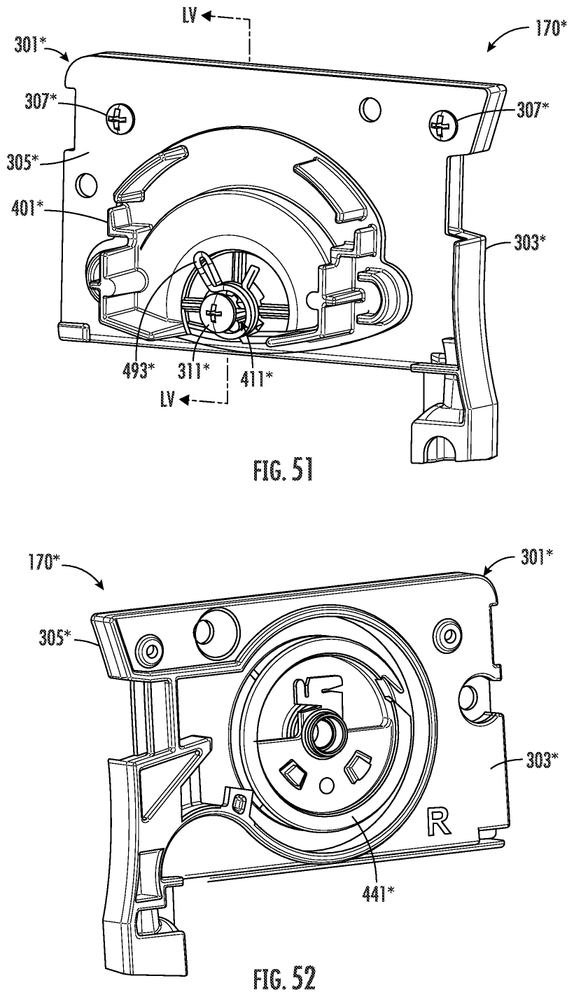

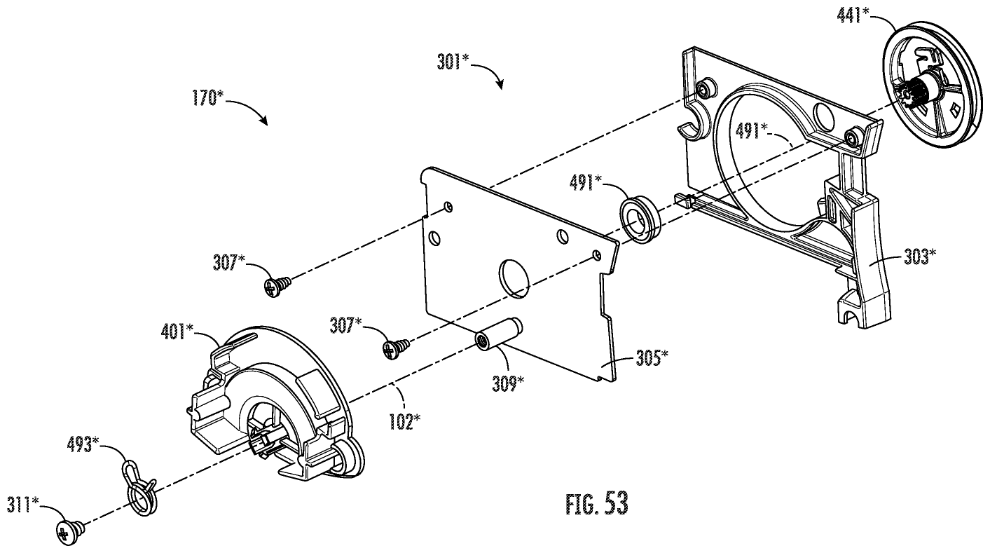

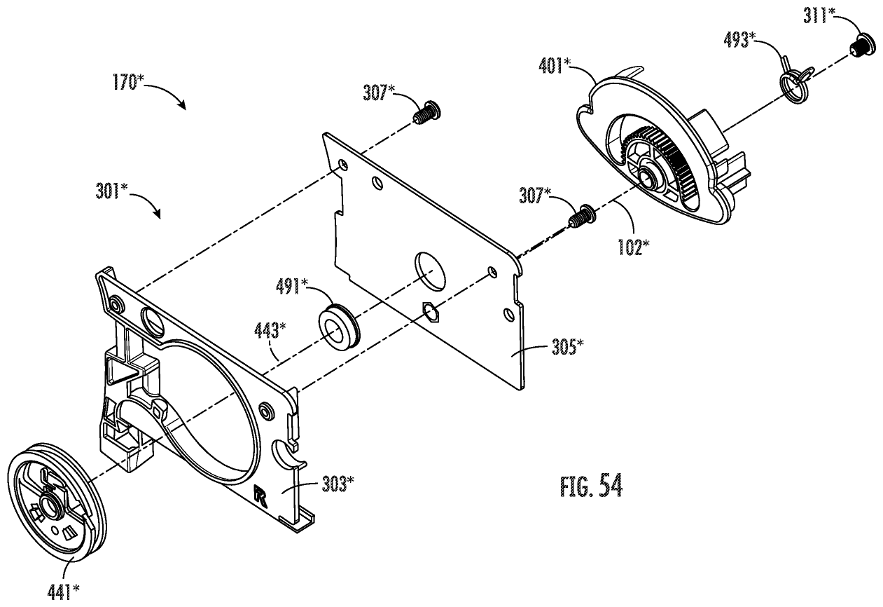

Referring now to FIGS. 51-55, various views of one embodiment of a tilt drive assembly (e.g., tilt drive assembly 170*) suitable for use within one or more embodiments of a tilt system (e.g., the disclosed tilt system 100*) are illustrated in accordance with aspects of the present subject matter. Specifically, FIGS. 51 and 52 illustrate opposed perspective, assembled views of the tilt drive assembly 170* and FIGS. 53 and 54 illustrate opposed perspective, exploded views of the tilt drive assembly 170* shown in FIGS. 50 and 51, respectively. Additionally, FIG. 55 illustrates a cross-sectional view of the tilt drive assembly 170* shown in FIG. 51 taken about line LV-LV.

As shown in the illustrated embodiment, the tilt drive assembly 170* includes an end plate assembly 301*. The end plate assembly 301* generally corresponds to a fixed assembly of the tilt drive assembly 170*. For instance, as will be described below, the end plate assembly 301* may be configured to be fixedly coupled to the mounting rail 80* of the headrail assembly 52* for supporting the remainder of the headrail assembly 52* relative to the mounting rail 80*. The end plate assembly 301* may also be configured to be coupled to the adjacent endcap of the headrail assembly 52* (e.g., the first endcap 74* (FIG. 42)). As particularly shown in FIGS. 53 and 54, the end plate assembly 301* includes an outer end plate 303* and an end cover 305* configured to be rigidly coupled outer end plate 303* (e.g., via fasteners 307*).

Additionally, as shown in FIGS. 51 and 53-55, the tilt drive assembly 10* also includes a tilt rail cap 401*. In contrast to the end plate assembly 301*, the tilt rail cap 401* generally corresponds to a rotatable or pivotable tilt drive component of the tilt drive assembly 170*. Specifically, in several embodiments, the tilt rail cap 401* may be configured to be coupled to the end plate assembly 301* (e.g., via a suitable standoff or stub shaft 309* (FIG. 53) extending from the end plate cover 305* and an associated fastener 311*) for rotation relative thereto about the tilt axis 102* (FIGS. 53-55) of the tilt system 100*. As such, the tilt rail cap 401* (and any other tilt system components coupled thereto or supported thereby) may be configured to rotate or pivot relative to the fixed end plate assembly 301* of the tilt drive assembly 170*. For instance, as will be described below, the drive end 132* of the tilt rail 130* may be coupled to the tilt rail cap 401* such that the tilt rail cap 401* and tilt rail 130* rotate together about the tilt axis 102*.

Moreover, the tilt drive assembly 170* further includes a cord drum or drive pulley 441* configured to be supported by the end plate assembly 301* for rotation relative thereto (e.g., via an associated pulley bearing 491* (FIGS. 53-55). As will be described below, a cord path is defined within the tilt drive assembly 170* to allow the tilt cords 113*, 115* to engage or interact with the drive pulley 441*. For instance, the tilt cords 113*, 115* may exit the tilt wand 110* and enter the tilt drive assembly 170* via a wand socket of the outer end plate 303* and extend through a corresponding cord channel defined by the outer end plate 303* to the drive pulley 441*, at which point the tilt cords 113*, 115* may be at least partially wound or wrapped around the drive pulley 441* in opposed directions and coupled thereto (e.g., by tying off an end of each cord 113*, 115* to the drive pulley 441*). For instance, the first tilt cord 113* may be wrapped around the drive pulley 441* in a first direction and the second tilt cord 115* may be wrapped around the drive pulley 441* in a second direction. As such, depending on the direction of rotation of the drive pulley 441*, each tilt cord 113*, 115* may be configured to be wound around or unwound from the pulley 443* with rotation thereof about a separate pulley axis 443* (FIGS. 53-55) spaced apart radially from the tilt axis 102* via a given axis spacing distance 445 (FIG. 55).

Referring still to FIGS. 51-55, the tilt drive assembly 170* also includes a brake spring 493* (FIGS. 51 and 53-55) provided in operative association within the tilt rail cap 401*. In general, the brake spring 493* is configured to create a frictional interface between the tilt rail cap 401* and the stub shaft 309* that supports the rail cap 401* relative to the end plate assembly 301* for rotation relative thereto about the tilt axis 102*. Specifically, as will be described below, the brake spring 493* may be configured to apply a radially-inwardly directed, compressive force against a plurality of spring tabs of the tilt rail cap 401* that surround the stub shaft 309*, thereby compressing the spring tabs against the shaft 309* to create the frictional interface therebetween. This frictional interface may generally serve to maintain the tilt rail cap 401* (and, thus, the tilt rail 130* coupled thereto) at a given position when the operator releases the tilt wand 110*, thereby allowing the slats 56* to be maintained at the operator-selected tilt position. However, when the operator manipulates the tilt wand 110* (e.g., by moving the second wand portion 119* up or down relative to the first wand portion 117*), the torque applied to the tilt rail cap 401* via the drive pulley 441* is sufficient to overcome the friction defined between the tilt rail cap 401* and the stub shaft 309*, thereby allowing the tilt rail cap 401* to rotate relative to the shaft 309* about the tilt axis 102* to effectuate tilting of the slats 56*.

Referring briefly to FIGS. 56A-56C, various end views of the tilt drive assembly 170* described above are illustrated with the tilt wand 110* installed relative thereto, particularly illustrating the tilt rail cap 401* of the tilt drive assembly 170* and the tilt wand 110* at differing positions corresponding to different tilt positions of the slats 56* of the associated covering 50*. For instance, FIG. 56B illustrates an operating position/state of the tilt rail cap 401* and tilt wand 110* when the slats 56* are at the fully opened position. Additionally, FIGS. 56A and 56C illustrate the operating positions/states of the tilt rail cap 401* and tilt wand 110* when the slats 56* are at a closed-up position and a closed-down position, respectively.

As shown in FIG. 56B, when the slats 56* are at the fully opened position (e.g., the position shown in FIG. 41), the tilt rail cap 401* is disposed at a substantially horizontal orientation and the tilt wand 110* defines an effective length 121* that is generally equal to 50% of its maximum effective length. To transition the slats 56* from the fully opened position to the closed-down position, the second wand portion 119* is pulled downwardly relative to the first wand portion 117*, which results in the tilt rail cap 401* (and the tilt rail 130* coupled thereto) being rotated about the tilt axis 102* in the closed-down direction (indicated by arrow CD in FIG. 56B) from the substantially horizontal orientation shown in FIG. 56B to the substantially vertical orientation shown in FIG. 56C. As such position, the tilt wand 110* generally defines an effective length 121* that equal to its maximum effective length. Similarly, to transition the slats 56* from the fully opened position to the closed-up position, the second wand portion 119* is pushed upwardly relative to the first wand portion 117*, which results in the tilt rail cap 401* (and the tilt rail 130* coupled thereto) being rotated about the tilt axis 102* in the closed-up direction (indicated by arrow CU in FIG. 56B) from the substantially horizontal orientation shown in FIG. 56B to the substantially vertical orientation shown in FIG. 56A. As such position, the tilt wand 110* generally defines an effective length 121* that equal to its minimum effective length. Accordingly, by moving the second wand portion 119* relative to the first wand portion 117* across the range of travel shown between the wand positions in FIGS. 56A and 56C, the tilt rail cap 401* (and the tilt rail 130* coupled thereto) may generally be pivoted about the tilt axis 102* approximately 180 degrees.

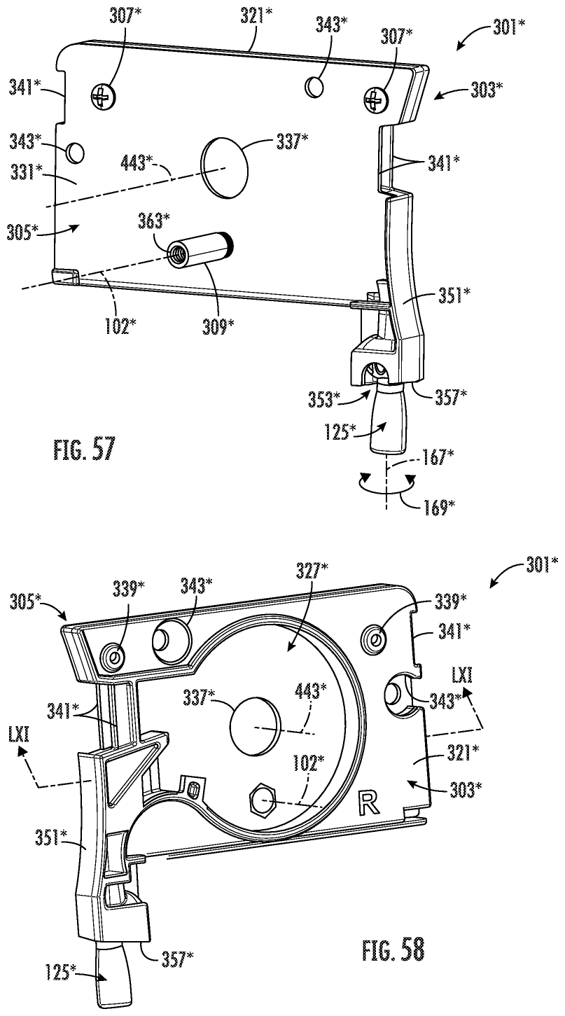

The various components and sub-assemblies of the tilt drive assembly 170* noted above will now be described in more detail with reference to FIGS. 57-67.

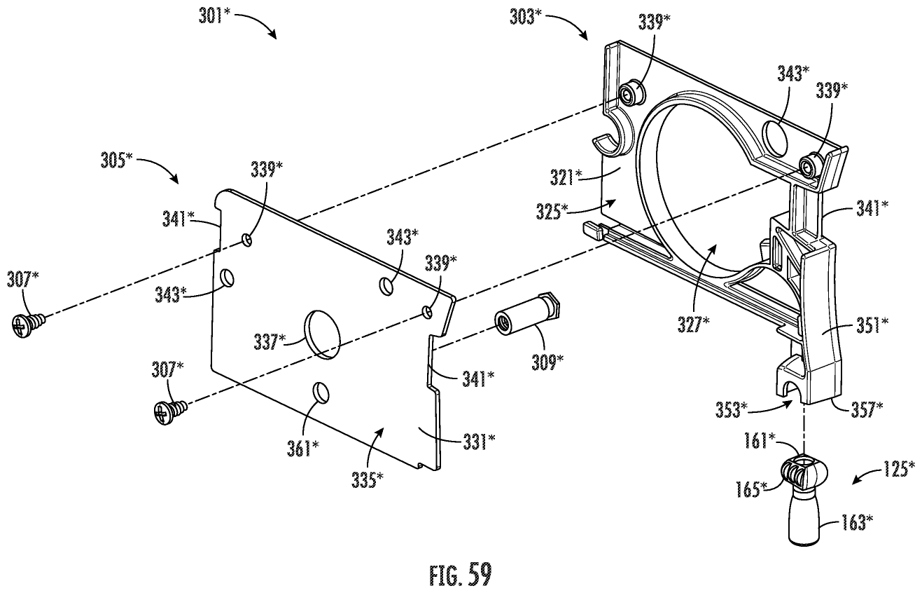

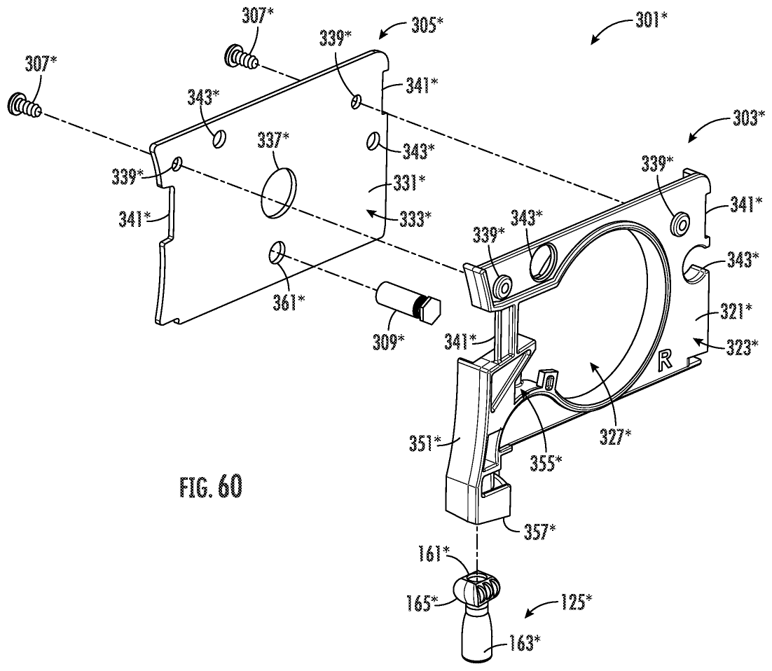

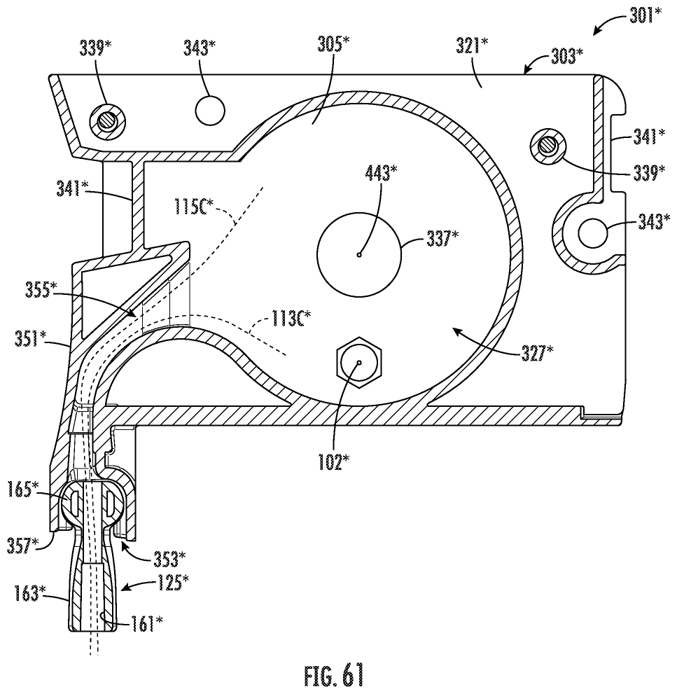

Referring specifically to FIGS. 57-61, various views of the end plate assembly 301* and the wand pivot member 125* of the tilt wand 110* are illustrated in accordance with aspects of the present subject matter. Specifically, FIGS. 57 and 58 illustrate opposed perspective, assembled views of the end plate assembly 301* and wand pivot member 125*. FIGS. 59 and 60 illustrate exploded views of the end plate assembly 301* and wand pivot member 125* shown in FIGS. 57 and 58. Additionally, FIG. 61 illustrates a cross-sectional view of the end plate assembly 301* and wand pivot member 125* shown in FIG. 58 taken about line LXI-LXI.

As indicated above, the end plate assembly 301* generally includes an outer end plate 303* and an associated end plate cover 305*. As particularly shown in FIGS. 59 and 60, the outer end plate 303* generally includes a planar wall portion 321* at least partially defining an outer side 323* (FIG. 60) of the end plate 303* that is configured to face towards the adjacent endcap of the headrail assembly 52* (e.g., the first endcap 74* (FIG. 42)) and an inner side 325* (FIG. 59) of the end plate 303* that is configured to face towards the end plate cover 305*. A central pulley opening 327* is defined through the wall portion 321* and extends coaxially along the pulley axis 443* (FIGS. 57 and 58) of the tilt system 100* from the outer side 323* of the end plate 303* to the inner side 325* of the end plate 303*.

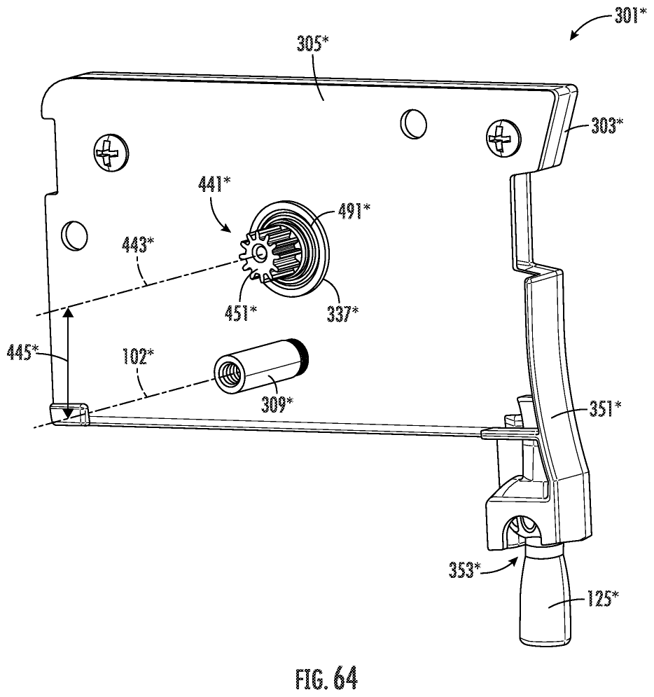

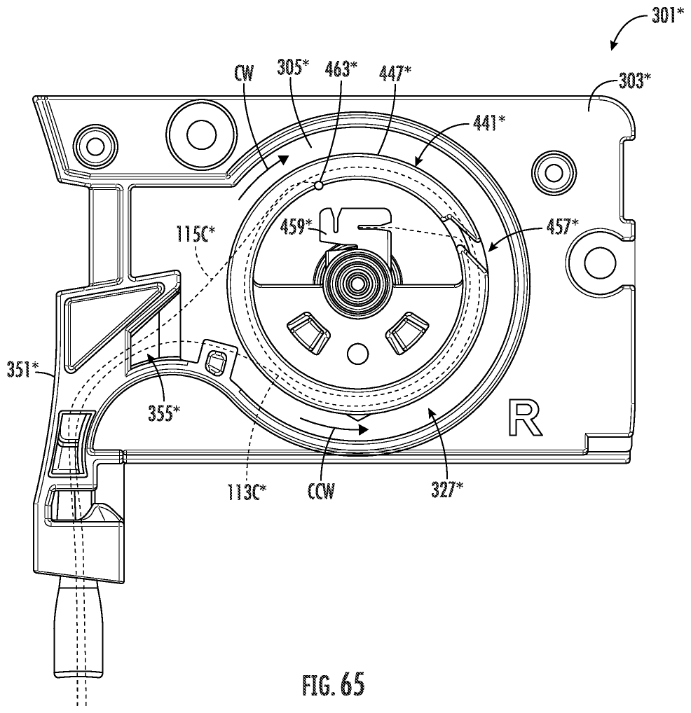

Additionally, as particularly shown in FIGS. 59 and 60, the end plate cover 305* generally includes a planar wall portion 331* at least partially defining an outer side 333* (FIG. 60) of the plate cover 305* that is configured to face towards the outer end plate 303* and an inner side 335* (FIG. 59) of the plate cover 305* that is configured to face towards the tilt rail cap 401* of the tilt drive assembly 170*. A pulley axis opening 337* defined through the wall portion 331* and extends coaxially along pulley axis 443* (FIGS. 57 and 58) from the outer side 333* of the cover 305* to the inner side 335* of the cover 305*. As such, when the outer end plate 303* and end plate cover 305* are assembled together, the central pulley opening 327* and pulley axis opening 337* may generally be coaxially aligned along the pulley axis 337*. As will be described below with reference to FIGS. 64 and 65, when the drive pulley 441* of the tilt drive assembly 170* is assembled relative to the end plate assembly 301*, a portion of the drive pulley 441* may be positioned within the pulley opening 327* defined by the outer end plate 303* while another portion of the drive pulley 441* may be configured to extend through the pulley axis opening 337* defined by the end plate cover 305* to allow the drive pulley 441* to be rotationally coupled to the tilt rail cap 401* in a manner that permits the tilt rail cap 401* to rotate relative to the end plate assembly 301* about the tilt axis 102* as the drive pulley 441* is being rotated about the separate pulley axis 443*.

The outer end plate 303* and end plate cover 305* may also be configured to include or define suitable mounting features for coupling such components together. For instance, as shown in FIGS. 59 and 60, the end plate 303* and plate cover 305* defined aligned fastener openings 339* for receiving suitable fasteners 307* for rigidly coupling the end plate cover 305* to the outer end plate 303*. Additionally, the outer end plate 303* and end plate cover 305* may include or define suitable mounting features for coupling the end plate assembly 301* to adjacent components of the headrail assembly 52*, such as for securing the end plate assembly 301* to the adjacent endcap 74* (FIG. 42) and mounting rail 80* (FIG. 43) of the headrail assembly 52*. For instance, as shown in FIGS. 57-60, the outer end plate 303* and plate cover 305* both define notches 341* configured to receive corresponding mounting hooks or tabs of the endcap 74* for coupling such endcap 74* to the end plate assembly 301*. Moreover, as shown in FIGS. 57-60, the end plate 303* and plate cover 305* define aligned fastener openings 343* for receiving suitable fasteners for rigidly coupling the end plate assembly 301 to the mounting rail 80* of the headrail assembly 52*.

Referring still to FIGS. 57-61, the outer end plate 303* also includes a sidewall portion 351* defining features for receiving one or more cord-related components of the tilt system 100*. For instance, as particularly shown in FIG. 61, the sidewall portion 351* of the outer end plate 303* may define a wand socket 353* configured to receive a corresponding portion of the wand pivot member 125* and a cord channel 355* configured to receive portions of the tilt cords 113*, 115* extending from the tilt wand pivot member 125*. Specifically, as shown in the illustrated embodiment, the wand socket 353* is generally characterized by an open-ended, substantially rectangular-shaped cavity defined at a lower or bottom end 357* of the sidewall portion 351*, with the cord channel 355* extending between the wand socket 353* and the central pulley opening 327* of the outer end plate 303*. As such, the tilt cords 113*, 115* extending through the tilt wand 110* may follow a cord path (shown schematically as dashed lines 113C*, 115C* in FIG. 61) that exits the wand 110* via a through-hole 161* (FIG. 61) defined through the wand pivot member 125* and subsequently extends through the cord channel 355* to the central pulley opening 327* of the outer end plate 303*. As will be described below with reference to FIG. 65, the cords 113*, 115* may then be wrapped around a portion of the drive pulley 441* positioned within the pulley opening 327* in opposing directions and subsequently coupled thereto.

As particularly shown in FIGS. 59-61, the wand pivot member 125* includes a lower connector portion 163* configured to be coupled to a corresponding portion of the tilt wand 110*. For instance, in one embodiment, the lower connector portion 125* may be configured to be pressed onto the upper end 117A* of the first wand portion 117* (FIGS. 44 and 45) of the tilt wand 110*. The wand pivot member 125* also includes an upper joint portion 165* configured to form a pivot or ball joint for pivoting the tilt wand 110* relative to the outer end plate 303*. Specifically, the upper joint portion 165* may be configured to be received within the wand socket 353* defined by the outer end plate 303* to form the pivot or ball joint between such components. As shown in FIGS. 59-61, the upper joint portion 165* may, in one embodiment, define an oblong, substantially rectangular-shaped body that generally matches the substantially rectangular shape of the wand socket 353*. Such a configuration may facilitate pivoting of the tilt wand 110* relative to the end plate assembly 301* about one or more planes. For example, in the illustrated embodiment, the socket joint formed between the end plate assembly 301* and the wand pivot member 125* may allow the tilt wand 110* to be pivoted relative to the end plate assembly 301* approximately 180 degrees in any direction, including about a vertical plane extending perpendicular to the tilt axis 102* and about a vertical plane extending parallel to the tilt axis 102*. Moreover, the rectangular shape or profile of the socket joint (as opposed to a circular shaped ball joint) may also function to substantially prevent twisting of the tilt wand 110* relative to the end plate assembly 301*. Specifically, the rectangular-shaped socket joint formed between the end plate assembly 301* and the wand pivot member 125* may substantially prevent the wand pivot member 125* (and tilt wand 110*) from being rotated about a longitudinal axis thereof (e.g., as indicated by line 167* in FIG. 57) relative to the end plate assembly 301*, such as by preventing the tilt wand 110* from being rotated in the direction of arrow 169* (FIG. 57) about the longitudinal axis 167*.

As indicated above, when the tilt cords 113*, 115* are installed relative to the tilt wand 110* and the tilt drive assembly 170*, the cords 113*, 115* may generally be configured to be pre-tensioned by a given amount (e.g., to a nominal pre-tension). In accordance with aspects of the present subject matter, such cord tension alone may be configured to retain the wand pivot member 125* within the wand socket 353* and, thus, retain the tilt wand 110* relative to the end plate assembly 301*. Specifically, the tension within the cords 113*, 115* may pull the tilt wand 110* upwardly towards the end plate assembly 301*, thereby maintaining the wand pivot member 125* seated within the wand socket 353*. As such, no mechanical retention means or structure is necessary to retain the tilt wand 101* relative to the end plate assembly 301*.

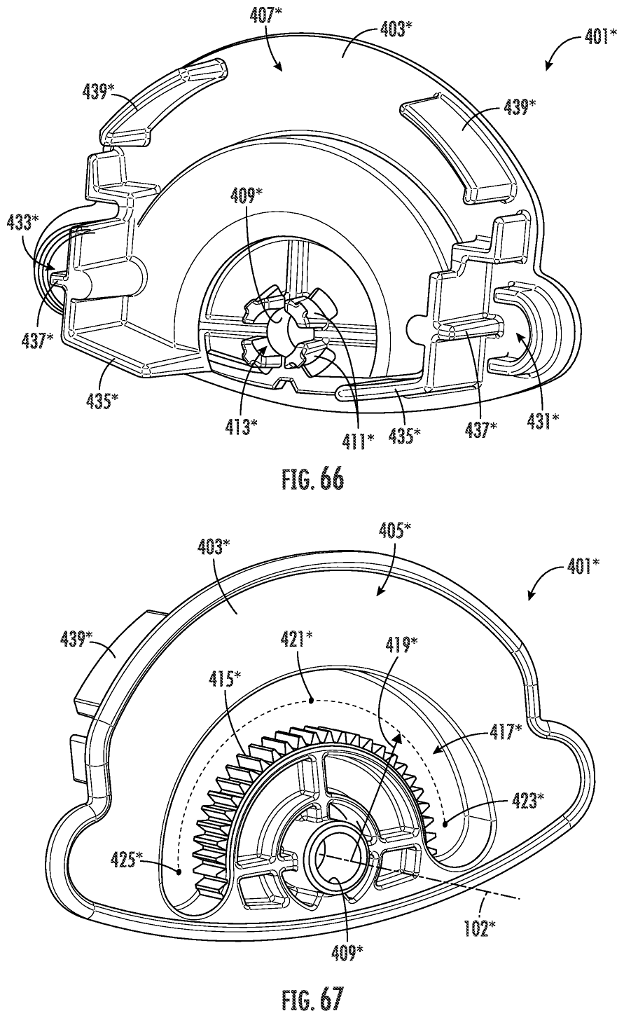

Moreover, as indicated above, the end plate assembly 301* may also include a standoff or stub shaft 309* configured to support for the tilt rail cap 401* for rotation relative thereto about the tilt axis 102*. As shown in FIGS. 59 and 60, to accommodate the stub shaft 309*, the end plate cover 305* may define a shaft opening 361* configured to receive the stub shaft 309*, with the shaft opening 361* being coaxially aligned with the tilt 102*. As such, when the stub shaft 309* is inserted through the shaft opening 351* (e.g., until a head of the shaft 361* contacts the outer side 333* of the plate cover 305*), the stub shaft 309* may extend outwardly from the inner side 335* of the cover plate 205* along the tilt axis 102* to allow an outer circumferential surface of the shaft 309* to serve as a bearing surface for the tilt rail cap 401*. For instance, as will be described below with reference to FIGS. 66 and 67, the tilt rail cap 401* may define a tilt shaft opening within which the stub shaft 309* is configured to be received, thereby allowing the tilt rail cap 401* to be pivotably coupled to the end plate assembly 301* via the stub shaft 309*. Additionally, as shown in FIG. 57, a fastener or threaded opening 363* may be defined at the end of the stub shaft 309* for receiving a corresponding fastener 311* (FIG. 55) configured to retain the tilt rail cap 401* on the stub shaft 309*.

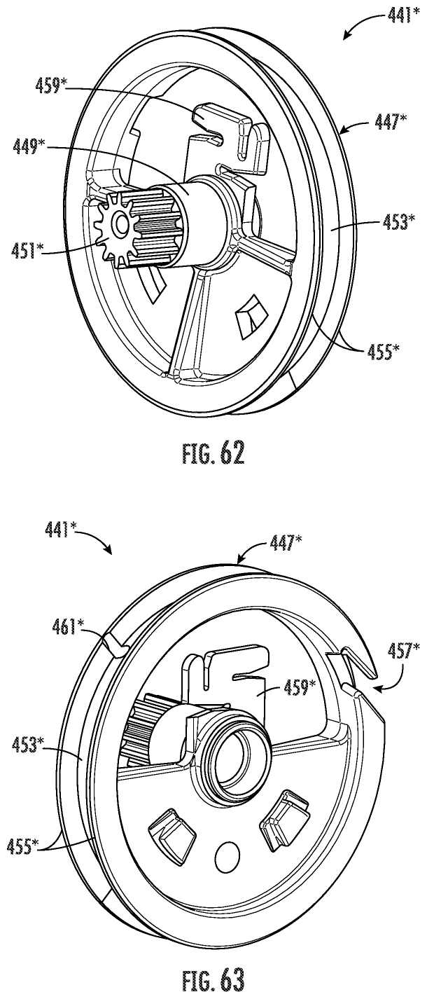

Referring now to FIGS. 62-65, various views of the drive pulley 441* are illustrated in accordance with aspects of the present subject matter. Specifically, FIGS. 62 and 63 illustrate opposed perspective views of the drive pulley 441*. Additionally, FIGS. 64 and 65 illustrate perspective and end views, respectively, of the drive pulley 441* as assembled relative to the end plate assembly 301* of the tilt drive assembly 170*.

As particularly shown in FIGS. 62 and 63, the drive pulley 441* generally includes an outer pulley portion 447* about which the tilt cords 113*, 115* are configured to wind and unwind, a central bearing post 449* (FIG. 62) extending outwardly from the pulley portion 447* along the pulley axis 443* of the drive pulley 441* and an inner gear post 451* (FIG. 62) extending outwardly from the central bearing post 449* opposite the outer pulley portion 447* along the pulley axis 443*. In general, the pulley portion 447* may be configured similar to a conventional pulley and, thus, may include, for example, a recessed pulley surface 453* extending between opposed pulley flanges 455*. As such, the tilt cords 113*, 115* may be configured to wind around and unwind from the recessed pulley surface 453*, with the tilt cords 113*, 115* being retained on such surface 453* between the opposed flanges 455*. Additionally, the pulley portion 447* may be configured to define suitable features for coupling the tilt cords 113*, 115* thereto. Specifically, as shown in FIG. 63, a cord slot 457* is defined through a portion of the recessed pulley surface 453* to allow one of the tilt cords (e.g., the first tilt cord 113*) to be secured to a portion of the drive pulley 441* (e.g., a tie-off tab 459* positioned within an interior of the pulley portion 447*). For instance, in one embodiment, the first tilt cord 113* may extend through the cord slot 457* and may be wrapped around and/or tied-off to the tie-off tab 459(. Moreover, as shown in FIG. 63, a cord opening 461* is defined through another portion of the recessed pulley surface 453* to allow the other tilt cord (e.g., the second tilt cord 115*) to be secured to the drive pulley 441. For instance, in one embodiment, an end of the tilt cord 115* may be inserted through the cord opening 461* and subsequently knotted so that the knotted end cannot be pulled back through the cord opening 461*, thereby securing the tilt cord 115* to the drive pulley 441*.

Referring specifically to FIG. 64, the bearing post 449* of the drive pulley 44′* may generally be configured to be pressed into the pulley bearing 491* (see also FIGS. 53 and 54 for the bearing 491*), with the pulley bearing 491*, in turn, being configured to be pressed into the pulley axis opening 337* defined through the end plate cover 305*, thereby providing a low friction, rotational interface for rotation of the drive pulley 441* relative to the end plate assembly 401 about the pulley axis 443*. Thus, as shown in FIGS. 64 and 65, with the bearing post 449* and pulley bearing 491* installed within the pulley axis opening 337*, the outer pulley portion 447* of the drive pulley 441* may be positioned within the pulley opening 327* of the outer end plate 305* along the outer side thereof while the gear post 451* of the drive pulley 441* may be positioned along the opposed inner side of the end plate cover 305* and extend outwardly therefrom along the pulley axis 443* of the drive pulley 441*. As will be described below with reference to FIGS. 66 and 67, the gear post 451 of the drive pulley 441 may, in turn, be configured to mesh with a corresponding gear portion of the tilt rail cap 401* to allow the tilt rail cap 401* to pivot or rotate about the tilt axis 102* with rotation of the drive pulley 441* about its respective pulley axis 443*.

Referring specifically FIG. 65, a cord path of each respective tilt cord 113*, 115* is shown (indicated by dashed lines 113C,*, 115C* in FIG. 65) as the tilt cords 113*, 115* extend through the end plate assembly 301* and wrap around the pulley portion 447* of the tilt drum 441*. In particular, FIG. 65 illustrates the cord path for the tilt cords 113*, 115* when the tilt rail 130* is oriented at the position shown in FIG. 56A such that the slats 56* are tilted to their closed-up position. As shown in FIG. 65, at such tilt position, the first tilt cord 113* is configured to extend upwardly through the cord channel 355* defined by the end plate 303* and wrap around the outer pulley portion 447* of the drive pulley 441* in a counter-clockwise wrapping direction (indicated by arrow CCW in FIG. 65). For instance, in the illustrated embodiment, the first tilt cord 113* is configured to be wrapped around the drive pulley 441* one or more times (e.g., two times) in the CCW direction and then extend through the cord slot 457* to allow an end of the first tilt cord 113* to be coupled to the tie-off tab 459* of the drive pulley 441*. Additionally, as shown in FIG. 65, the second tilt cord 115* is configured to extend upwardly through the cord channel 355* defined by the end plate 303* and wrap around a portion of the outer pulley portion 447* of the drive pulley 441* in a clockwise wrapping direction (indicated by arrow CW in FIG. 65), with an end of the second tilt cord 115* being coupled to the pulley portion 447* (e.g., at location 463* shown in FIG. 65).

It should be appreciated that, as the tilt wand 110* is actuated or manipulated by a user, the amount that each cord 113*, 115* is wound around the drive pulley 441* will vary. For instance, as indicated above, FIG. 65 illustrates the positioning/winding of the tilt cords 113*, 115* when the tilt rail 130* is oriented at the position shown in FIG. 56A such that the slats 56* are tilted to their closed-up position. In this regard, as the second wand portion 119* is moved downwardly relative to the first wand portion 117* to tilt the slats 56* away from the closed-up position, such movement of the second wand portion 119* results in the drive pulley 441* being rotationally driven in the clockwise direction CW as the first tilt cord 113* is paid off of or otherwise unwinds from the drive pulley 441* and the second tilt cord 115* is wound around the drive pulley 441*. The clockwise rotation of the drive pulley 441* may, in turn, result in the tilt rail cap 401* (and the tilt rail 130* coupled thereto) being pivoted in the closed-down direction CD (FIG. 56B), thereby tilting the slats 56* towards the closed-down position.

Referring now to FIGS. 66 and 67, opposed perspective views of the tilt rail cap 401* of the tilt drive assembly 170* are illustrated in accordance with aspects of the present subject matter. As particularly shown in FIGS. 66 and 67, the tilt rail cap 401* generally includes a planar wall portion 403* at least partially defining an outer side 405* (FIG. 67) of the rail cap 401* that is configured to face towards the end plate assembly 301* and an inner side 407* (FIG. 66) of the rail cap 401* that is configured to face towards the tilt rail 130*. A tilt shaft opening 409* is defined through the wall portion 403* and is configured to extend coaxially along the tilt axis 102* from the outer side 405* of the rail cap 401* to the inner side 407* of the rail cap 401*. Additionally, as particularly shown in FIG. 66, the tilt rail cap 401* includes a plurality of circumferentially spaced spring tabs 411* extending outwardly from the tilt shaft opening 409* along the inner side 407* of the rail cap 401*. The spring tabs 411* generally form a secondary shaft opening 413* that is coaxially aligned with the tilt shaft opening 409* defined through the wall portion 403*.

As indicated above, the stub shaft 309* of the end plate assembly 301* may be configured to be received within the shaft openings 409*, 413* of the tilt rail cap 401*, thereby allowing the rail cap 401* to be supported relative to the end cover assembly 301* for rotation relative thereto about the tilt axis 102*. For instance, referring briefly back to the cross-sectional view of the assembled tilt drive assembly 170* shown in FIG. 55, the stub shaft 309* extends axially from the end plate cover 305* along the tilt axis 102* through both tilt shaft opening 409* and the secondary shaft opening 413* defined by the spring tabs 411*. Once the stub shaft 309* is inserted axially through the aligned shaft openings 409*, 413*, a suitable fastener 311* (FIG. 55) may be threaded into the fastener opening defined in the stub shaft 309* to axially retain the tilt rail cap 401* relative to the endplate assembly 301*. For instance, as shown in FIG. 55, the tilt rail cap 401* may be axially retained on the stub shaft 309* directly between the end plate cover 305* on one side and the fastener 311* on the opposed side (e.g., via the engagement between the head of the fastener 311* and the spring tabs 411* of the rail cap 401*.

Additionally, as indicated above, the brake spring 493* (FIGS. 51 and 55) of the tilt drive assembly 170* may be configured to be installed relative to the spring tabs 411* of the tilt drive system 170* to create a frictional interface between the tilt rail cap 401* and the stub shaft 309*. Specifically, referring briefly back to FIGS. 51 and 55, the brake spring 493* may be configured as a torque spring or similar spring configured to be installed over and around the spring tabs 411* to allow the brake spring 493* to apply a radially-inwardly directed, compressive force against the spring tabs 411*, thereby compressing the spring tabs 411* against the stub shaft 309* to create the frictional interface therebetween. The compressive force provided via the brake spring 493* (and the frictional interface resulting therefrom) may generally serve to maintain the tilt rail cap 401* (and, thus, the tilt rail 130* coupled thereto) at a given position when the operator releases the tilt wand 110*, thereby allowing the slats 56* to be maintained at the operator-selected tilt position.

Referring back to FIGS. 66 and 67, the tilt rail cap 401* may also include or define suitable features for allowing the rail cap 401* to be rotationally driven by the drive pulley 441* of the tilt drive assembly 170*. For example, as particularly shown in FIG. 67, the tilt rail cap 401* may include a gear or “gear portion” 415* positioned along the outer side 405* of the rail cap 401* that is centered about the tilt axis 102*. In general, the gear portion 415* of the tilt rail cap 401* is configured to mesh with the corresponding gear post 451* of the drive pulley 441* such that rotation of the drive pulley 441 about its separate pulley axis 443* results in the tilt rail cap 401* pivoting about the tilt axis 102*. To accommodate meshing of the gear portion 415* of the tilt rail cap 401* with the gear post 451* of the drive pulley 441*, the tilt rail cap 401* may also define a recessed gear cavity 417* along the outer side 505* of the rail cap 401* that receives the gear post 451* of the drive pulley 441*. As shown in FIG. 66, the gear cavity 417* generally forms a semi-circular slot centered about the tilt axis 102* and extending radially outwardly from the hear portion 415*, with a central radius 419* of the cavity 417* being equal to the spacing distance 445* (FIG. 55) defined between the tilt axis 102* and the separate pulley axis 442* of the drive pulley 441*. Thus, as the tilt rail cap 401* is pivoted relative to the drive pulley 441* about the tilt axis 102*, the relative positioning of the gear post 451* within the gear cavity 417* may vary along the arc length of the cavity 417*. For instance, with the tilt rail cap 401* disposed at the position shown in FIG. 56B (e.g., when the slats 56* are at the fully opened position), the gear post 451* of the drive pulley 441* may generally be positioned at the center of the gear cavity 417* along its arc length (e.g., as indicated by point 421* in FIG. 67). However, if the tilt rail cap 401* is pivoted about the tilt axis 102* from the position shown in FIG. 56B to the position shown in FIG. 56C (e.g., when the slats 56* are at the closed-down position), the gear post 451* of the drive pulley 441* may generally be positioned at a first end of the gear cavity 417* along its arc length (e.g., as indicated by point 423* in FIG. 67). Similarly, if the tilt rail cap 401* is pivoted about the tilt axis 102* from the position shown in FIG. 56B to the position shown in FIG. 56A (e.g., when the slats 56* are at the closed-up position), the gear post 451* of the drive pulley 441* may generally be positioned at an opposed second end of the gear cavity 417* along its arc length (e.g., as indicated by point 425* in FIG. 67). In this regard, it should be appreciated that the gear cavity 417* may also function to limit the extent to which the tilt rail cap 401* can be pivoted about the tilt axis 102*, with the opposed ends 423*, 425* of the gear cavity 417* serving as mechanical stops to prevent further pivoting of the tilt rail cap 401* as the gear post 451* contacts the adjacent wall of the rail cap 401*. In this regard, the arc length of the gear cavity 417* may generally define the angular pivot range about which the tilt rail cap 401* can be pivoted about the tilt axis 102*.

Moreover, referring particularly to FIG. 66, the tilt rail cap 401* may also include various structural walls or the like extending outwardly along the inner side 407* thereof for receiving portions of the drive end 132* (FIG. 43) of the tilt rail 130*. Specifically, as shown in FIG. 66, a pair of rail cavities (e.g., a front rail cavity 431* and a rear rail cavity 433*) are defined adjacent to the front and rear sides of the tilt rail cap 401* for receiving the front and rear edge walls 142*, 144* (FIG. 59) and adjacent inner sidewalls 158* (FIG. 50) of the tilt rail 130*, respectively, with the bottom wall 140* (FIG. 50) of the tilt rail 130* being configured to wrap around or extend adjacent to a correspondingly-shaped lower wall or surface 435* extending between the rail cavities 431*, 433*. Additionally, as shown in FIG. 66, the tilt rail cap 401* also includes a mounting tab 437* extending outwardly into each rail cavity 431*, 433*, with each mounting tab 437* being configured to be received with one of the respective mounting slots 162* (FIG. 50) of the tilt rail 130*. As such, with the drive end 132* of the tilt rail 130* installed relative to the tilt rail cap 401* such that the front and rear edge walls 142*, 144* and corresponding inner sidewalls 158* of the rail 130* are received within the respective rail cavities 431*, 433* (with the mounting tabs 437* extending within the adjacent mounting slots 162* of the tilt rail 130*) and the bottom curved wall 140* of the rail 130* wraps around the lower curved wall or surface 435* of the tilt rail cap 401*, the tilt rail 130* may be configured to rotate with the tilt rail cap 401* about the tilt axis 102*. Moreover, as shown in FIG. 66, the tilt rail cap 401* may also include additional mounting flanges 439* extending outwardly from the inner side 407* of the rail cap 401* for engaging a portion of the rail cover 131*. For instance, in one embodiment, the tilt rail cap 401* may include a pair of inner mounting flanges 439* configured to be engaged against and contact an inner surface of the upper curved wall 133* (FIG. 50) of the rail cover 131* when the rail/cover are installed relative to the tilt rail cap 401*.

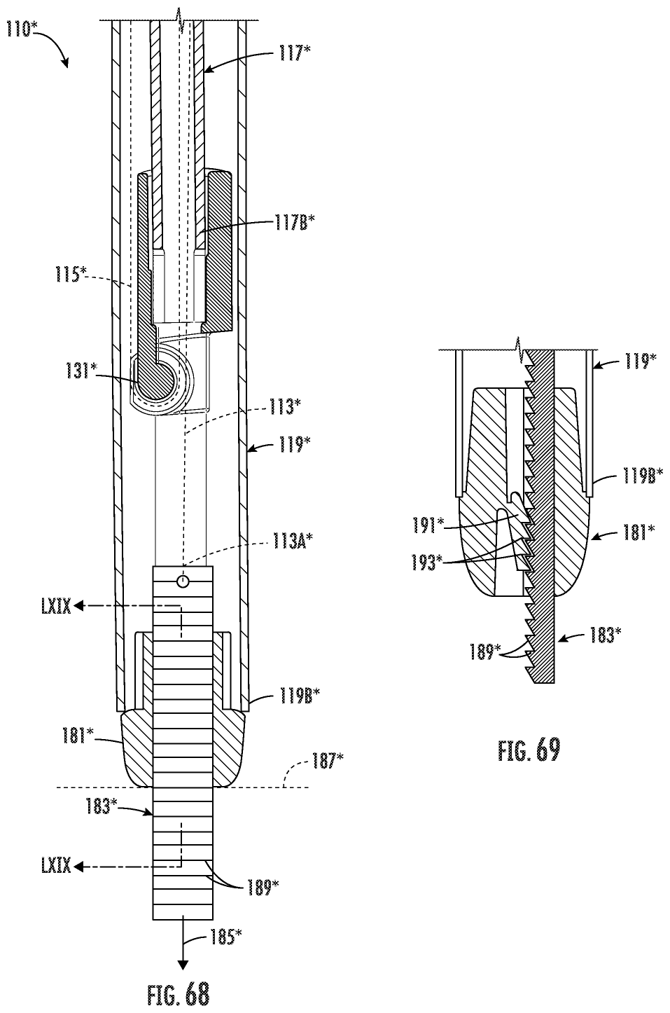

Referring now to FIG. 68, a partial cross-sectional view of another embodiment of the tilt wand described above is illustrated in accordance with aspects of the present subject matter. Specifically, FIG. 68 illustrates a similar cross-sectional view of the portion of the tilt wand contained within box LXVIII-LXVIII shown in FIG. 46, particularly illustrating alternative embodiment for coupling the first tilt cord to the second wand portion at or adjacent to its bottom end of the second wand portion. It should be appreciated that, unless described otherwise with reference to FIG. 68, the tilt wand is generally configured the same as that described above with reference to FIG. 46.

As described above with reference to the embodiment of the tilt wand 110* shown in FIG. 46, the end 113A* of the first tilt cord 113* is configured to be coupled directly to the bottom cap 127* of the tilt wand 110*. With this embodiment, the first and second wand portions 117*, 119* of the tilt wand 110* and the associated tilt cords 113*, 115* are configured to be pre-assembled together and subsequently coupled to the tilt drive assembly 170* (e.g., via the socket joint provided between the wand pivot member 125* and the wand socket 353* of the end plate assembly 301*). The “pre-tensioning” of the tilt cords 113*, 115* is then accomplished by properly tightening the cords 13*, 115* as they are being coupled to the drive pulley 441*. While such an embodiment has many advantages, this configuration requires numerous different “tilt wand pre-assemblies” to be stocked within the manufacturing environment when it is desirable to offer various different tilt wand sizes.

To address this issue, the embodiment of the tilt wand 110* shown in FIG. 68 allows for the first tilt cord 113* to be coupled to the second wand portion 119* and pre-tensioned as a final assembly step, thereby eliminating the need to stock numerous different “tilt wand pre-assemblies”. Specifically, as shown in FIG. 68, as opposed to coupling the end 113A* of the first tilt cord 113* directly to a bottom cap 181* of the tilt wand 110*, the end 113A* of the tilt cord 113 is configured to be coupled to an elongated connection strap 183* (e.g., a zip tie or cable tie), which can then be separately coupled to the second wand portion 119* via the associated bottom cap 181* upon assembly of such components relative to the first wand portion 117* of the tilt wand 110*. For example, during assembly, the first tilt cord 113* can be coupled to the drive pulley 441* as described above and routed through the end plate assembly 401*, the wand pivot member 125*, and the first wand portion 117* before being tied off to the elongated connection strap 183*. Thereafter, when installing the second wand portion 119* relative to the first wand portion 117*, the elongated connection strap 183* can be inserted through the second wand portion 119* as it is being slid onto the first wand portion 117*. The corresponding bottom cap 181* may then be slid up the connection strap 183* and secured onto the bottom end 119B* of the second wand portion 119*. Thereafter, the tilt system 100* may be pre-tensioned by pulling downward on the connection strap 183* (e.g., as indicated by arrow 185* in FIG. 68) to reduce the length of the connection strap 183* extending within the second wand portion 119* until the desired cord tension is achieved. As a final assembly step, the connection strap 325* may be cut or trimmed at the end of the bottom cap 181* (e.g., along cut line 187* shown in FIG. 68) to provide a clean, finished look.

It should be appreciated that, to allow connection strap 185* to be used to pre-tension the tilt system 100* in the manner described above, the bottom cap 181* of the tilt wand 110 may be configured to engage or lock against the connection strap 185* as it is pulled downwardly relative thereto, thereby preventing the connection strap 185* from being pulled back upwards into the tilt wand 110* due to the cord tension. For instance, when the connection strap 185* is configured similar to a zip tie or cable tie, the strap 185* may include a ridged surface or linear ratchet gear rack formed therein that includes a plurality of gear teeth or ridges 189*. In such an embodiment, the bottom cap 181* may be configured to include suitable engagement features for engaging or locking against the ridges 189* of the connection strap 185*, such as a pawl or ratchet mechanism. For example, FIG. 69 illustrates a cross-sectional view of the bottom end of the tilt wand 110 shown in FIG. 68 taken about line LXIX-LXIX. As shown, the bottom cap 181* includes a pawl 191* including counter or opposed ratchet teeth 193* configured to engage the gear teeth or ridges 189* of the connection strap 183*. Thus, as the connection strap 183* is pulled downwardly through the bottom cap 181* to pre-tension the first tilt cord 113*, the ratchet function provided by the pawl 191* may lock the connection strap 183* against upward movement relative to the bottom cap 181*.

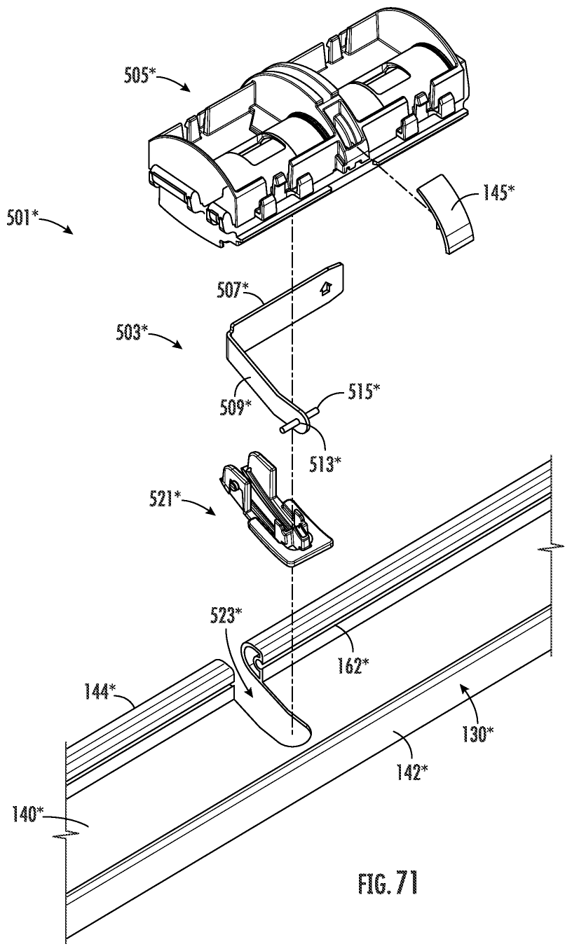

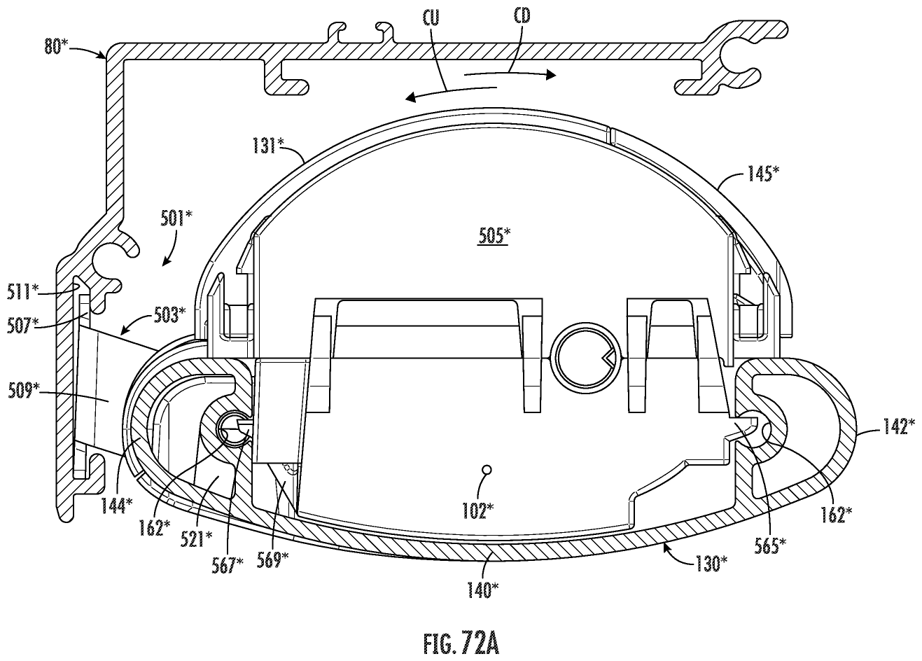

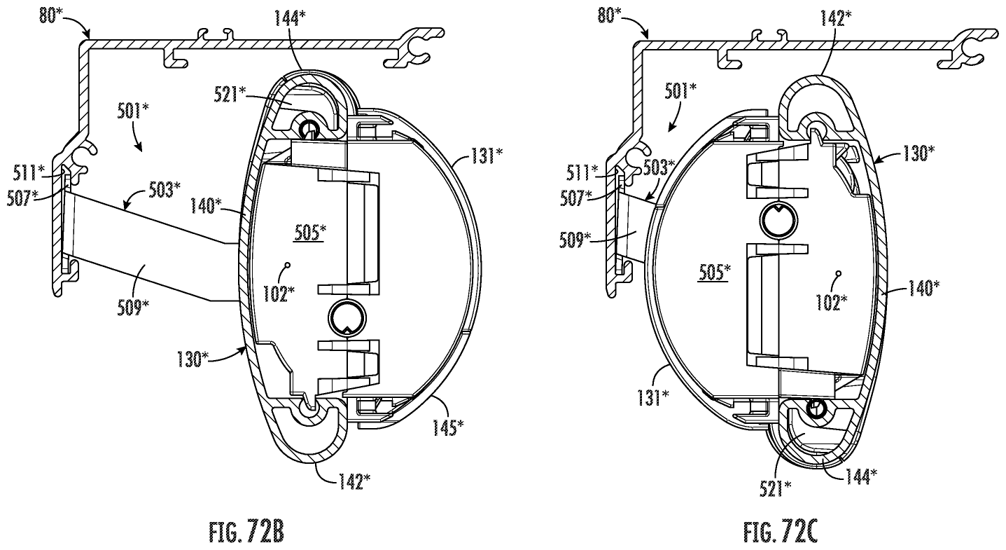

Referring now to FIGS. 70-72C, several views of one embodiment of a rail support assembly 501* suitable for use with the headrail assembly 52* described above are illustrated in accordance with aspects of the present subject matter. Specifically, FIG. 70 illustrates a perspective view of the rail support assembly 501* as assembled within a central portion of the tilt rail 130* of the tilt system 100* (e.g., the portion of the tilt rail included within box LXX shown in FIG. 48). FIG. 71 illustrates an exploded, perspective view of the rail support assembly 501* shown in FIG. 70, with the various components of the rail support assembly 501* exploded away from the tilt rail 130*. Additionally, FIGS. 72A-72C illustrate end views of the rail support assembly 501* and tilt rail 130* shown in FIG. 70 as installed relative to the mounting rail 80* of the headrail assembly 52*, particularly illustrating the tilt rail 130* and the various components supported therein at different positions relative to the mounting rail 80* and the rail support bracket 503* of the rail support assembly 501* as the tilt rail 130* is tilted about the tilt axis 102* to adjust the tilt position of the slats 56*. It should be appreciated that FIGS. 70 and 71 also illustrate the front cover extension 145* described above with reference to FIGS. 47-49, particularly illustrating the relative positioning of front cover extension 145* to the components of the rail support assembly 501*.

As indicated above, the rail support assembly 501* may generally be configured to provide vertical support for the tilt rail 130* relative to the mounting rail 80* at a location between the opposed ends of the rail 130* (e.g., at a centralized location of the tilt rail 130*). In this regard, as shown in FIGS. 71 and 72A-72C, the rail support assembly 501* may generally include a rail support bracket 503* configured to be coupled between the mounting rail 80* and the tilt rail 130*. As shown in FIG. 71, the rail support bracket 501* includes a first bracket arm or portion 507* and a second bracket arm or portion 509*. In general, the first bracket portion 507* of the rail support bracket 503* may be configured to be coupled to the mounting rail 80*. For instance, as shown in FIGS. 72A-72C, the first bracket arm 507* of the rail support bracket 503* may be configured to be slidably received within a corresponding mounting slot 511* defined by the mounting rail 80*, thereby providing a rigid coupling between the bracket 503* and the mounting rail 80*.

Additionally, the second bracket portion 509* of the rail support bracket 503* may generally be configured to be pivotably coupled to the tilt rail 130*. For instance, as particularly shown in FIG. 7′, the second bracket portion 509* defines a pin opening 513* configured to receive a pivot pin 515* of the rail support assembly 501*. For instance, in one embodiment, the pivot pin 515* may be configured to be pressed into the pin opening 13* with a friction or press-fit such that the pin 515* is rigidly and non-rotatably coupled to the rail support bracket 503*. In general, the pivot pin 515* may be configured to define a pivot point between the rail support bracket 503* and both a slot cap 521 (FIG. 71) and a lift station 505* of the rail support assembly 501*, with such additional components of the rail support assembly 501* providing a connection between the rail support bracket 503* (e.g., via the pin 515* coupled thereto) and the tilt rail 130*. For instance, as will be described below, the slot cap 521* and the lift station 505* may be configured to be installed within and coupled to the tilt rail 130* such that the pivot pin 515* is captured between such components, thereby allowing the pin 515* to provide a pivotable or pinned connection between the rail support bracket 503* and the tilt rail 130*.

As should be readily understood, the pivotable or pinned connection between the rail support bracket 503* and the tilt rail 130* allows the tilt rail 130* to be pivoted about the tilt axis 102* between its various different rail positions when tilting the slats 56*. Specifically, the pivot pin 515* of the rail support assembly 501* may be configured to be aligned with and extend coaxially along the tilt axis 102*, thereby allowing the support bracket 503* to vertically support the tilt rail 130* (and any components supported thereby) for rotation about the tilt axis 102*. For instance, FIG. 72A illustrates the tilt rail 130* and associated components of the rail support assembly 501* when the tilt rail 130* is at its substantially horizontal orientation (i.e., when the slats 56* are at the fully opened position e.g., the position shown in FIG. 41). As indicated above, to transition the slats 56* from the fully opened position to the closed-down position, the tilt rail 130* is rotated about the tilt axis 102* in the closed-down direction (indicated by arrow CD in FIG. 72A) from the substantially horizontal orientation shown in FIG. 72A to the substantially vertical orientation shown in FIG. 72B. Similarly, to transition the slats 56* from the fully opened position to the closed-up position, the tilt rail 130* is rotated about the tilt axis 102* in the closed-up direction (indicated by arrow CU in FIG. 72A) from the substantially horizontal orientation shown in FIG. 72A to the substantially vertical orientation shown in FIG. 72C. As shown in the transition between FIG. 72A and FIG. 72B and the transition between FIG. 72A and FIG. 72C, the tilt rail 130* (along with the slot cap 521* and lift station 505* supported therein) pivot about the pinned connection provided at the tilt axis 102* relative to both the rail support bracket 503* and the mounting rail 80*.

It should be appreciated that, to accommodate such pivoting of the tilt rail 130* relative to the rail support bracket 503*, the tilt rail 130*, along with the other components of the rail support assembly 501*, may be configured to define elongated slots or other features within which the second bracket portion 509* of the rail support bracket 503* is received as the tilt rail 102* is being pivoted about the tilt axis 102* across the pivot range shown in FIGS. 72A-72C. For instance, as particularly shown in FIG. 71, the tilt rail 130* defines a rail slot 523* through which the rail support bracket 503* is configured to extend as the tilt rail 130* is being pivoted about the tilt axis 102* across of range of rail positions. Additionally, as will be described below, the slot cap 521* and the lift station 505* may also define complementary slots or other features for receiving the rail support bracket 503*. As indicated above, tilt rail cover 131* may also define a slot (e.g., between the separate cover portions 131A*, 131B*) for receiving the rail support bracket 503*.

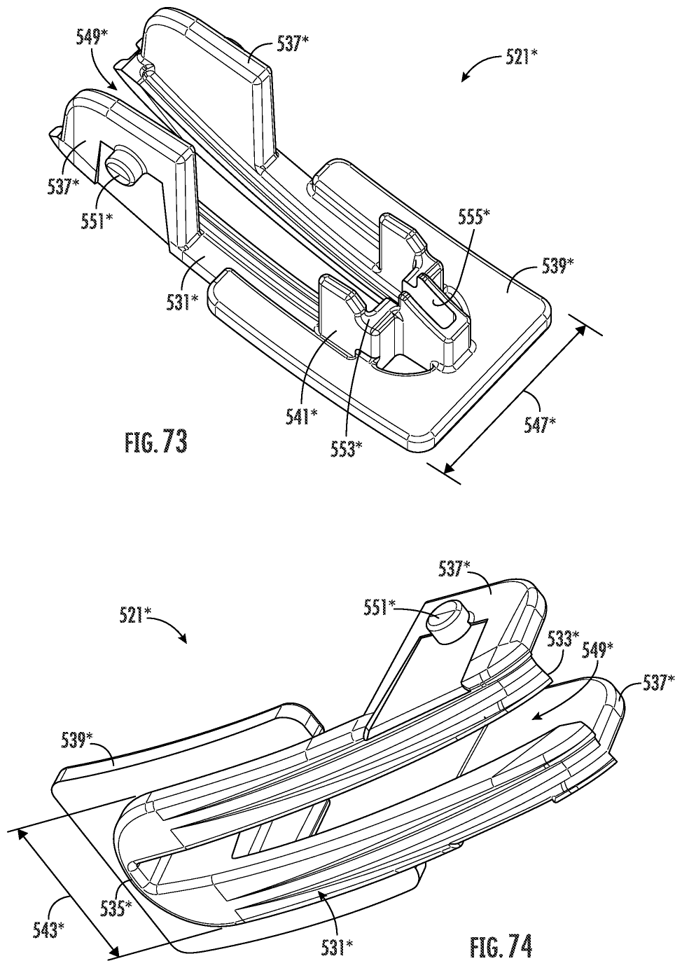

The various components and sub-assemblies of the rail support assembly 501* noted above will now be described in further detail with reference to FIGS. 73-83.

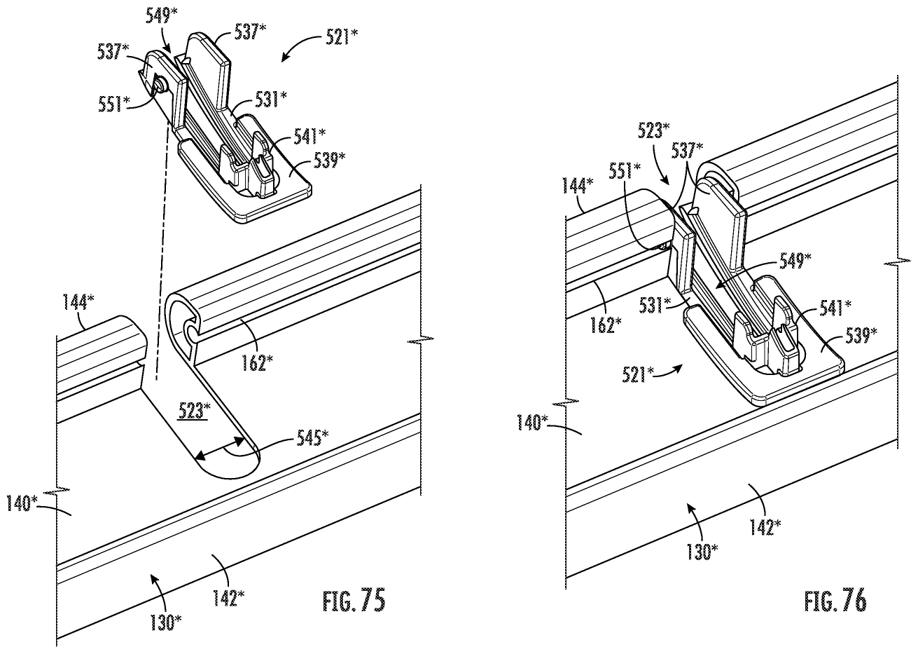

Referring now to FIGS. 73-76, several views of the slot cap 521* of the rail support assembly 501* are illustrated in accordance with aspects of the present subject matter. Specifically, FIGS. 73 and 74 illustrate opposed, top and bottom perspective views, respectively, of the slot cap 521*. Additionally, FIGS. 75 and 76 illustrate exploded and assembled perspective views, respectively, of the slot cap 521* relative to the tilt rail 130*.

As particularly shown in FIGS. 73 and 74, the slot cap 521* generally includes a lower slot wall 531* extending between a first end 533* (FIG. 74) and a second end 535* (FIG. 74), a pair of opposed, vertically oriented mounting tabs 537* extending outwardly from the slot wall 531* adjacent to its first end 533*, and an enlarged, horizontally oriented mounting flange 539* extending outwardly from the slot wall 531* in a raised configuration relative to its second end 535*. Additionally, the slot cap 521* also includes a pin carriage 541* extending upwardly from the slot wall 531* adjacent to its second end 535*.

In general, the lower slot wall 531* of the slot cap 521* may be configured to define a shape or profile that matches the shape or profile of the elongated rail slot 523* defined in the tilt rail 130*, thereby allowing the slot wall 521* to be received within the rail slot 523* when the slot cap 521* is installed relative to the tilt rail 130*. For instance, as shown in FIG. 74, the second end 535* of the slot wall 531* may be rounded to match the rounded end of the rail slot 523* defined in the tilt rail 130*. The slot wall 531* may also generally define a curved profile between its first and second ends 533*, 535* that is configured to substantially match the curved profile of the bottom wall 140* of the tilt rail 130* (e.g., see FIG. 10 for the curved profile of the bottom wall 140* of the tilt rail 130*). Moreover, as shown in FIG. 74, a width 543* of the slot wall 531* may generally be selected based on a corresponding width 545* of the rail slot 523* to allow the slot wall 531* to be received with the slot 523*, such as by configuring the slot wall 531* to define a width 543* that is slightly smaller than the width 545* of the rail slot 523*. In contrast, the enlarged mounting flange 539* of the slot cap 521* may generally be configured to define a width 547* (FIG. 73) that is larger than the width 545* of the rail slot 523*, thereby allowing the mounting flange 539* to vertically support the slot cap 521* relative to the bottom wall 140* of the tilt rail 130*. As such, when the slot cap 521* is installed relative to the tilt rail 130*, the lower slot wall 531* generally extends within the rail slot 523* and matches the profile of the portion of the bottom wall 140* of the tilt rail 130* extending along such rail slot 523* while the elongated mounting flange 539* is seated flush against and engages the adjacent surface of the bottom wall 140* of the tilt rail 130*.

Additionally, as shown in the illustrated embodiment, the slot wall 521* may also define a cap slot 549* extending between the opposed first and second ends 533*, 535* of the slot wall 521* that is generally aligned with the rail slot 523* when the slot cap 521* is installed relative to the tilt rail 130*. Such aligned slots 523*, 549* are generally configured to accommodate the rail support bracket 503* as the tilt rail 102* is being pivoted about the tilt axis 102* relative to the bracket 503*. For instance, referring briefly to FIGS. 72A and 72B, as the tilt rail 130* is tilted about the tilt axis 102* to transition the slats 56* from the fully opened position (e.g., at the rail position shown in FIG. 72A) to the closed-down position (e.g., at the rail position shown in FIG. 72B), the rail support bracket 503* may be received within the aligned slots 523*, 549*.

Referring back to FIGS. 73-76, the pair of vertically oriented mounting tabs 537* of the slot cap 521* may generally be configured to provide an additional coupling or connection between the slot cap 521* and the tilt rail 103* at the adjacent edge wall (e.g., rear edge wall 144*) of the tilt rail 130*. Specifically, as shown in FIGS. 73 and 74, each mounting tab 537* may be configured to extend vertically upwardly from the lower slot wall 531* and may include a tab projection 551* extending outwardly therefrom. In such an embodiment, each tab projection 551* may be configured to be received within the adjacent mounting slot 162* of the tilt rail 130* along either side of the rail slot 523*. For instance, as shown in FIG. 76, when the slot cap 521* is installed relative to the tilt rail 130*, the vertically oriented mounting tabs 537* may be seated flush against the adjacent radiused edge wall 144* of the tilt rail 130* along either side of the rail slot 523*, with the tab projections 551* extending outwardly from the mounting tabs 537* into the corresponding mounting slot 162* of the tilt rail 130*.

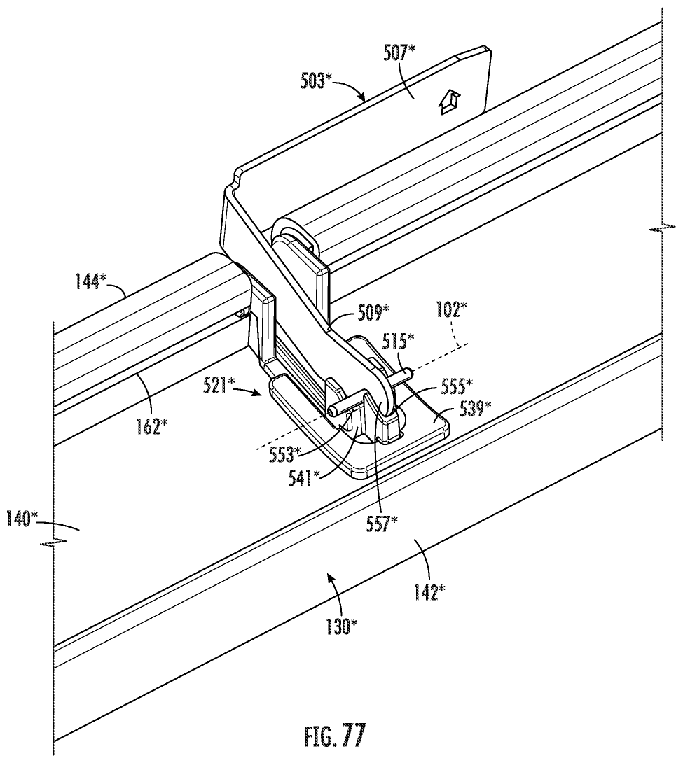

As indicated above, the slot cap 521 may also include a pin carriage 541* extending upwardly from the lower slot wall 531* adjacent to the second end 535* of the wall 531*. In general, the pin carriage 541* may be configured to define suitable features for receiving the pivot pin 515* of the rail support assembly 501* in a manner that allows the slot cap 521* (along with the tilt rail 130* and any other components supported by the tilt rail 130*) to rotate relative to the pivot pin 515* (and rail support bracket 503*) about the tilt axis 102*. For instance, as particularly shown in FIG. 73, the pin carriage 541* may define a recessed area or pin slot 553* within which the pivot pin 515* is configured to be received, with the pin slot 553* defining a bearing surface about which the slot cap 521* pivots relative to the pivot pin 515* about the tilt axis 102*. Additionally, as shown in FIG. 73, the pin carriage 541* may also define a bracket slot 555* extending perpendicular to the pin slot 553* for receiving a portion of the second bracket portion 509* extending outwardly beyond the pivot pin 515*. For example, FIG. 77 illustrates a perspective view of the slot cap 521* and rail support bracket 503* (along with the associated pivot pin 515*) assembled relative to the tilt rail 130*. As shown in FIG. 77, the pivot pin 515* is nested or received within the pin slot 553* of the pin carriage 541* while a distal portion 557* of the second bracket portion 509* of the support bracket 503* is received within the bracket slot 555* of the pin carriage 541*, thereby allowing the slot cap 521* (and tilt rail 130* coupled thereto) to pivot relative to the pivot pin 515* and the support bracket 503* about the tilt axis 102*.

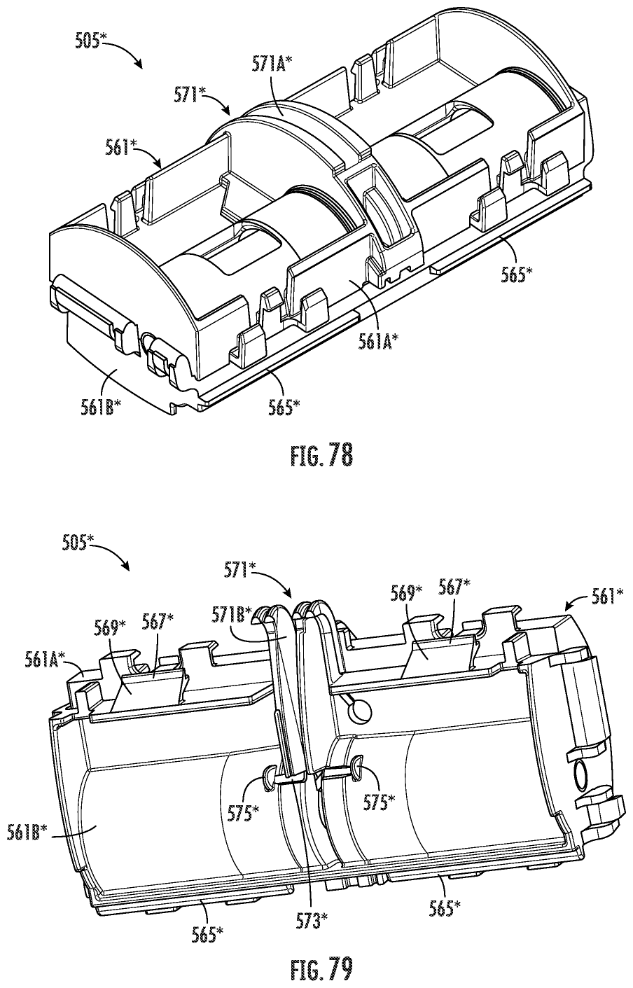

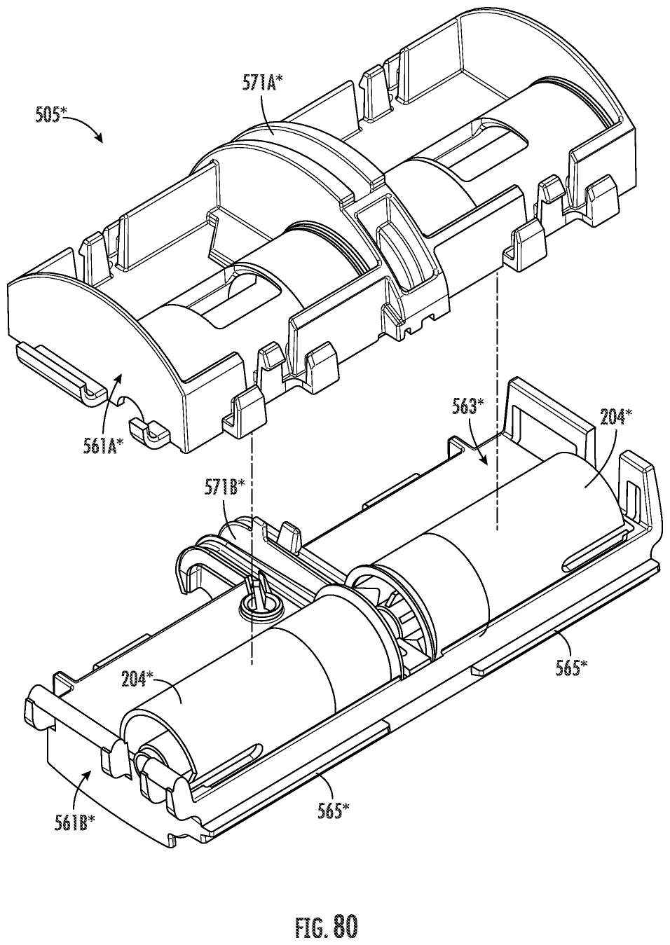

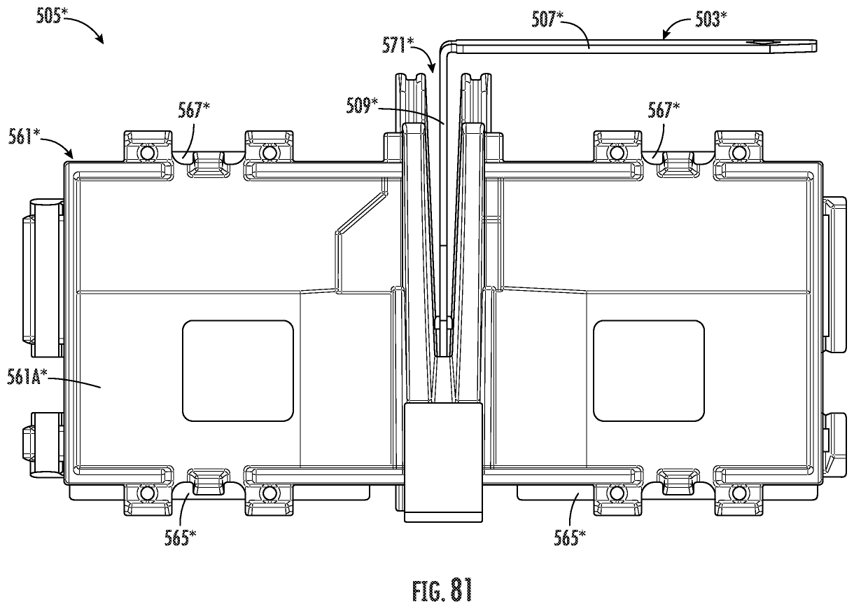

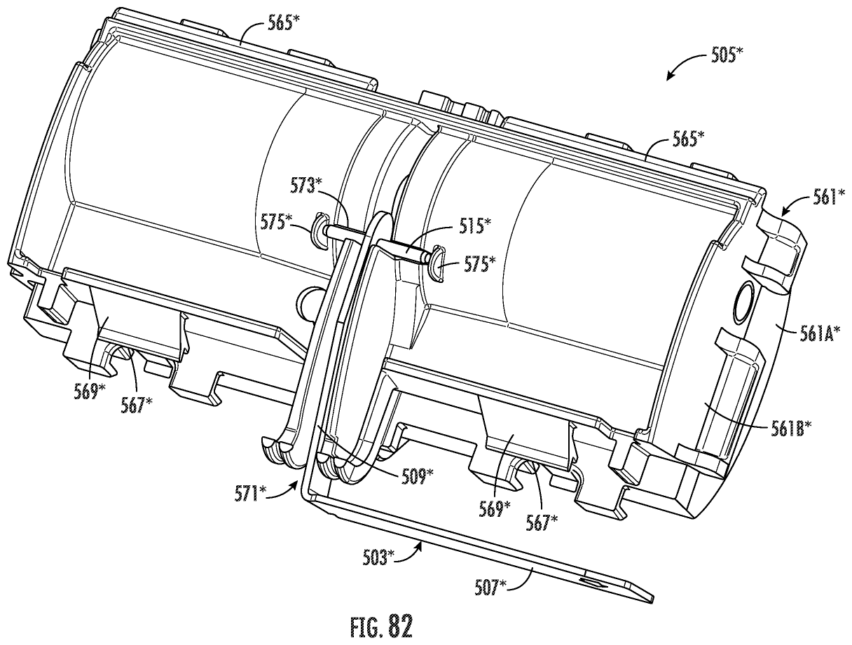

Referring now to FIGS. 78-82, various views of one embodiment of a lift station 505* suitable for use within the disclosed rail support assembly 501* are illustrated in accordance with aspects of the present subject matter. Specifically, FIGS. 78 and 79 illustrate top and bottom perspective views, respectively, of the lift station 505*. FIG. 80 illustrates a similar perspective view of the lift station 505* as that shown in FIG. 78, particularly illustrating an upper or first housing component of the lift station 505* exploded away from the remainder thereof. Additionally, FIG. 81 illustrates a top view of the lift station 505* while FIG. 82 illustrates another bottom perspective view of the lift station 505*, with both FIGS. 81 and 82 showing the lift station 505* assembled relative to the rail support bracket 503* and the associated pivot pin 515* of the rail support assembly 501*.

As indicated above, in addition to the rail support functionality associated with the rail support assembly 501*, the lift station 505* may also be configured to function as a typical lift station and, thus, may include various components and/or features of a conventional lift station. For instance, as particularly shown in FIGS. 78-80, the lift station 505* may generally include a housing 561* configured to encase a pair of lift spools 204*. As particularly shown in FIG. 80, the housing 561* may be substantially hollow so as to define a spool cavity 563* for accommodating the lift spools 204*. As indicated above, the lift spools 204* may generally be configured to be coupled to the motor 210* of the lift system 200* via the associated lift rod 208* to allow the motor 210* to rotationally drive the lift spools 204* when raising the bottom rail assembly 54* relative to the headrail assembly 52*. Additionally, the housing 561* may be configured to define various features (e.g., cord openings or slots, cord routings, tie-off points, etc.) for accommodating the associated cords of the lift/tilt system. For example, suitable cord openings and/or slots (not shown) may be defined by the housing 561* through which the lift cords 64*, 66* extend as the cords 64*, 66* are wound around and unwound from the lift spools 204* during raising and lowering of the bottom rail assembly 54* relative to the headrail assembly 52*. Similarly, in one embodiment, the housing 561* may define suitable key-holes or tie-off points (not shown) for coupling the ends of the ladder runs 60*, 62* of the adjacent ladder tape assembly 58* to the lift station 505*.

In several embodiments, the housing 561* may be configured as a multi-piece construction, such as a two-part assembly. For instance, as shown in FIG. 80, the lift station 505* may include an upper or first housing component 561A and a lower or second housing component 561B configured to be coupled to each other to form the complete housing 561*. In such an embodiment, when the first and second housing components 561A*, 561B* are coupled together, the housing components 561A*, 561B* may collectively define the spool cavity 563* of the housing 561*, and, thus, may be configured to encase the lift spools 204*. In general, the housing components 561A*, 561B* may be configured to be coupled to each other using any suitable attachment structure and/or means. For instance, in one embodiment, one or both of the housing components 561A*, 561B* may include or define suitable features for allowing the other housing component to be snapped onto or otherwise secured thereto. In other embodiments, the housing components 561A*, 561B* may include any other suitable attachment structure and/or the lift station 505* may be configured to include any other suitable components for coupling the housing components 561A*, 561B* to each other (e.g., by using suitable mechanical fasteners).

The housing 561* may also be configured to accommodate or include suitable features for coupling or securing the lift station 505* within the tilt rail 13o*. For instance, as particularly shown in FIGS. 78 and 80-82, one or more front mounting tabs (e.g., a pair of mounting tabs 565*) may extend outwardly from the second housing component 561B* along a front or forward side of the lift station 505*. Additionally, as particularly shown in FIGS. 79 and 82, one or more rear mounting tabs (e.g., a pair of mounting tabs 567*) may be positioned relative to the second housing component 561B* along a rear or aft side of the lift station 505*. In one embodiment, the rear mounting tabs 567* may be provided on or form part of resilient or flexible spring arms 569* extending outwardly from the second housing component 561B* along the rear side of the lift station 505*. In such an embodiment, the spring arms 569* may be configured to apply a biasing force that maintains the lift station 505* in position relative to the tilt rail 130*. For instance, referring briefly to the end view of FIG. 72A, when installing the lift station 505* relative to the tilt rail 130*, the lift station 505* may be configured to be slid into tilt rail 130* longitudinally such that the front mounting tabs 565* are received within the mounting slot 162* defined adjacent to the forward edge wall 142* of the tilt rail 130* and the rear mounting tabs 567* are received within the mounting slot 162* defined adjacent to the rear edge wall 144* of the tilt rail 130*. In this installed configuration, the spring arms 569* may be in a compressed state so as to apply a crosswise biasing force that maintains the mounting tabs 565*, 567* within the mounting slots 162*.

Referring back to FIGS. 78-82, in accordance with aspects of the present subject matter, the lift station 505* may also be configured to incorporate suitable features for accommodating one or more of the other components of the rail support assembly 501*. For instance, in several embodiments, the housing 561* may be configured to define a housing slot 571* within which the rail support bracket 503* extends as the tilt rail 130* (and lift station 505*) are tilted relative thereto about the tilt axis 102*. For instance, as particularly shown in FIGS. 78-80, the first housing component 561A* may be configured to define a first slot portion 571A* while the second housing component 561B* may be defined define a second slot portion 571B*. In one embodiment, each slot portion 571A*, 571B* may generally be configured to accommodate approximately 90 degrees of relative rotational travel between the lift station 505* and the rail support bracket 503*. As such, the slot portions 571A*, 571B* may collectively define or form a housing slot 571* that accommodates approximately 180 degrees of relative rotational travel between the lift station 505* and the rail support bracket 503* as the tilt rail 130* is pivoted about the tilt axis 102* between the position shown in FIG. 72B (i.e., when the slats 56* are in the closed-down position) and the position shown in FIG. 72C (i.e., when the slats 56* are in the closed-up position). For instance, FIG. 81 illustrates the rail support bracket 503* extending within the approximately 180 degree housing slot 571* defined by the lift station housing 561*.

Moreover, similar to the slot cap 521* described above, the lift station 505* may also include or define suitable features for receiving the pivot pin 515* in a manner that allows the lift station 505* (along with the tilt rail 130* and any other components supported by the tilt rail 130*) to rotate relative to the pivot pin 515* (and rail support bracket 503*) about the tilt axis 102*. For instance, as particularly shown in FIG. 79, the second housing component 561B may define a recessed area or pin slot 573* along the bottom side of the housing 561* within which the pivot pin 515* is configured to be received, with the pin slot 573* defining a bearing surface about which the lift station 505* pivots relative to the pivot pin 515* about the tilt axis 102*. Additionally, as shown in FIG. 79, a pair of stop tabs 575* are provided at the opposed axial ends of the pin slot 573* that function as mechanical stops to axially retain the pivot pin 515* within the pin slot 573*. For example, as shown in FIG. 82, when the rail support bracket 503* and associated pivot pin 515* are installed relative to the lift station 505*, the pivot pin 515* is nested or received within the pin slot 573* of the lift station 505* and extends axially along the slot 573* between the opposed pair of stop tabs 575*.

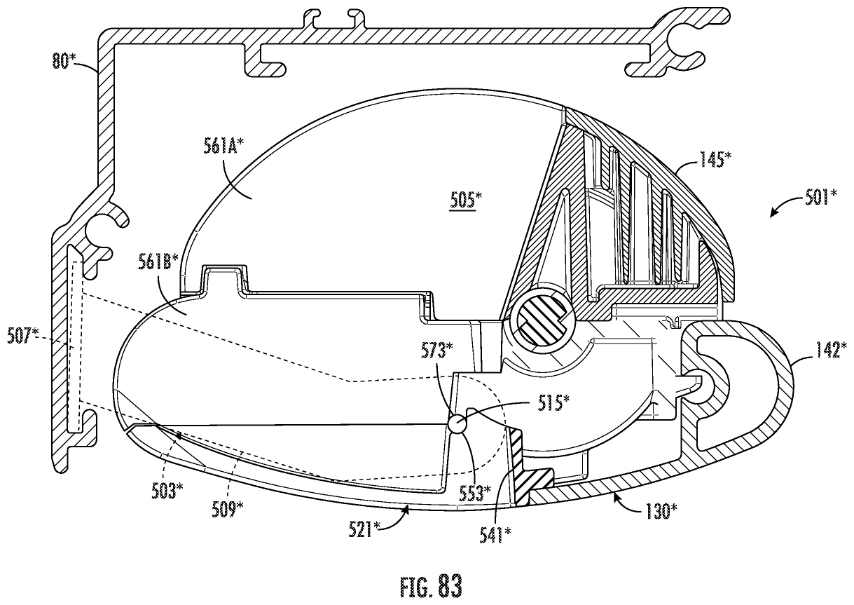

Accordingly, by configuring the rail support assembly 501* in the manner described above, the rail support bracket 503* may be configured to provide vertical support for the tilt rail 130* (and any components supported thereby) via the pinned connection provided by the slot cap 521* and the lift station 505*. For instance, FIG. 83 illustrates a cross-sectional view of the tilt rail 130* and rail support assembly 501* shown in FIG. 70 taken about line LXXXIII-LXXXIII, with the rail support bracket 503* being shown as transparent (e.g., in dashed lines) and the mounting rail 80* being added for purposes of illustration. As shown in FIG. 83, when the various components of the rail support assembly 501* are assembled together, the pivot pin 515* is captured or trapped directly between the slot cap 521* and the lift station 505*, namely between the pin slot 553* of the slot cap 521* and the pin slot 573* of the lift station 505*, thereby providing a structural connection between the rail support bracket 503* and the tilt rail 130*. Moreover, as indicated above, the pin slots 553*, 573* of the slot cap 521* and lift station 505* generally define bearing surfaces that contact the pivot pin 515* to provide a low-friction interface around which such components are configured to rotate relative to the pivot pin 515* about the tilt axis 102*. Thus, as the tilt rail 130* is being pivoted about the tilt axis 102*, the slot cap 521* and lift station 505* may pivot with the tilt rail 130* about the pivot pin 515*.

It should be appreciated that, in the embodiment of the rail support assembly 501* described above, the assembly 501* is positioned relative to the headrail assembly 52* so as to incorporate the central lift station 505* of the lift system 200* as a component thereof. However, in embodiments in which the lift system 200* includes four or more lift stations (e.g., for a wider covering 50*), a rail support assembly 501* may be provided in association with each of the inner central lift stations. For instance, in an embodiment including four lift stations, the lift system 200* may include two conventional lift stations 202* positioned closer to the outer lateral ends of the tilt rail 130* and two lift stations 505* spaced apart from one another along the lift rod 208* between the lift stations 202*. In such an embodiment, the headrail assembly may incorporate two rail support assembles 501* (i.e., one in association with each lift station 505*) to allow the tilt rail 130* to be supported at two different locations between its opposed lateral ends.

It should also be appreciated that, although the rail support assembly 501* describe above incorporates a dual-function lift station 505* as a component thereof, the assembly 501* may, in alternative embodiments, incorporate a replacement component for the lift station 505*. Specifically, as an alternative to the lift station 505*, a dedicated support component may be installed within the tilt rail 130* in a manner similar to the lift station 505* such that the pivot pin 515* is captured between the support component and a separate component of the rail support assembly 501*, such as the slot cap 521* or any other suitable component of the rail support assembly 501*. For instance, the support component may be configured as a small frame or armature that is configured to be mounted within the tilt rail 130* (e.g., using mounting tabs received within the mounting slots 162* of the tilt rail 130*) and that defines a pin slot for receiving the pivot pin 515*. Additionally, similar to the lift station 505*, the support component may define an elongated slot with which the rail support bracket 503* extends as the tilt rail 130* is being pivoted about the tilt axis 102*. In such an embodiment, unlike embodiments using the lift station 505*, the rail support assembly 501* may be positioned at any suitable location along the axial length of the tilt rail 130* (as opposed to being limited to axial locations aligned with the locations of the lift cords 64*, 66*).

Similarly, it should be appreciated that, in other embodiments, the slot cap 521* may be replaced with any other suitable support component configured to generally function to provide a pivotable coupling between the tilt rail 102* and the pivot pin 515*.

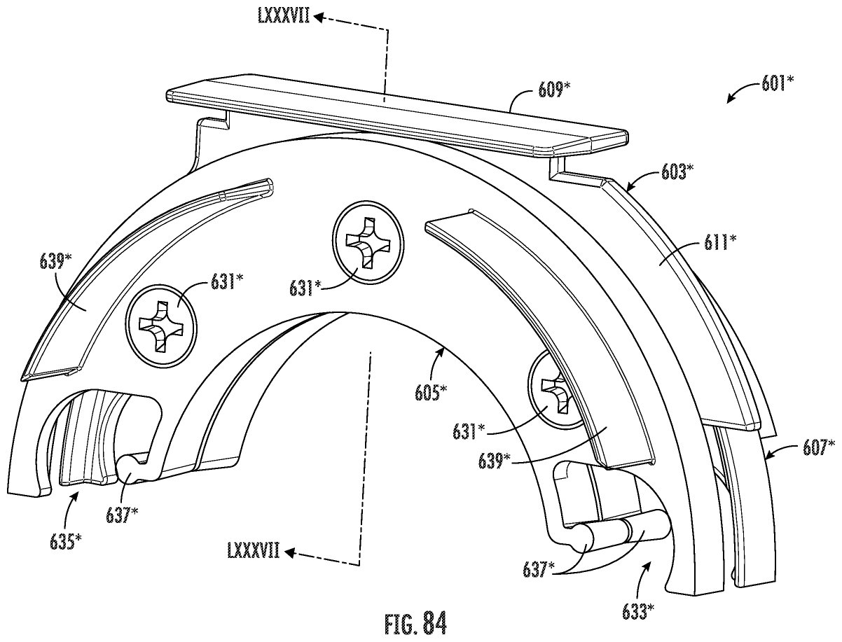

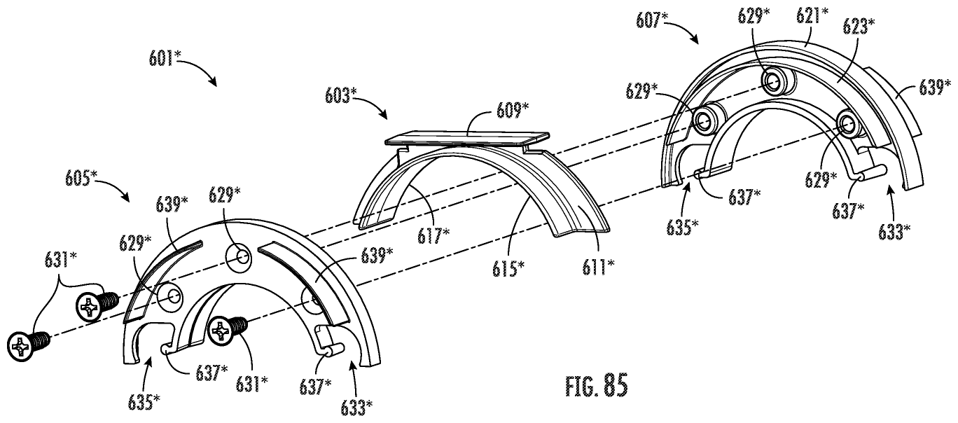

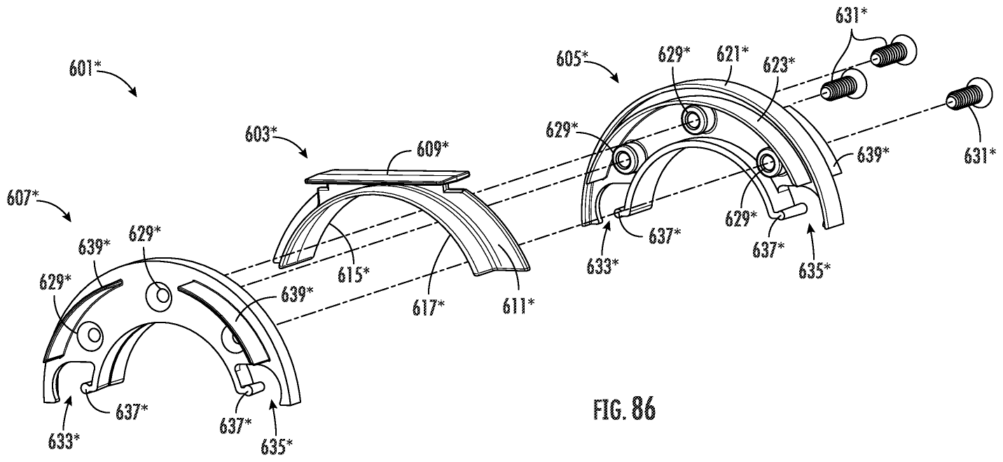

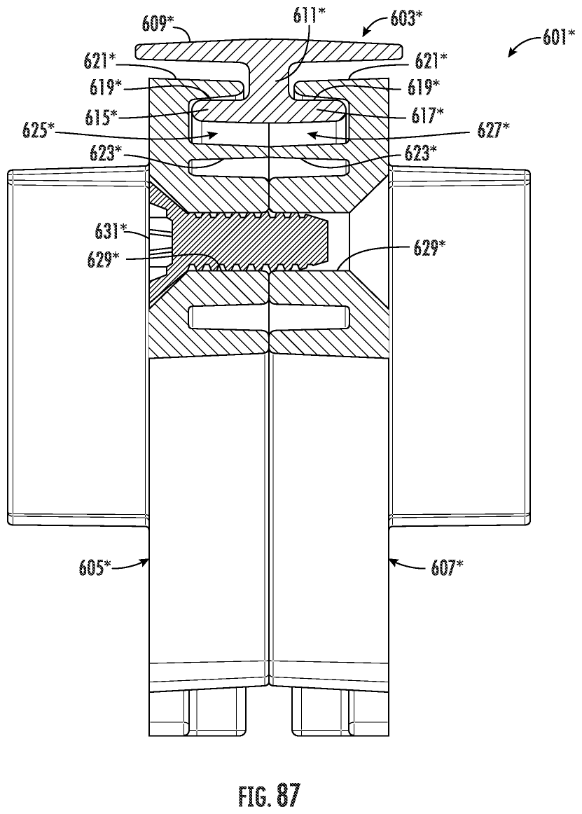

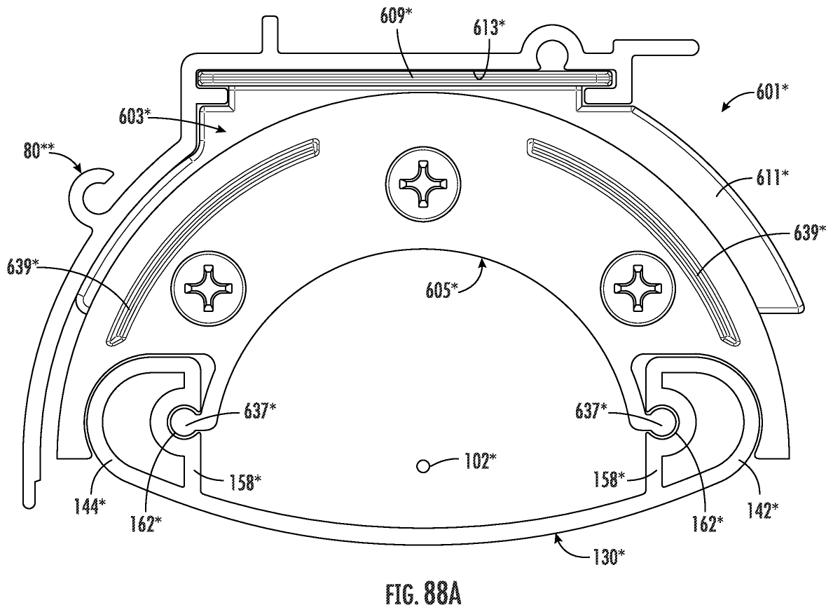

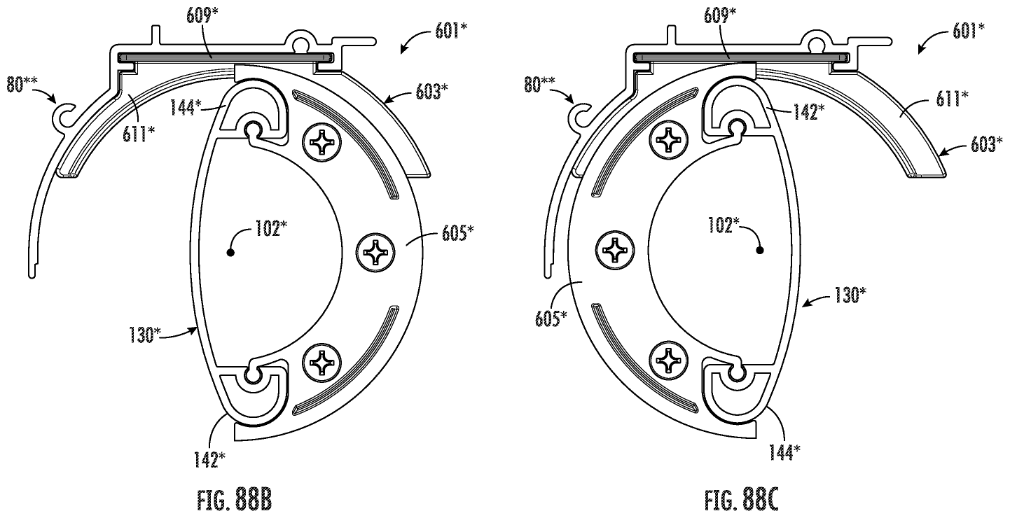

Referring now to FIGS. 84-88C, various views of another embodiment of a rail support assembly 601* suitable for use as an alternative to the rail support assembly 501* described above are illustrated in accordance with aspects of the present subject matter. Specifically, FIG. 84 illustrates a perspective view of the rail support assembly 601* and FIGS. 85 and 86 illustrated opposed, exploded perspective views of the rail support assembly 601* shown in FIG. 84. FIG. 87 illustrates a cross-sectional view of the rail support assembly 601* shown in FIG. 84 taken about line LXXXVII-LXXXVII. Additionally, FIGS. 88A-88C illustrate end views of the rail support assembly 601* as installed relative to the tilt rail 130* and an embodiment of a suitable mounting rail 80** configured for use with the disclosed headrail assembly 52*, particularly illustrating the tilt rail 130* at different positions relative to the mounting rail 80** as the tilt rail 130* is pivoted about the tilt axis 102* to adjust the tilt position of the slats 56*.

Similar to the embodiment described above, the rail support assembly 601* may generally be configured to provide vertical support for the tilt rail 130* relative to a mounting rail of an associated headrail assembly (e.g., mounting rail 80** (FIGS. 88A-8C) configured for use with headrail assembly 52*) at a location between the opposed ends of the rail 130* while still accommodating pivoting of the tilt rail 130* relative to the mounting rail 80** about this tilt axis 102*. In this regard, as shown in the illustrated embodiment, the rail support assembly 601* may generally include a rail support bracket 603* and first and second rail slides 607*, 609* configured to be slidably coupled to the rail support bracket 603*.

As shown in FIGS. 85-87, the rail support bracket 603* includes a first bracket portion or upper mounting arm 609* and a second bracket portion or lower slide arm 611* extending outwardly relative to the upper mounting arm 609* along a curved or arcuate path. In general, the upper mounting arm 609* may be configured to be coupled to the mounting rail 80*. For instance, as shown in FIGS. 88A-88C, the upper mounting arm 609* of the rail support bracket 603* may be configured to be slidably received within a corresponding mounting slot 613* defined by the mounting rail 88**, thereby providing a rigid coupling between the bracket 603* and the mounting rail 88**. Additionally, the arcuate slide arm 611* of the support bracket 603* may generally include opposed slide tabs 615*, 617* configured to vertically support the rail slides 605*, 607* of the rail support assembly 601* relative to the mounting rail 80**. Specifically, as shown in FIGS. 85-87, the slide arm 611* may include a first slide tab 615* configured to engage with the first rail slide 605* and a second slide tab 617* configured to engage with the second rail slide 607*, with both slide tabs 615*, 617* generally defining an upper bearing surface 619* (FIG. 87) about which the rail slides 605*, 607* are configured to slide as the tilt rail 130* is being pivoted about the tilt axis 102*.

As particularly shown in FIGS. 84-87, the first and second rail slides 605*, 607* may, in several embodiments, have a mirrored configuration and, thus, may each slide 605*, 607* define or include the same features but mirrored relative to the other slide. In general, each rail slide 605*, 607* may be configured to be coupled between the rail support bracket 603* and the tilt rail 130* such that the rail slides 605*, 607* support the tilt rail 130* for pivoting about the tilt axis 102* relative to the rail support bracket 603*. Specifically, in the illustrated embodiment, each rail slide 605*, 607* includes upper and lower arcuate walls 621*, 623* that define an arcuate slide channel along the inner face of the slide 605*, 607* for receiving a respective slide tab 615*, 617* of the rail support bracket 603*. For example, as shown in FIGS. 86 and 87, the first rail slide 605* includes upper and lower arcuate walls 621*, 623* defining a first slide channel 625* (FIG. 87) along its inner side for receiving the first slide tab 615*. Similarly, as shown in FIGS. 85 and 87, the second rail slide 607* includes upper and lower arcuate walls 621*, 623* defining a second slide channel 627* (FIG. 87) along its inner side for receiving the second slide tab 617*. As such, when the first and second rail slides 605*, 603* are assembled relative to the slide arm 611* of the rail support bracket 603* in the manner shown in FIGS. 84 and 87 (e.g., along either side of the slide arm 611*), each slide tab 615*, 617* of the rail support bracket 603* may extend into and be received within the respective slide channel 625*, 627* of the adjacent rail slide 605*, 607* to provide a sliding interface between the rail slides 605*, 607* and the mounting bracket 603*. In particular, as shown in FIG. 87, with the slide tabs 615*, 517* received within the slide channels 625*, 627*, the upper arcuate walls 621* of the rail slides 605*, 607* may be configured to rest upon and contact the bearing surfaces 619* defined by the respective slide tabs 615*, 617*, thereby allowing the rail slides 605*, 607* to slide across the slide tabs 615*, 617* along the arcuate path defined thereby as tilt rail 130* is being pivoted about the tilt axis 102*. Additionally, as shown in FIGS. 85-87, each rail slide 605*, 607* defines a set of fastener openings 629* configured to be aligned with the corresponding set of fastener openings 629* of the other rail slide, thereby allowing suitable fasteners 631* to be inserted through the aligned fastener openings 629* to couple the rail slides 605*, 607* together. In doing so, the rail slides 605*, 607* may generally be clamped together along either side of the slide arm 611* of the rail support bracket 603*, thereby maintaining the slide tabs 615*, 617* captured within the slide channels 625*, 627* of the rail slides 605*, 607*.

It should be appreciated that the radius of curvature of the arcuated-shaped features (e.g., walls, tabs, channels) of the rail support bracket 503* and rail slides 605*, 607* described above may generally be centered about the tilt axis 102* of the tilt system 100*, thereby preventing binding along the sliding interface defined between such features during rotation of the tilt rail 130* about the tilt axis 102*.

In several embodiments, each rail slide 605*, 607* may also include or define rail mounting features for coupling the tilt rail 130* (and associated rail cover 131*) to the slides 605*, 607*. For instance, as shown in FIGS. 84-87, each rail slide 605*, 607* defines a pair of rail cavities (e.g., a front rail cavity 633* and a rear rail cavity 635*) adjacent to the front and rear sides of the slide 605*, 607* for receiving the front and rear edge walls 42*, 44* (FIG. 88A) and adjacent sidewalls 158* (FIG. 88A) of the tilt rail 130*, respectively. Additionally, each rail slide 605*, 607* includes a mounting tab 637* extending outwardly into each rail cavity 633*, 635*, with each mounting tab 637* configured to be received with one of the respective mounting slots 162* (FIG. 88A) of the tilt rail 130*. Thus, as particularly shown in FIG. 88A, with the rail support assembly 601* assembled relative to the tilt rail 130, the front and rear edge walls 142*, 144* and corresponding sidewalls 158* of the rail 130* are received within the respective aligned rail cavities 633*, 635* (FIGS. 84-87) of the rail slides 605*, 607* (with the aligned mounting tabs 637* extending within the adjacent mounting slots 162* of the rail 130*). Moreover, as shown in FIGS. 84-87, the rail slides 605*, 607* may also include additional mounting flanges 639* extending outwardly from the outer sides thereof for engaging a portion of the rail cover 131*. For instance, in one embodiment, each rail slide 605*, 607* may include a pair of mounting flanges 639* configured to be engaged against and contact an inner surface of the upper curved wall 133* (FIG. 50) of the rail cover 131* when the rail/cover are installed relative to the rail support assembly 601*.

By configuring the rail support assembly 601* as described above, the tilt rail 130* may be vertically supported by the rail support bracket 603* (e.g., via the connection provided by the rail slides 605*, 607*) in a manner that allows the tilt rail 130* (any components supported thereby) to be freely pivoted about the tilt axis 102*. Specifically, the sliding interface provided between the rail support bracket 603* and the rail slides 605*, 607* allows the tilt rail 130* to be pivoted about the tilt axis 102* between its various rail positions when tilting the slats 56*. For instance, FIG. 88A illustrates the tilt rail 130* and associated components of the rail support assembly 601* when the tilt rail 130* is at its substantially horizontal orientation (i.e., when the slats 56* are at the fully opened position e.g., the position shown in FIG. 41). Similarly, FIGS. 88B and 88C illustrate the tilt rail 130* and associated components of the rail support assembly 601* when the tilt rail 130* is at its closed-down, substantially vertical orientation (i.e., when the slats 56* are at the closed-down position) and its closed-up, substantially vertical orientation (i.e., when the slats 56* are at the closed-up position), respectively.

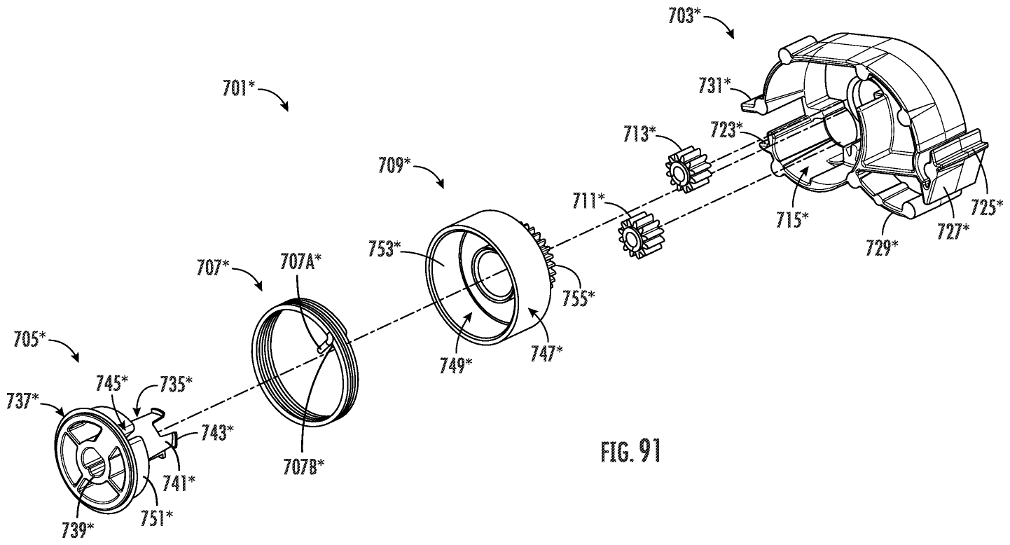

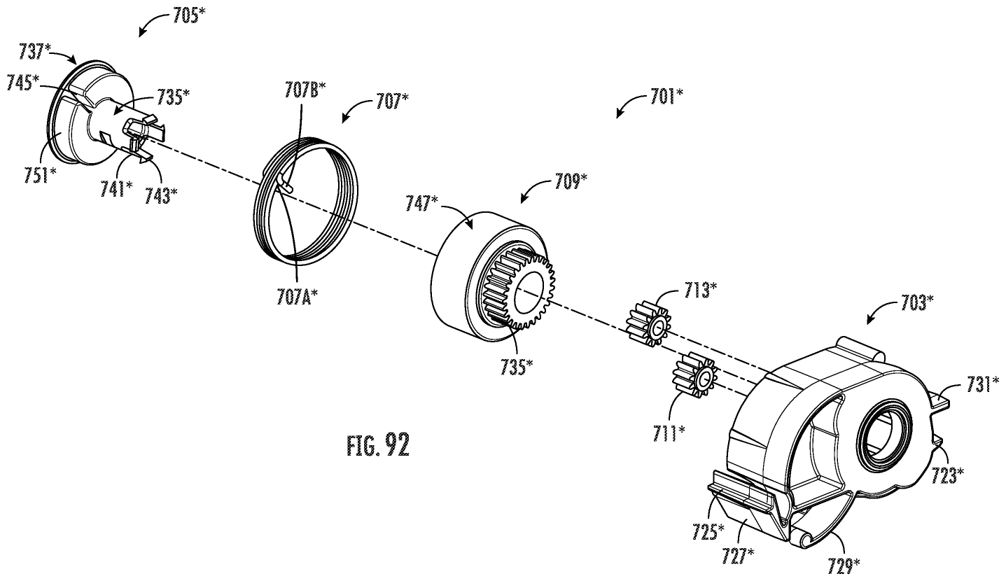

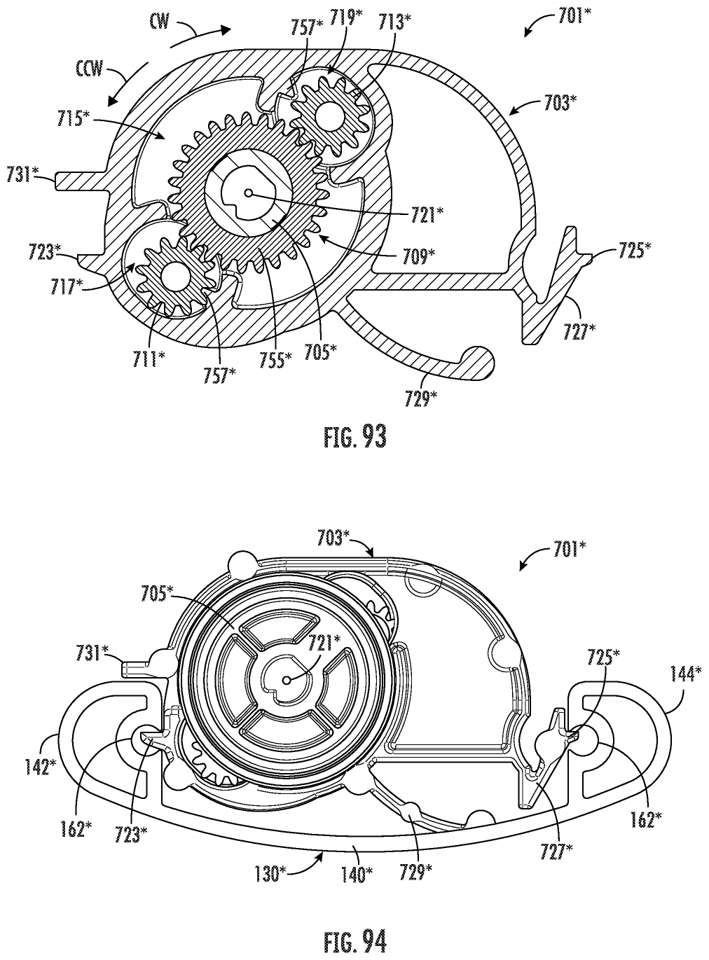

Referring now to FIGS. 89-94, various views of one embodiment of a brake assembly 701* suitable for use as the brake 212* for the lift system 200* described above with reference to FIGS. 48 and 49 are illustrated in accordance with aspects of the present subject matter. Specifically, FIGS. 89 and 90 illustrate opposed, assembled perspective views of the brake assembly 701*, while FIGS. 91 and 92 illustrate opposed, exploded perspective views of the brake assembly 701* shown in FIGS. 89 and 90. FIG. 93 illustrates a cross-sectional view of the brake assembly 701* shown in FIG. 89 taken about line XCIII-XCIII. Additionally, FIG. 94 illustrates an end view of the brake assembly 701* as installed relative to the tilt rail 130* of the disclosed tilt system 130*.

In general, the brake assembly 701* is configured to function as a one-way brake for the lift system 200*. Specifically, when the motor 210* of the lift system 200* is rotationally driving the associated lift rod 208* in a first rotational direction or lifting direction (indicated by arrow CW in FIG. 93) to raise the bottom rail assembly 54* relative to the headrail assembly 52*, the brake assembly 701* may be configured to apply as a little resistance as possible to the lift rod 208*. However, when the lift rod 208* is being rotated in an opposite, second rotational direction or lowering direction (indicated by arrow CCW in FIG. 93) to lower the bottom rail assembly 54* relative to the headrail assembly 52*, the brake assembly 701* may be configured to apply a given amount of resistance to the lift rod 208* to allow the bottom rail assembly 54* to be maintained at an operator-selected position relative to the headrail assembly 52*.

As particularly shown in FIGS. 91 and 92, the brake assembly 701* generally includes a housing 704* configured to at least partially encase or enclose the various other components of the brake assembly 701*, including, for example, a hub 705*, a spring 707*, a drum 709*, and a pair of planetary gears (e.g., a first planetary gear 711* and a second planetary gear 713*). In general, the housing 704* may be configured to define various cavities for receiving the other components of the brake assembly 701*. For instance, as shown in FIGS. 91 and 93, the housing 704* may define a primary brake cavity 715* configured to receive the hub 705*, spring 709*, and drum 709* (as assembled) along with the lift rod 208* extending through such assembled components. Additionally, the housing 703* may also define a pair of opposed secondary brake cavities or gear cavities configured to receive the planetary gears 711*, 713*. For instance, as shown in FIG. 93, the housing 703* defines a first gear cavity 717* configured to receive the first planetary gear 711* and a second gear cavity 719* configured to receive the second planetary gear 713*, with gear cavities 717*, 719* generally being positioned along opposed sides of the primary brake cavity 715* relative to the rotational axis of the lift rod 208* (indicated by point 721* in FIGS. 93 and 94).

The housing 703* may also be configured to accommodate or include suitable features for coupling or securing the brake assembly 701* within the tilt rail 130*. For instance, as particularly shown in the illustrated embodiment, a front mounting tab 723* may extend outwardly from the housing 703* along a front or forward side of the brake assembly 701*. Additionally, a rear mounting tab 725* is positioned relative to the housing along a rear or aft side of the brake assembly 701*. In one embodiment, the rear mounting tab 725* may be provided on or form part of a resilient or flexible spring arm 727* extending outwardly from the housing 703* along the rear side of the brake assembly 701*. In such an embodiment, the spring arm 727* may be configured to apply a biasing force that maintains the brake assembly 701* in position relative to the tilt rail 103*. For instance, as shown in FIG. 94, when installing the brake assembly 701* relative to the tilt rail 130*, the brake assembly 701* may be configured to be slid into tilt rail 130* longitudinally such that the front mounting tab 725* is received within the mounting slot 162* defined adjacent to the forward edge wall 142* of the tilt rail 130* and the rear mounting tab 725* is received within the mounting slot 162* defined adjacent to the rear edge wall 144* of the tilt rail 130*. In this installed configuration, the spring arm 727* may be in a compressed state so as to apply a crosswise biasing force that maintains the mounting tabs 723*, 725* within the mounting slots 162*. Moreover, as shown in in FIG. 94, the housing 703* may also include another spring arm or leaf spring 729* extending along the bottom side thereof that is configured to engage the bottom wall 140* of the tilt rail 130* when the brake assembly 701* is installed relative thereto. In such an embodiment, the leaf spring 729* may be configured to apply an upward biasing force against the brake assembly 701* that maintains the mounting tabs 723*, 725* against the top sides of the mounting slots 162* while also providing a moment arm that biases a separate engagement tab 731* extending outwardly from the front side of the housing 703* against a top end of the front edge wall 142* of the tilt rail 130*.

As shown in FIGS. 91 and 92, the brake hub 705* may generally include a central hub portion 735* and an enlarged brake portion 737* extending radially outwardly relative to the central hub portion 735*. As particularly shown in FIG. 91, the central hub portion 735* of the hub may define a shaft opening 739* for receiving the lift rod 208* of the lift system 200*. For instance, the shaft opening 739* may be keyed to allow the brake hub 705* to rotationally engage the lift rod 208*, such as by including a V-shaped projection configured to be received within a corresponding V-shaped recess defined in the lift rod 208*. Additionally, as particularly shown in FIGS. 90 and 92, an end of the central hub portion 735* may include a plurality of spring arms 741* having locking tabs 743* configured to engage an portion of the housing 703* (see FIG. 90) when the hub 705* is assembled relative to the housing 703*. As shown in FIG. 92, the brake portion 737* of the hub 705* may be configured to define a tang opening or slot 745* for receiving one of the opposed ends or tangs 707A*, 707B* of the brake spring 707*.

Moreover, as shown in FIGS. 91 and 92, the brake drum 709* may generally include a drum portion 747* defining a hub cavity 749* (FIG. 91) for receiving both the enlarged brake portion 737* of the hub 705* and the brake spring 707* when such components are assembled relative to one another. Specifically, in several embodiments, upon assembling the hub 705*, spring 707* and drum 709* together, the brake portion 737* of the hub 705* may be positioned within the hub cavity 749* such that an outer radial surface 751* (FIGS. 91 and 92) of the brake portion 737* is spaced radially inwardly relative to an inner radial surface 753* (FIG. 91) of the drum portion 747* so as to define a spring cavity (not shown) within which the brake spring 707* is housed between the hub 705* and the drum 709*. In such embodiments, given the connection between the hub 705* and the brake spring 707* (e.g., via one of the tangs 707A*, 707B*), the brake spring 707* may be configured to expand outwardly when the hub 705* is rotationally driven via the lift rod 208* and frictionally engage the inner radial surface 753* of the drum portion 747* of the brake drum 709*, thereby providing a rotational coupling between the hub 705* and the drum 709* to allow such components to rotate together.

Additionally, as shown in FIG. 92, the brake drum 709* also includes a gear portion or “brake gear” 755* extending opposite the drum portion 747* that is configured to rotationally engage the planetary gears 711*, 713* within the brake housing 703*. Specifically, as shown in FIG. 93, when the brake drum 709* and planetary gears 711*, 713* are assembled relative to the housing 703* within their respective cavities 715*, 717*, 719*, the brake gear 755* may be configured to rotationally engage or mesh with the first and second planetary gears 711*, 713*. In this regard, to provide the one-way braking function described above, at least one of the planetary gears 711*, 713* may be configured to be locked against rotation when the brake drum 709* is being rotated in the lowering direction CCW (see the arrow in FIG. 93) but may be allowed to freely rotate when the brake drum 709* is being rotated in the raising direction CW (see the arrow in FIG. 93). As shown in FIG. 93, such locking of the planetary gears 711*, 713* may be achieved via a stop tooth 757* extending radially inwardly within each gear cavity 717*, 719* of the housing 703*. In particular, each stop tooth 757* may be positioned within its respective gear cavity 717*, 719* such that the corresponding planetary gear 711*, 713* is driven into the stop tooth 757* when the brake drum 709* is rotated slightly in the lowering direction CCW, thereby stopping rotation of the planetary gears 711*, 713* and preventing further rotation of the drum 709*. In such instance, the friction between the brake spring 707* and the brake drum 709* provides a braking force that is applied through the hub 705* to resist rotation of the lift rod 208*. However, when the brake drum 709* is rotated in opposite raising direction CW, each planetary gear 711*, 713* is driven away from its respective stop tooth 757* and can freely spin within its gear cavity 717*, 719*, thereby allowing the drum 709* to freely rotate within its respective cavity 715* relative to the housing 703*. In such instance, the brake assembly 701* may provide little or no resistance to the rotation of the lift rod 208*.

It should be appreciated that, in several embodiments, the maximum braking force applied by the brake assembly 201* when the lift rod 208* is being rotated in the lowering direction CCW is generally a function of the slip force of the brake spring 707*, which can vary depending on the spring 707*, lubricants provided within the brake assembly 701*, the inner diameter of the brake drum 709* and the associated material of the drum 709*. When the torque applied through the brake assembly 701* exceeds the slip force of the brake spring 707*, the spring 707* will slip relative to the inner radial surface 753* of the brake drum 709* to allow the lift rod 208* to rotate. As such, the brake force applied by the brake assembly 701* may be overcome, for example, by a user pulling down on the bottom rail assembly 54* with a sufficient amount of force.

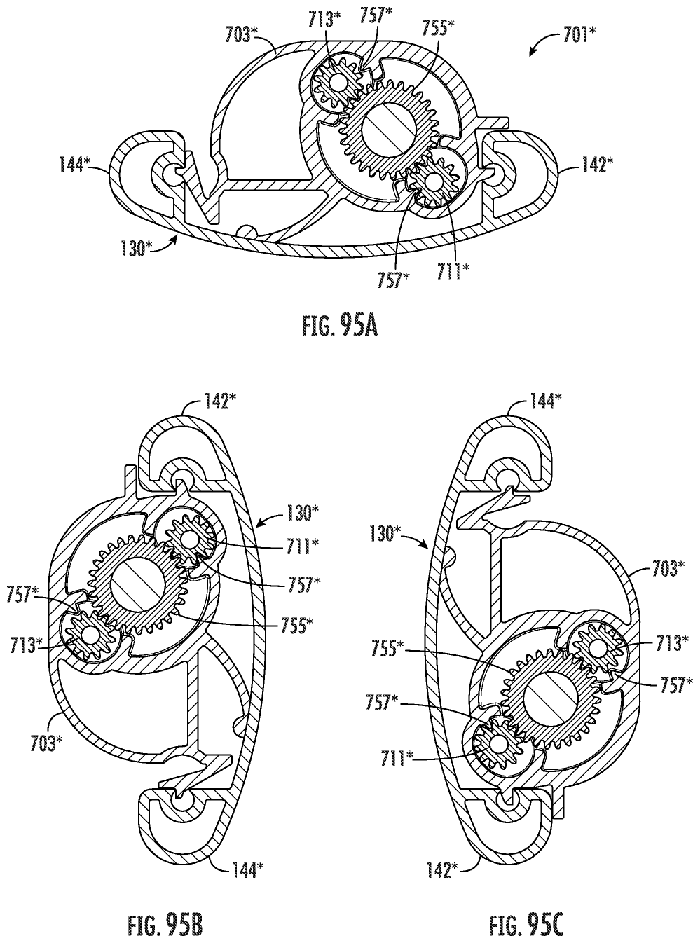

It should also be appreciated that the dual-planetary configuration of the brake assembly 701* may generally allow the brake to function as described herein regardless of the orientation or rail position of the tilt rail 130*. For example, FIGS. 95A-9C illustrate a similar cross-sectional view of the brake assembly 701* to that shown in FIG. 93 as installed relative to the tilt rail 130* (but with the view mirrored to show the front and rear sides of the tilt rail 130* in the same orientation as similar views provided herein), particularly illustrating the tilt rail 130* oriented at various different rail positions corresponding to different tilt positions for the slats 56*. Specifically, when the tilt rail 130* is disposed in the substantially horizontal orientation shown in FIG. 95A (i.e., when the slats 56* are at the fully opened position) and the closed-up, substantially vertical orientation shown in FIG. 95B (i.e., when the slats 56* are at the closed-up position), the force of gravity acting on the first planetary gear 711* will generally cause it want to shift towards its respective stop tooth 757* while the force of gravity acting on the second planetary gear 713* will generally cause it to want to fall away from its respective stop tooth 757*. As such, even if the second planetary gear 713* disengages with its stop tooth 757* (e.g., due to the force gravity) while the tilt rail 130* is at the position shown in FIG. 95A or FIG. 95B, the first planetary gear 711* will remain in engagement with its stop tooth 757* to prevent rotation of the brake drum 709*. In contrast, when the tilt rail 130* is disposed in the closed-down, substantially vertical orientation shown in FIG. 95C (i.e., when the slats 56* are at the closed-down position), the force of gravity acting on the second planetary 713* gear will generally cause it want to shift towards its respective stop tooth 757* while the force of gravity acting on the first planetary gear 711* will generally cause it to want to fall away from its respective stop tooth 757*. As such, even if the first planetary gear 711* disengages with its stop tooth 757* (e.g., due to the force gravity) while the tilt rail 130* is at the position shown in FIG. 95C, the second planetary gear 713* will remain in engagement with its stop tooth 757* to prevent rotation of the brake drum 709*. Accordingly, regardless of the orientation of the tilt rail 130* across its range of rail positions, at least one of the planetary gears 711*, 713* may be configured to remain in engagement with its stop tooth 757* when the tilt rod 130* is being rotated in the lowering direction CCW to allow the brake assembly 701* to provide the desired braking functionality.

While the foregoing Detailed Description and drawings represent various embodiments, it will be understood that various additions, modifications, and substitutions may be made therein without departing from the spirit and scope of the present subject matter. Each example is provided by way of explanation without intent to limit the broad concepts of the present subject matter. In particular, it will be clear to those skilled in the art that principles of the present disclosure may be embodied in other forms, structures, arrangements, proportions, and with other elements, materials, and components, without departing from the spirit or essential characteristics thereof. For instance, features illustrated or described as part of one embodiment can be used with another embodiment to yield a still further embodiment. Thus, it is intended that the present subject matter covers such modifications and variations as come within the scope of the appended claims and their equivalents. One skilled in the art will appreciate that the disclosure may be used with many modifications of structure, arrangement, proportions, materials, and components and otherwise, used in the practice of the disclosure, which are particularly adapted to specific environments and operative requirements without departing from the principles of the present subject matter. For example, elements shown as integrally formed may be constructed of multiple parts or elements shown as multiple parts may be integrally formed, the operation of elements may be reversed or otherwise varied, the size or dimensions of the elements may be varied. The presently disclosed embodiments are therefore to be considered in all respects as illustrative and not restrictive, the scope of the present subject matter being indicated by the appended claims, and not limited to the foregoing description.

In the foregoing Detailed Description, it will be appreciated that the phrases “at least one”, “one or more”, and “and/or”, as used herein, are open-ended expressions that are both conjunctive and disjunctive in operation. The term “a” or “an” element, as used herein, refers to one or more of that element. As such, the terms “a” (or “an”), “one or more” and “at least one” can be used interchangeably herein. All directional references (e.g., proximal, distal, upper, lower, upward, downward, left, right, lateral, longitudinal, front, rear, top, bottom, above, below, vertical, horizontal, cross-wise, radial, axial, clockwise, counterclockwise, and/or the like) are only used for identification purposes to aid the reader's understanding of the present subject matter, and/or serve to distinguish regions of the associated elements from one another, and do not limit the associated element, particularly as to the position, orientation, or use of the present subject matter. Connection references (e.g., attached, coupled, connected, joined, secured, mounted and/or the like) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another.

All apparatuses and methods disclosed herein are examples of apparatuses and/or methods implemented in accordance with one or more principles of the present subject matter. These examples are not the only way to implement these principles but are merely examples. Thus, references to elements or structures or features in the drawings must be appreciated as references to examples of embodiments of the present subject matter, and should not be understood as limiting the disclosure to the specific elements, structures, or features illustrated. Other examples of manners of implementing the disclosed principles will occur to a person of ordinary skill in the art upon reading this disclosure.

This written description uses examples to disclose the present subject matter, including the best mode, and also to enable any person skilled in the art to practice the present subject matter, including making and using any devices or systems and performing any incorporated methods. The patentable scope of the present subject matter is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The following claims are hereby incorporated into this Detailed Description by this reference, with each claim standing on its own as a separate embodiment of the present disclosure. In the claims, the term “comprises/comprising” does not exclude the presence of other elements or steps. Furthermore, although individually listed, a plurality of means, elements or method steps may be implemented by, e.g., a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second”, etc., do not preclude a plurality. Reference signs in the claims are provided merely as a clarifying example and shall not be construed as limiting the scope of the claims in any way.

What is claimed is:

1. An operating system for tilting a plurality of slats of a covering for an architectural structure, the operating system comprising:
a tilt drive assembly including a drive pulley supported for rotation about a pulley axis;
first and second tilt cords coupled to the drive pulley; and
a tilt wand supported relative to the tilt drive assembly, the tilt wand comprising a first wand portion and a second wand portion, the first and second tilt cords being coupled to the tilt wand such that movement of the second wand portion relative to the first wand portion in a first direction results in the drive pulley being rotated in a first rotational direction about the pulley axis and movement of the second wand portion relative to the first wand portion in an opposed, second direction results in the drive pulley being rotated in an opposed, second rotational direction about the pulley axis.

2. The operating system of claim 1, wherein:
the first tilt cord is wound around the drive pulley as the second tilt cord unwinds from the drive pulley while the drive pulley is rotating in the first rotational direction; and
the second tilt cord is wound around the drive pulley as the first tilt cord unwinds from the drive pulley while the drive pulley is rotating in the second rotational direction.

3. The operating system of claim 1, wherein the tilt drive assembly is configured such that rotation of the drive pulley in the first rotational direction results in the plurality of slats being tilted towards one of a closed-up position or a closed-down portion and rotation of the drive pulley in the second rotational direction results in the plurality of slats being tilted towards the other of the one of the closed-up position or the closed-down position.

4. The operating system of claim 1, wherein the first and second wand portions are provided in a telescoping arrangement.

5. The operating system of claim 1, wherein an end of the first tilt cord is coupled to the second wand portion at a first location and an end of the second tilt cord is coupled to the second wand portion at a second location spaced apart from the first location.

6. The operating system of claim 5, wherein the second tilt cord is routed through the second wand portion such that an overlapped cord section is formed across which the second tilt cord vertically overlaps itself within the second wand portion.

7. The operating system of claim 1, further comprising a tilt rail coupled to the tilt drive assembly such that the tilt drive assembly is configured to rotate the tilt rail about a tilt axis, the tilt axis being spaced apart radially from the pulley axis.

8. The operating system of claim 7, wherein the tilt drive assembly further comprises a tilt drive component coupled between the drive pulley and tilt rail such that rotation of the drive pulley about the pulley axis results in the tilt rail cap and the tilt rail rotating together about the tilt axis.

9. A covering for an architectural structure, the covering comprising a headrail assembly, a bottom rail assembly supported relative to the headrail assembly, and the operating system of claim 1, wherein the plurality of slats are supported between the headrail assembly and the bottom rail assembly.

10. A headrail assembly configured for use with a covering for an architectural structure, the headrail assembly comprising:
a mounting rail;
a tilt system supported relative to the mounting rail, the tilt system including a tilt drive assembly and a tilt rail, the tilt rail extending lengthwise between a first end and a second end, the tilt drive assembly being configured to rotate the tilt rail about a tilt axis to effectuate tilting of a plurality of slats;
a rail support assembly configured to support the tilt rail relative to the mounting rail for rotation about the tilt axis, the rail support assembly supporting the tilt rail at a location between the first and second ends of the tilt rail, the rail support assembly comprising:
a rail support bracket including a first bracket portion coupled to the mounting rail and a second bracket portion extending outwardly from the first bracket portion; and
first and second support components coupled between the tilt rail and the second bracket portion, the first and second support component being configured to rotate with the tilt rail about the tilt axis relative to the rails support bracket.

11. The headrail assembly of claim 10, wherein the first support component defines a first elongated slot and the second support component defines a second elongated slot, the first and second elongated slots being configured to receive the rail support bracket as the tilt rail is rotated relative to the rail support bracket about the tilt axis.

12. The headrail assembly of claim 10, wherein the tilt rail defines an elongated slot configured to receive the rail support bracket as the tilt rail is rotated relative to the rail support bracket about the tilt axis, the first support component comprising a slot cap coupled to the tilt rail such that at least a portion of the slot cap extends within the elongated slot defined by the tilt rail.

13. The headrail assembly of claim 12, further comprising a lift system configured to raise and lower the covering between raised and lowered positions, the lift system comprising a plurality of components provided in operative association with the tilt rail such that the plurality of components rotate with the tilt rail about the tilt axis, the second support component comprising a first lift system component of the plurality of components of the lift system such that the pivot pin is captured directly between the slot cap and the first lift station component.

14. The headrail assembly of claim 10, wherein the rail support assembly further comprises a pivot pin secured to the second bracket portion and extending lengthwise along the tilt axis, wherein the first and second support components are pivotably coupled to the rail support bracket via the pivot pin such that the first and second support components pivot relative to the pivot pin with pivoting of tilt rail relative about the tilt axis.

15. The headrail assembly of claim 10, wherein the first and second support components comprise first and second rail slides configured to engage with the second bracket portion such that a sliding interface is defined between the second bracket portion and the first and second rail slides.

16. A covering comprising the headrail assembly of claim 10, the covering further comprising a bottom rail assembly supported relative to the headrail assembly, the plurality of slats being supported between the headrail assembly and the bottom rail assembly.

17. A covering for an architectural structure, the covering comprising:
a headrail assembly;
a plurality of slats supported relative to the headrail assembly by at least one ladder tape assembly;
a tilt system forming part of the headrail assembly, the tilt system including a tilt drive assembly and a tilt rail coupled to the at least one ladder tape assembly, the tilt drive assembly being configured to rotate the tilt rail about a tilt axis to effectuate tilting of the plurality of slats; and
a lift system forming part of the headrail assembly and being configured to raise and lower the plurality of slats relative to the headrail assembly;
wherein one or more lift system components of the lift system are provided in operative association with the tilt rail such that the one or more lift system components rotate with the tilt rail about the tilt axis.

18. The covering of claim 17, further comprising a bottom rail assembly positioned relative to the headrail assembly such that the plurality of slats are supported between the headrail assembly and the bottom rail assembly.

19. The covering of claim 18, wherein the bottom rail assembly comprises:
a bottom rail comprising a rail portion and a separate cover portion, the rail portion including an upper rail wall and forward and rear edge walls extending from upper rail wall along respective front and rear sides of the rail portion, the rail portion defining an open bottom end configured to be at least partially covered by the covering portion; and
a connector insert received within the rail portion and being configured to couple the cover portion to the rail portion of the bottom rail, the connector insert including at least one connection member configured to engage at least one corresponding connection member of the cover portion to support the cover portion relative to the open bottom end of the rail portion.

20. The covering of claim 17, wherein a center of mass of the tilt rail is offset from the tilt axis in a radial direction defined relative to the tilt axis.

21.
